(19) United States
(12) Patent Application Publication
(10) Pub. No.: US 2011/0137732 A1
(43) Pub. Date: Jun. 9, 2011

(54) Broadcast messaging and feedback communications apparatus and method

(75) Inventor: Jeffrey Scott Averbeck, Signal Mountain, TN (US)

(73) Assignee: Airnet Group. Inc.

(21) Appl. No.: 12/807,989

(22) Filed: Sep. 17, 2010

Related U.S. Application Data
(60) Provisional application No. 61/243,497, filed on Sep. 17, 2009.

(51) Int. Cl. G06F 15/16; G06Q 30/00

(52) U.S. Cl. 705/14.66; 709/204; 709/206

(57) ABSTRACT

A method and communication system for delivering first data to a plurality of recipients and obtaining and manipulating feedback information received from the plurality of recipients is provided. The communication system comprises a host computer, a network, one or more client devices and a plurality of recipients. The host computer includes a set of instructions for operating one or more modules. The network is coupled to the host computer and the one or more client devices are coupleable to the network for coupling to the host computer via the network to access some or all of the one or more modules. The host computer can couple to each of the plurality of recipients in one of a plurality of predetermined delivery modes, wherein the client is able to customize contact of the plurality of recipients from the host computer and collection of feedback data from the recipients at the host computer

### CROSS-REFERENCES TO RELATED APPLICATION

This is a non-provisional conversion patent application claiming priority to provisional patent application 61/243,497, filed Sep. 17, 2009.

### FIELD OF THE INVENTION

The present invention relates to apparatus and methods for communicating messages to recipients and analyzing feedback from the recipients. More particularly, the present invention is directed to messaging communication systems providing multiple media communication modes for sending messages to recipients and analyzing recipient responses.

### BACKGROUND OF THE DISCLOSURE

There are many types of web-enabled interactive communication systems, such as email systems, social networking websites and survey websites. There are also a number of systems for communicating with a large number of recipients, such as mass mailings, telemarketing and targeted emailing. During a political campaign, for instance, several systems may be used to poll the public, to communicate a candidate's message, or to collect demographic information on voters. Generally, different personnel are responsible for different functions and it is difficult to collect, maintain, study and view all of the collected information. Any feedback that can be obtained from the various collection methods can be misread or lost due to the diversity of collection systems.

Thus, what is needed is a method and apparatus for integrating many different recipient contact modes, data collection techniques, and data analysis procedures which overcomes the issues described above. Furthermore, other desirable features and characteristics will become apparent from the subsequent detailed description and the appended claims, taken in conjunction with the accompanying drawings and this background of the disclosure.

### SUMMARY OF THE INVENTION

According to the Detailed Description, a method is provided in a communication system for contacting a plurality of recipients and collecting feedback data from the plurality of recipients. The method includes a client customizing contact of the plurality of recipients from a host computer and the client customizing collection of the feedback data from the recipients at the host computer. The method also includes the client receiving the feedback data via a network portal coupled to the host computer, wherein the feedback data is received in the form of a report including at least a portion of the feedback data, and wherein the feedback data is analyzed in accordance with client analysis criteria customized by the client.

In addition, a communication system is provided for delivering first data to a plurality of recipients and obtaining and manipulating feedback information received from the plurality of recipients. The communication system comprises a host computer, a network, one or more client devices and a plurality of recipients. The host computer includes a set of instructions for operating one or more modules. The network is coupled to the host computer and the one or more client devices are coupleable to the network for coupling to the host computer via the network to access some or all of the one or more modules. The host computer can couple to each of the plurality of recipients in one of a plurality of predetermined delivery modes, wherein the client is able to customize contact of the plurality of recipients from the host computer and collection of feedback data from the recipients at the host computer.

Further, a host computer is provided for operating under customized control of a client device for communicating with a plurality of recipients and obtaining feedback data therefrom. The host computer includes a survey module, a group module, an analyzer module, and a manager module. The survey module permits creation of surveys by the client device to enable the client device to obtain information concerning interests of at least a portion of the plurality of recipients. The group module allows the client device to interact with social networking websites. The analyzer module generates and provides analytics to the client device on a plurality of predetermined contact modes for contacting each of the plurality of recipients. And the manager module communicates advertising messages to at least a portion of the plurality of recipients in response to demographic information on each of the at least a portion of the plurality of recipients.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 illustrates a block diagram of an overview a broadcast messaging and feedback communications system in accordance with an embodiment of the present invention.

FIG. 2 illustrates a block diagram of modules of a host computer of the broadcast messaging and feedback communications system of FIG. 1 in accordance with the embodiment.

FIG. 3 illustrates a block diagram of module of clients' devices of the broadcast messaging and feedback communications system of FIG. 1 in accordance with the embodiment.

FIG. 4 illustrates a block diagram of recipients' contact devices of the broadcast messaging and feedback communications system of FIG. 1 in accordance with the embodiment.

FIG. 5 illustrates a loading screen following initialization of the messaging system by a user of a client device of the broadcast messaging and feedback communications system of FIG. 1 in accordance with the embodiment.

FIG. 6 illustrates a log-in screen displayed following loading of the messaging system on a client device of the broadcast messaging and feedback communications system of FIG. 1 in accordance with the embodiment.

FIG. 7 illustrates a “forgot password” screen on a client device of the broadcast messaging and feedback communications system of FIG. 1 in accordance with the embodiment.

FIG. 8 illustrates a popover screen displayed when a user requires an e-mail communication as to a forgotten password during operation of the broadcast messaging and feedback communications system of FIG. 1 in accordance with the embodiment.

FIG. 9 illustrates a password reset screen on a client device of the broadcast messaging and feedback communications system of FIG. 1 in accordance with the embodiment.

FIG. 10 illustrates a screen image displayed for authorized personnel to access operational control features on the client device of the broadcast messaging and feedback communications system of FIG. 1 in accordance with the embodiment.

FIG. 11 illustrates a control screen for analyzing messages within the broadcast messaging apparatus, and particularly displays the calendar for communication of messages on the client device of the broadcast messaging and feedback communications system of FIG. 1 in accordance with the embodiment.

FIG. 12 illustrates a screen that displays charts of message performance on the client device of the broadcast messaging and feedback communications system of FIG. 1 in accordance with the embodiment.

FIG. 13 illustrates a message grid popover accessed from the message performance screen illustrated in FIG. 12 and displayed on the client device of the broadcast messaging and feedback communications system of FIG. 1 in accordance with the embodiment.

FIG. 14 illustrates a zoom chart popover accessed through the message performance screen illustrated in FIG. 12 and displayed on the client device of the broadcast messaging and feedback communications system of FIG. 1 in accordance with the embodiment.

FIG. 15 illustrates a screen that displays on the client device of the broadcast messaging and feedback communications system of FIG. 1 information as to actions by recipients of messages from the messaging system over a selected time period in accordance with the embodiment.

FIG. 16 illustrates graph charts that display segment actions relative to messages received by recipients within the segment that are displayed on the client device of the broadcast messaging and feedback communications system of FIG. 1 in accordance with the embodiment.

FIG. 17 illustrates a popover displaying a segment selection grid accessed through the screen illustrated in FIG. 16 in accordance with the embodiment.

FIG. 18 illustrates a zoom chart popover selectable from the display illustrated in FIG. 16 in accordance with the embodiment.

FIG. 19 illustrates an account setup page in the management module of the host computer of the broadcast messaging and feedback communications system of FIG. 1 in accordance with the embodiment.

FIG. 20 illustrates a flowchart depicting the navigation of the new account setup routine of the management module of the host computer of the broadcast messaging and feedback communications system of FIG. 1 in accordance with the embodiment.

FIG. 21 illustrates a module selection screen for an account accessed in the management module of the host computer of the broadcast messaging and feedback communications system of FIG. 1 in accordance with the embodiment.

FIG. 22 illustrates a selectively displayed popover image that provides additional information about a selected module of the host computer of the broadcast messaging and feedback communications system of FIG. 1 in accordance with the embodiment.

FIG. 23 illustrates a customization selection screen for an account accessed in the management module of the host computer of the broadcast messaging and feedback communications system of FIG. 1 in accordance with the embodiment.

FIG. 24 illustrates a categories creation and editing screen within the management module of the host computer for categorizing messages and actions of the broadcast messaging and feedback communications system of FIG. 1 in accordance with the embodiment.

FIG. 25 illustrates a first popover screen displayed while creating and editing categories with the screen illustrated in FIG. 24 in accordance with the embodiment.

FIG. 26 illustrates a second popover screen displayed while creating and editing categories with the screen illustrated in FIG. 24 in accordance with the embodiment.

FIG. 27 illustrates a third popover screen displayed while creating and editing categories with the screen illustrated in FIG. 24 in accordance with the embodiment.

FIG. 28 illustrates a flowchart depicting the navigation of the routine for creating, editing and deleting of categories, permissions, keywords, access roles, templates and departments of the management module of the host computer of the broadcast messaging and feedback communications system of FIG. 1 in accordance with the embodiment.

FIG. 29 illustrates a screen within the management module for establishing and editing keywords used in connection with the messages communicated by the broadcast messaging and feedback communications system of FIG. 1 in accordance with the embodiment.

FIG. 30 illustrates a first popover screen displayed while creating and editing keywords with the screen illustrated in FIG. 29 in accordance with the embodiment.

FIG. 31 illustrates a second popover screen displayed while creating and editing keywords with the screen illustrated in FIG. 29 in accordance with the embodiment.

FIG. 32 illustrates a third popover screen displayed while creating and editing keywords with the screen illustrated in FIG. 29 in accordance with the embodiment.

FIG. 33 illustrates a screen within the management module for establishing, editing, and deleting permission roles for particular individuals to access the host computer of the broadcast messaging and feedback communications system of FIG. 1 in accordance with the embodiment.

FIG. 34 illustrates a first popover screen displayed while creating, editing, and deleting permission roles with the screen illustrated in FIG. 33 in accordance with the embodiment.

FIG. 35 illustrates a second popover screen displayed while creating, editing, and deleting permission roles with the screen illustrated in FIG. 33 in accordance with the embodiment.

FIG. 36 illustrates a third popover screen displayed while creating, editing, and deleting permission roles with the screen illustrated in FIG. 33 in accordance with the embodiment.

FIG. 37 illustrates a fourth popover screen displayed while creating, editing, and deleting permission roles with the screen illustrated in FIG. 33 in accordance with the embodiment.

FIG. 38 illustrates a screen within the management module for establishing access roles for individuals associated with an account of the broadcast messaging and feedback communications system of FIG. 1 in accordance with the embodiment.

FIG. 39 illustrates a first popover screen displayed while creating, editing and deleting access roles for the account with the screen illustrated in FIG. 38 in accordance with the embodiment.

FIG. 40 illustrates a second popover screen displayed while creating, editing and deleting access roles for the account with the screen illustrated in FIG. 38 in accordance with the embodiment.

FIG. 41 illustrates a third popover screen displayed while creating, editing and deleting access roles for the account with the screen illustrated in FIG. 38 in accordance with the embodiment.

FIG. 42 illustrates a fourth popover screen displayed while creating, editing and deleting access roles for the account with the screen illustrated in FIG. 38 in accordance with the embodiment.

FIG. 43 illustrates a screen for creating a message template for use in creating (or editing) messages to be communicated by the broadcast messaging and feedback communications system of FIG. 1 in accordance with the embodiment.

FIG. 44 illustrates a screen within the management module for creating, editing, or deleting departments associated with an account of the broadcast messaging and feedback communications system of FIG. 1 in accordance with the embodiment.

FIG. 45 illustrates a first popover screen used to create, edit and delete department information in the broadcast messaging and feedback communications system of FIG. 1 in accordance with the embodiment.

FIG. 46 illustrates a second popover screen used to create, edit and delete department information in the broadcast messaging and feedback communications system of FIG. 1 in accordance with the embodiment.

FIG. 47 illustrates a third popover screen used to create, edit and delete department information in the broadcast messaging and feedback communications system of FIG. 1 in accordance with the embodiment.

FIG. 48 illustrates a screen for defining persons authorized to access and use an account in the broadcast messaging and feedback communications system of FIG. 1 in accordance with the embodiment.

FIG. 49 is a first popover screen displayed while creating, editing, or deleting user names authorized to access an account in the broadcast messaging and feedback communications system of FIG. 1 in accordance with the embodiment.

FIG. 50 is a second popover screen displayed while creating, editing, or deleting user names authorized to access an account in the broadcast messaging and feedback communications system of FIG. 1 in accordance with the embodiment.

FIG. 51 illustrates a screen for identifying persons in a database of recipients of messages communicated by the broadcast messaging and feedback communications system of FIG. 1 in accordance with the embodiment.

FIG. 52 is a first popover screen displayed while editing information and preferences associated with a recipient in the broadcast messaging and feedback communications system of FIG. 1 in accordance with the embodiment.

FIG. 53 is a second popover screen displayed while editing information and preferences associated with a recipient in the broadcast messaging and feedback communications system of FIG. 1 in accordance with the embodiment.

FIG. 54 is a third popover screen displayed while editing information and preferences associated with a recipient in the broadcast messaging and feedback communications system of FIG. 1 in accordance with the embodiment.

FIG. 55 illustrates a public screen available for a recipient to edit and manage subscriptions for information and messages sent by the broadcast messaging and feedback communications system of FIG. 1 in accordance with the embodiment.

FIG. 56 is a recipient success screen displayed while a recipient edits and manages subscriptions for information and messages sent in the broadcast messaging and feedback communications system of FIG. 1 in accordance with the embodiment.

FIG. 57 is a popover screen displayed while a recipient edits and manages subscriptions for information and messages sent in the broadcast messaging and feedback communications system of FIG. 1 in accordance with the embodiment.

FIG. 58 illustrates a screen for creating a chart for reports to keep a user informed on messages, actions and segments within the broadcast messaging and feedback communications system of FIG. 1 in accordance with the embodiment.

FIG. 59 illustrates a popover screen by which a report chart is created or edited for use in reporting messages, actions and segments within the broadcast messaging and feedback communications system of FIG. 1 in accordance with the embodiment.

FIG. 60 illustrates a screen for creating a new message to be sent by broadcast messaging and feedback communications system of FIG. 1 in accordance with the embodiment.

FIG. 61 illustrates a first popover screen displayed while creating a new message for communication by broadcast messaging and feedback communications system of FIG. 1 in accordance with the embodiment.

FIG. 62 illustrates a second popover screen displayed while creating a new message for communication by broadcast messaging and feedback communications system of FIG. 1 in accordance with the embodiment.

FIG. 63 illustrates a third popover screen displayed while creating a new message for communication by broadcast messaging and feedback communications system of FIG. 1 in accordance with the embodiment.

FIG. 64 illustrates a flowchart depicting the navigation of the message mailing module of the host computer of the broadcast messaging and feedback communications system of FIG. 1 in accordance with the embodiment.

FIG. 65 illustrates a setup page for identifying the audience to which a message is to be communicated by the broadcast messaging and feedback communications system of FIG. 1 in accordance with the embodiment.

FIG. 66 illustrates a first popover screen displayed while creating a new sender or editing a sender e-mail address in the broadcast messaging and feedback communications system of FIG. 1 in accordance with the embodiment.

FIG. 67 illustrates a second popover screen displayed while creating a new sender or editing a sender e-mail address in the broadcast messaging and feedback communications system of FIG. 1 in accordance with the embodiment.

FIG. 68 illustrates a template for creating, editing, copying or deleting a message to be sent by the broadcast messaging and feedback communications system of FIG. 1 in accordance with the embodiment.

FIG. 69 illustrates a screen for creating a new template of a message to be communicated by the broadcast messaging and feedback communications system of FIG. 1 in accordance with the embodiment.

FIG. 70 illustrates a screen for inserting or editing a message within a message template for communication by the broadcast messaging and feedback communications system of FIG. 1 in accordance with the embodiment.

FIG. 71 illustrates a first popover screen displayed while editing a message template using the screen illustrated in FIG. 70 in accordance with the embodiment.

FIG. 72 illustrates a second popover screen displayed while editing a message template using the screen illustrated in FIG. 70 in accordance with the embodiment.

FIG. 73 illustrates a third popover screen displayed while editing a message template using the screen illustrated in FIG. 70 in accordance with the embodiment.

FIG. 74 illustrates a fourth popover screen displayed while editing a message template using the screen illustrated in FIG. 70 in accordance with the embodiment.

FIG. 75 illustrates a review screen for testing communication of a message created with the broadcast messaging and feedback communications system of FIG. 1 in accordance with the embodiment.

FIG. 76 illustrates a screen for scheduling communication of a message in the broadcast messaging and feedback communications system of FIG. 1 in accordance with the embodiment.

FIG. 77 illustrates a screen for creating and managing groupings of persons in the recipients' database (such grouping referred to as a segment) based on desired attributes of persons to receive messages communicated with the broadcast messaging and feedback communications system of FIG. 1 in accordance with the embodiment.

FIG. 78 illustrates a screen for interactive assembly or characterization of a segment based on desired group attributes in the broadcast messaging and feedback communications system of FIG. 1 in accordance with the embodiment.

FIG. 79 illustrates a screen in which an attribute for a segment includes a slider bar for selecting a range of information relative to the attribute in the broadcast messaging and feedback communications system of FIG. 1 in accordance with the embodiment.

FIG. 80 illustrates a screen for creating a segment that includes a geographic attribute in the broadcast messaging and feedback communications system of FIG. 1 in accordance with the embodiment.

FIG. 81 illustrates a segment defining screen before the interactive assembly of a segment in the broadcast messaging and feedback communications system of FIG. 1 in accordance with the embodiment.

FIG. 82 illustrates the attribute selection dropdown menu for selecting an attribute for segment criteria in the broadcast messaging and feedback communications system of FIG. 1 in accordance with the embodiment.

FIG. 83 illustrates the attribute “Last Name” with a selected name dragged and dropped on the criteria box in the criteria field in the broadcast messaging and feedback communications system of FIG. 1 in accordance with the embodiment.

FIG. 84 illustrates the selected attribute dropped on the criteria box in the criteria field in the broadcast messaging and feedback communications system of FIG. 1 in accordance with the embodiment.

FIG. 85 illustrates a second attribute dragged and dropped on the criteria box in the criteria field, with a range bar to select a range of ages, in the broadcast messaging and feedback communications system of FIG. 1 in accordance with the embodiment.

FIG. 86 illustrates a second criteria block for an alternate selection criteria using Boolean logic in the broadcast messaging and feedback communications system of FIG. 1 in accordance with the embodiment.

FIG. 87 illustrates a third attribute dragged and dropped to the second criteria field in the broadcast messaging and feedback communications system of FIG. 1 in accordance with the embodiment.

FIG. 88 illustrates the two criteria for the segment with a total count of the recipients included by the criteria in the broadcast messaging and feedback communications system of FIG. 1 in accordance with the embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF AN EMBODIMENT

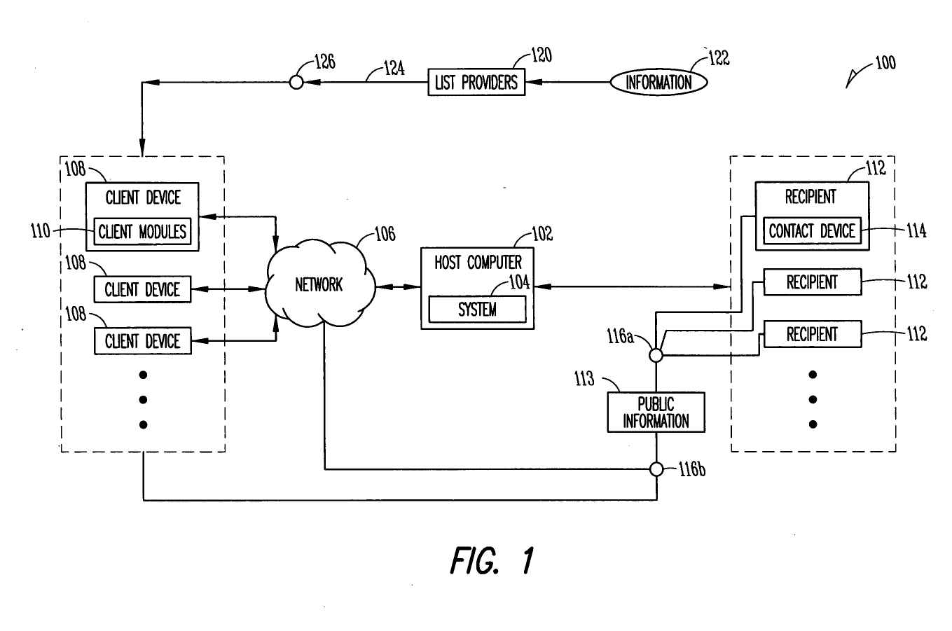

This Detailed Description is separated into logical sections with headings for clarification. With reference to the drawings, FIG. 1 illustrates a schematic view of a broadcast messaging and feedback communication system 100.

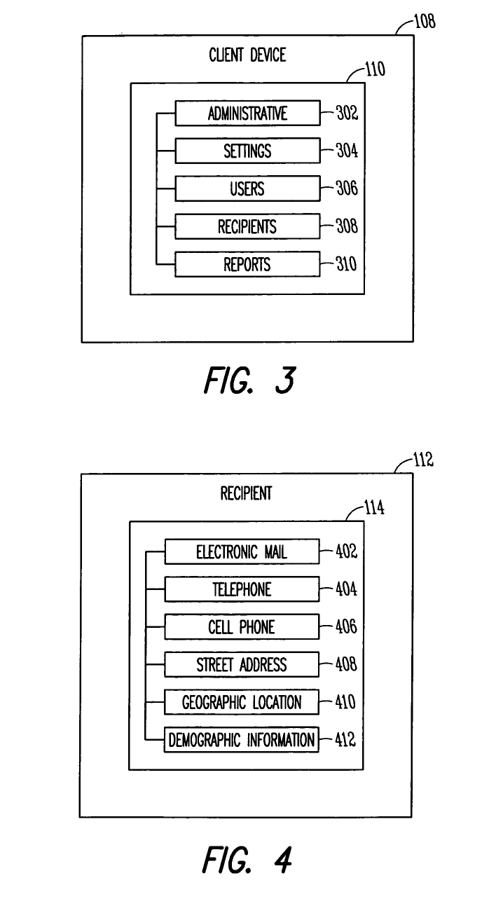

The system 100 includes a central host computer 102 configured to execute a set of instructions 104 that implement the communication system 100 in the illustrative embodiment as an application service provider. In an alternate embodiment, the set of instructions 104 executes on a stand-alone local computer. The host computer 102 communicates through a network 106 with one or more client devices 108 also referred to as an account. Each client operates one of the client devices 108 to access the host computer 102 through client modules 110 discussed in more detail in regards to FIG. 3, below, and operable on a local personal computer equipped with a network interface, a display screen, a keyboard or similar device for text entry, and a cursor control device such as a mouse.

The client device 108 accesses the host computer 102 through the network 106, such as the World Wide Web, for sending messages to a plurality of message recipients 112. Each message recipient 112 includes at least one message receiving device, such as contact device 114. The contact device 114 information and other information about the recipients 112 is obtained 116 through a variety of ways including public information 113 about the recipient 112, registration information submitted to the client by the particular message recipient 112, or affiliation or membership information, and the like. The circles 116a and 116b symbolize such information collecting and providing to the client 108. In addition, groups of message recipients may be developed from list providers 120 which collect information 122 about message recipients 112 and provide 124 categorized information 126 about the recipients 112 to client devices 108 among others.

The host computer 102 communicates 130 to the message recipients 112 through a variety of devices including electronic mail through networks, telecommunications, and written document delivery such as by mail or other delivery services.

### Overview of Modules

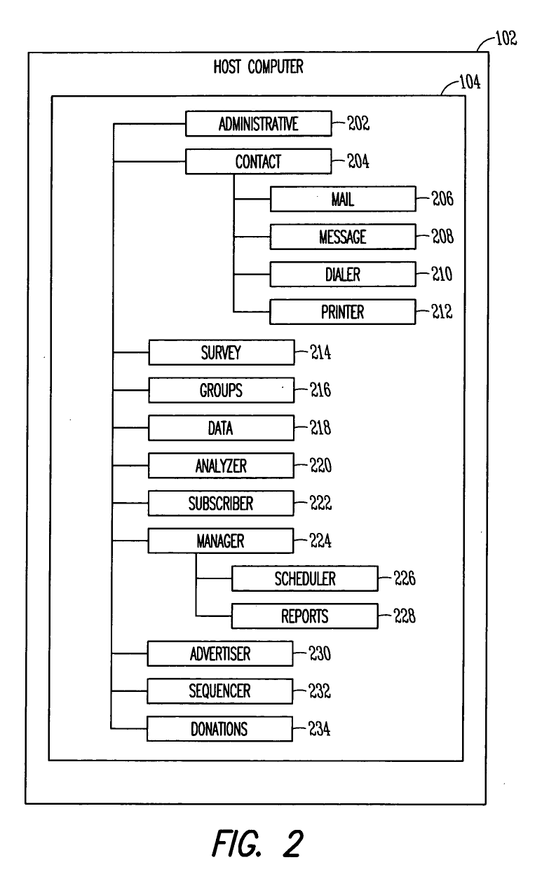

Referring to FIG. 2, the set of instructions 104 of the host computer 102 includes a plurality of modules selectively accessible by the client devices 108 to prepare messages, schedule transmission of messages, and to evaluate responses by message recipients. An administrative module 202 provides for set up and configuration for the particular account, settings for message and system operation, identification of users authorized to create and distribute messages, recipients of administrative information about the messages sent and message success analysis, and charts and other reports.

The host computer 102 provides alternate contact devices 204 for communicating with the recipients 112. These include a mailer module 206 for electronic distribution of messages, a messenger system 208 for managing and sending text messages to cell phones for direct and quick connection to and fast feedback from the recipients 112. A dialer module 210 enables building meaningful relationships between the client 108 and recipients 112 through direct conversation. The dialer module 210 manages and delivers calls to traditional telephones and cell phones for messaging to target message receivers 112. A printer module 212 enables a client 108 to contact recipients 112 by sending product offers or other printed materials that are relevant to particular interests. The printer module 212 incorporates the management and transmission of XML data streams directly into customized marketing pieces for distribution by mail or other delivery service.

A survey module 214 enables the client 108 to listen to and understand the thoughts and ideas of the recipients 112 through strategic surveying, including creation of phone surveys, voice over interne protocol (VOIP) communications, and a phone database entry to facilitate future interactions by making the client aware of message recipient interests.

A group's module 216 allows the client device 108 to interface with social networks by means of group surveys and e-mail and facilitates opening dialog between the client device 108 and an on-line community of recipients 112.

A data module 218 provides for cleaning, standardizing, enhancing, matching and updating data about the recipients 112 including change of address updates and other validation of the database data for the recipients 112.

An analyzer module 220 advantageously provides real-time analytics on marketing tactics and return on investment by comparing and analyzing use of the contact device 114 modules.

A subscriber module 222 provides centralized client management of subscriptions to the various communications modules or contact devices 114 while keeping track of the profile attributes for the recipients 112 according to which particular messages are communicated thereto. Thus, the subscriber module 222 is a user web managed module which allows the client devices 108 to login and manage the preferences for their accounts. In addition, the subscriber module 222 allows the client devices 108 to manage client interests, lists the clients belong to, frequency of communications, preference of communication modes (e.g., email, text, or autodial calls) and provide feedback on the services. Through the subscriber module 222, the client devices 108 can also maintain personal information such as phone numbers, addresses, emails or individual recipients 112 with whom the clients want to communicate.

A manager module 224 provides centralized management of the demographic group definitions of the recipients 112 for communicating messages or advertising to specific demographics, including a scheduler module 226 for scheduling such messages or advertising and a reports module 228 for providing information on the status of such messages and/or advertising in a meaningful way for presentation on the client devices 108.

In addition, an advertising module 230 provides a web based advertisement insertion and tracking module using webpage banner ads. The advertising module 230 also tracks the results of the advertisements back to the individual recipients 112 within the database of the client devices 108, advantageously allowing for immediate feedback of recipient 112 interests with data confirmations via data touch points. The banner ads are managed from the advertising module 230 and the analytics are implemented from the analyzer module 220.

A sequencer module 232 is a web management module that allows the creation of communication plans integrating various other host computer 102 modules. Thus, a communication plan using triggers from the various host computer 102 modules can initiate an automatic communication from the same or another module utilizing the sequencer module 232. For example, an email announcing an upcoming event can be sent using the mailer module 206. When the user signs up for the event, the mailer module 206 immediately sends out a confirmation email. Then, as the event approaches, a text message is sent out by the messenger system 208 the day before as a reminder and an autodial call is placed by the dialer module 210 on the day of the event as an additional reminder. Any number of communication events can be designed and “sequenced” by the sequencer module 232 based on timing or data touch points being collected.

The host computer 102 also includes an online donation module 234 that can be incorporated into clients' websites thereby allowing the client devices 108 to facilitate collection of donations, such as processing credit card transaction through a central credit card gateway. As in all modules, the transactions are logged to the individual recipient 112 which then can be used for analytic purposes. The fund raising campaigns are managed through the host computer 102 as are the resulting communications, such as confirmation emails.

Other modules can easily be added to the set of instructions 104 at the host computer 102 to allow additional functionality which can increase the analytical and communication capabilities of the system 100. Also, each of the client devices 108 need not utilize all of the modules available allowing for greater utilization by more proficient clients 108, while allowing basic utilization for less proficient clients 108.

### Overview of Clients

With reference to FIG. 3, the client devices 108 access the host computer 102 through a conventional personal computer with network connections to the network 106, such as to the World Wide Web. Each client device 108 includes multiple client modules 110. These client modules 110 include modules for administrative matters 302, system settings 304 to configure the operation of the communications system for the particular client, establishing users 306 authorized to access and operate the modules of the host computer 102, maintaining a database of recipients 308 receiving messages communicated by the communication system 100, and a reports module 310 for reporting on messaging and communication activities.

### Overview of Contact Devices

Referring next to FIG. 4, the contact devices 114 of the recipients 112 available within the communication system 100 include electronic mail 402, telephone 404, cell phone 406 (both voice and text messaging), and written correspondence via street address 408. In addition, the database of recipients 308 (FIG. 3) may include for each recipient 112 an associated geographic location (state, county, voting precinct, or other geographic boundary identifier) 410 and a demographic profile 412. The demographic profile includes age, educational background, annual income, or other identifying and grouping characteristic maintained by the client device 108. The contact device 114 information including the demographic information 412 is obtained 116 through a variety of ways including public information about the recipient 112, registration information submitted to the client by the particular message recipient 112, or affiliation or membership information, and the like.

### Initialization and Administrative Functions

In reference to FIG. 1, the client devices 108 access the host computer 102 through a conventional personal computer with network connections to a network 106, such as to the World Wide Web. Upon initiation of the communications system 104, the system checks the client's computer for proper software configuration for interfacing with the host computer 102. In the illustrative embodiment, the system operates with Microsoft SILVERLIGHT software provided as a free plug-in available to MACINTOISH and PC computer devices to facilitate a dynamically rich interface for on-line applications. An appropriate screen is then displayed in a manner well-known to those skilled in the art.

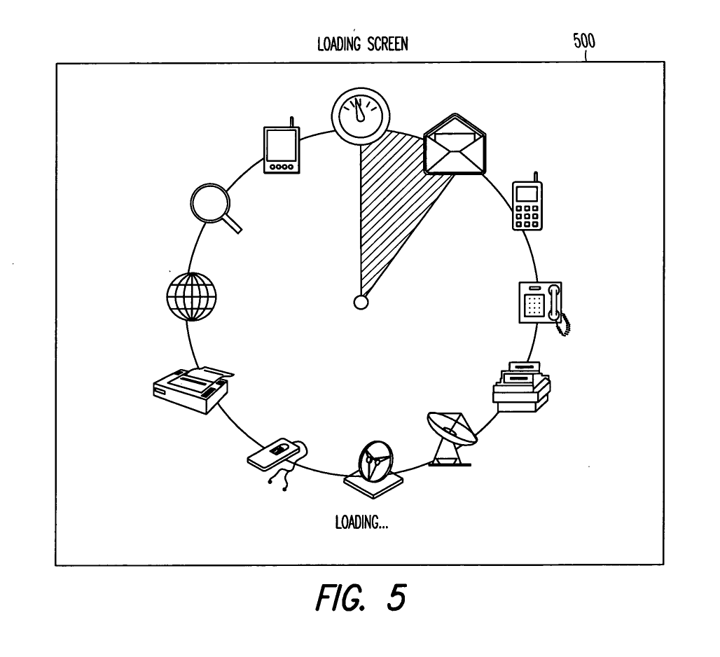

If the client's computer lacks the SILVERLIGHT plug-in, a hot link is provided for installing this plug-in from a conventional supplier. If the SILVERLIGHT is installed on the client device 112, a button is displayed for continuing the loading of the instructions 104 for operation by the host computer 102. Alternate embodiments may be gainfully developed with other executable software. Referring to FIG. 5, once appropriate executable software is located, a loading screen 500 is displayed on the client's computer and provides a graphic about the communication system and a message that the system is loading.

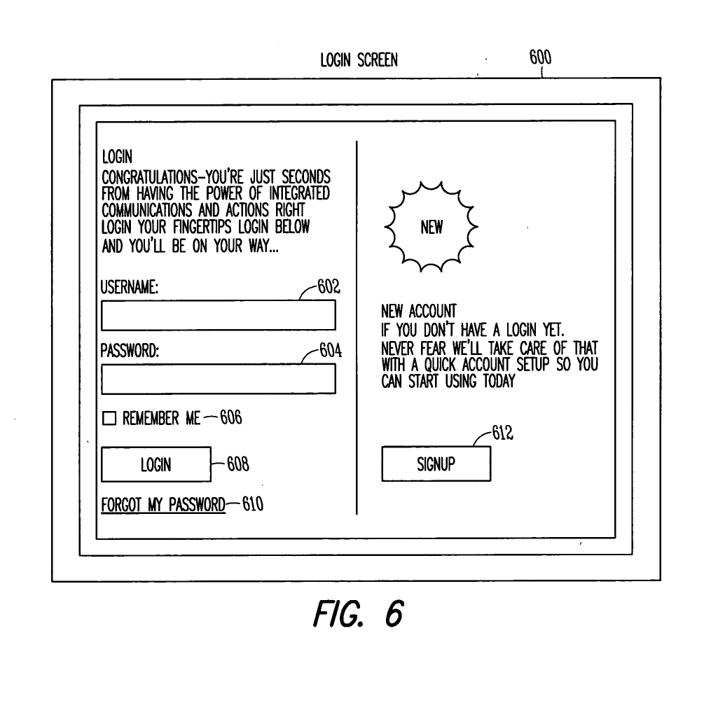

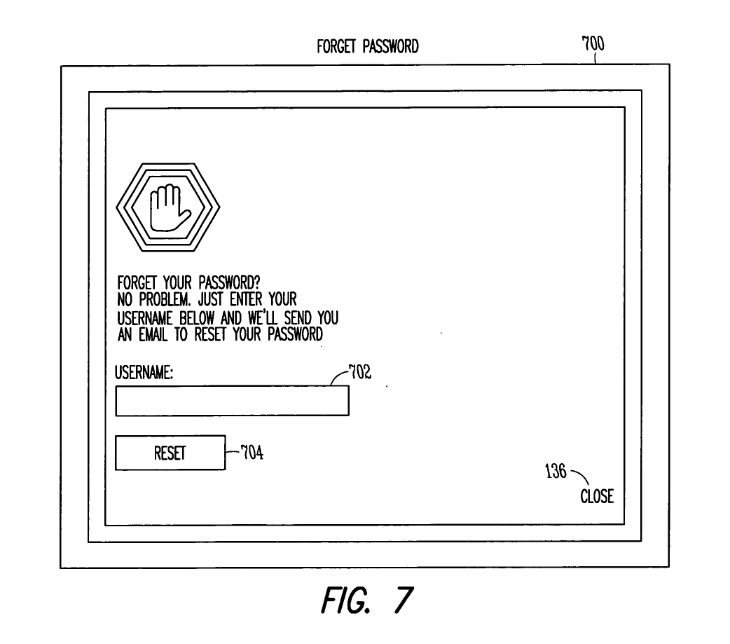

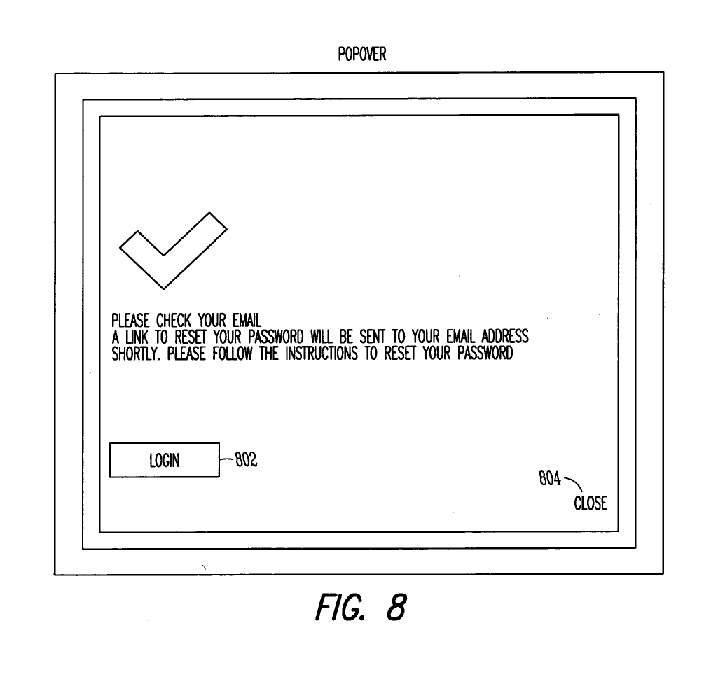

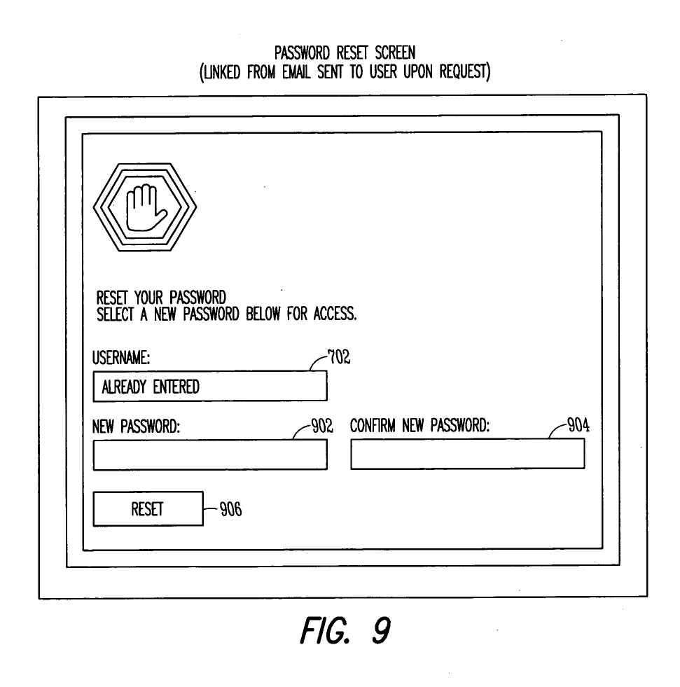

FIG. 6 illustrates a log-in screen 600. The log-in screen 600 includes a user name field 602 and password field 604. A “remember me” box can 606 be checked so that the user's computer remembers the password for the particular user name. A log-in button 608 enters the user name and password to the host computer 102 for validation. A “forgot my password” link 610 brings up a “forgot password” screen 700 shown in FIG. 7. In such event, the user enters the user name in the user name field 702. A reset button 704 submits the user name. The host computer 102 responds with an email message to the e-mail address associated with the client device 108. The email (not illustrated) includes a temporary password. As shown in FIG. 8, the client device 112 displays a “login” button 802 to link to a password reset screen illustrated in FIG. 9. A close button 804 returns control to the log-in screen displayed in FIG. 6.

The password reset screen is illustrated in FIG. 9. With reference to FIG. 9, the user name is already entered to the user name field 702 from the login “forgot password” screen 700 illustrated in FIG. 7. The user enters the new password in the new password field 902 and confirms the new password in field 904. The control button reset 906 resets the password. With continuing reference to FIG. 6, a new account can be initiated with the new account sign up button 612. New account information is discussed below.

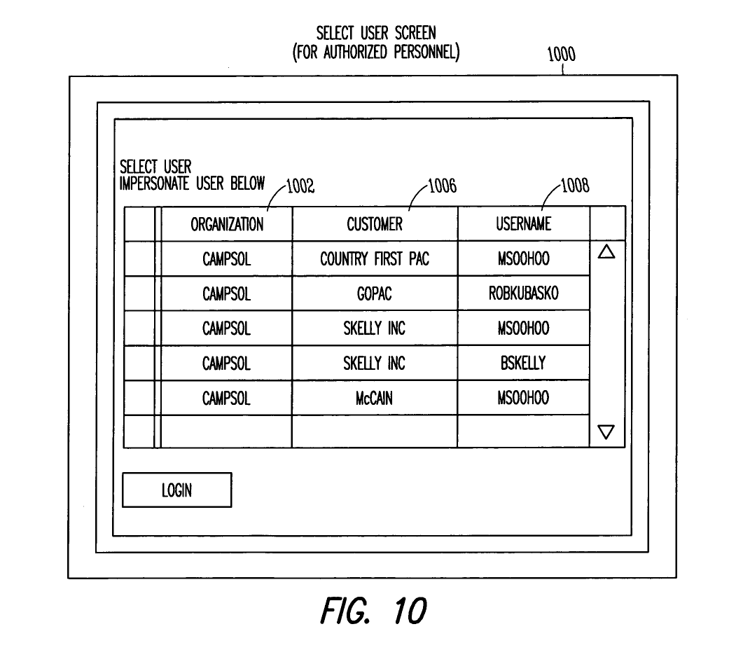

FIG. 10 illustrates a select user screen for use by authorized personnel to enter, edit, maintain, and update user information about particular clients 108. The screen 1000 includes the name of the organization 1002 associated with the client 108, the name of the user or customer 1006, and the login user name 1008.

### Message Analysis Module

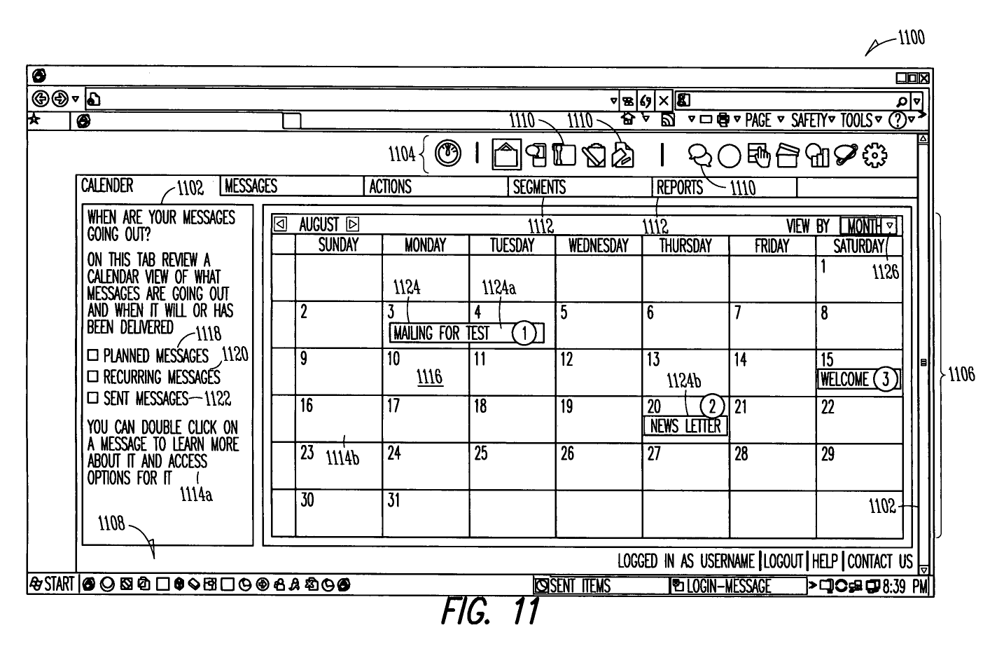

FIG. 11 illustrates a control screen 1100 in the message analysis module for analyzing messages within the broadcasting message system, and depicts the calendar screen 1102 in the message analysis module. The screen used in each module is divided into three areas: a header 1104, a module portion generally 1106, and a footer 1108. The header 1104 includes icons 1110 associated with each of the modules of the instruction set 104 of the host computer 102 to which the particular client 108 is permitted access. The modules area 1106 includes the tabs generally 1112. In the message analysis module, the tabs are “Calendar”, “Messages”, “Actions”, “Segments” and “Reports”. The user's current location in any given module is indicated by an active tab. An active tab is illustrated graphically using a primary color so as to distinguish one tab 1112 from another. Each tab includes one or more panels 1114. In the illustrated calendar screen 1102, a first panel 1114a includes information about the calendar and a second panel 1114b includes a calendar. Generally, in each module and tab, the information panel 1114a includes information describing the panel 1114b.

In the illustrated tab, the calendar panel includes a particular month designated by a date field 1116. The calendar shows planned messages 1118, recurring messages 1120, and sent messages 1122. These correlate to message headers (1124a and 1124b for example) displayed on the calendar page. The messages 1118, 1120 and 1122 can be distinguished by display in differing colors. A date selection button 1126 enables viewing the calendar screen 1102 by a selected time period: day, week, month, quarter, or year. The calendar is changed through a dropdown window. A message header 1124 is displayed on a date (or dates) over which the particular message was sent or is scheduled to be sent.

FIG. 11 illustrates a header 1124a for a test mailing that was sent on August third and fourth. The message bar 1124 is active. For messages already sent, the user can select the message bar 1124 and transfer control of the program to an analysis display, discussed below. For scheduled messages, the user can select the message bar, for example 1124b, and transfer control to the edit module to edit the pending message. The host computer 102 provides a popover display to confirm that the user desires to edit the scheduled message.

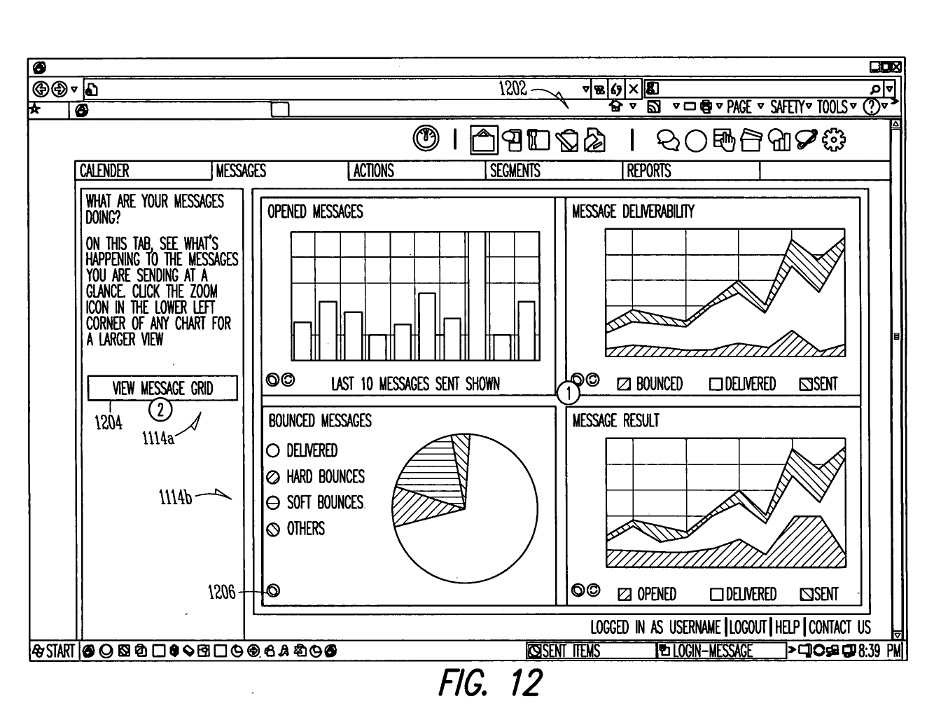

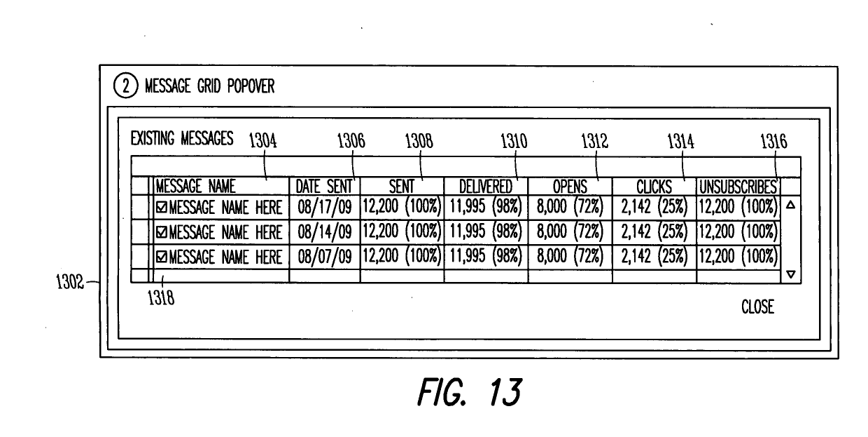

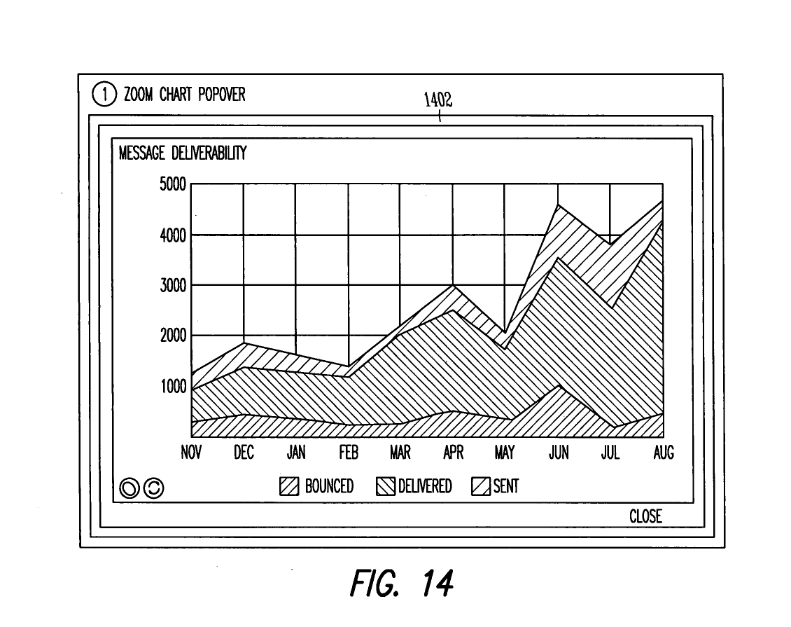

FIG. 12 illustrates a screen 1202 that displays message performance. The screen 1202 is accessed through the “Messages” one of the tabs 1112 (FIG. 11). Similarly to the communication screen 1100, the performance screen 1202 includes a text panel 1114a that explains the information displayed on module panel 1114b within the messages tab. A view message grid button 1204 brings up a popover message grid 1302 shown in FIG. 13. The message grid 1302 provides information about each active message contained in the communication system for the client. A conventional scroll bar with arrows (shown on the right of the grid) facilitates display of the messages in the grid. The message grid 1302 includes the message name 1304, the date sent 1306, the quantity of messages sent 1308, the quantity of messages delivered 1310, the quantity of messages opened 1312, the number of additional links or information accessed by recipients in the message (the “clicks”) 1314 and the number of unsubscribes 1316 resulting from the delivery of the message. The number of “opens” and the number of “clicks” indicates the relative success of the message. A checkbox 1318 activates the particular message for including in the charts on the display screen 1202. The display screen 1202 includes graphs or charts of the selected messages: opened messages information; message deliverability including color differentiated messages that were bounced, delivered and sent; and message results. Charts are selectable for display in picture graph form, pie chart, or other graph display. With reference, for example to the pie chart, the bounced messages can be observed as to type of bounce. Also displayed is the result of the message, including the number of messages sent, delivered, and opened. As depicted in FIG. 14, the user may select one of the graph charts 1402 for showing as a zoom chart popover. This is accomplished by the zoom button generally 1206 (FIG. 12) included with each of the graph charts.

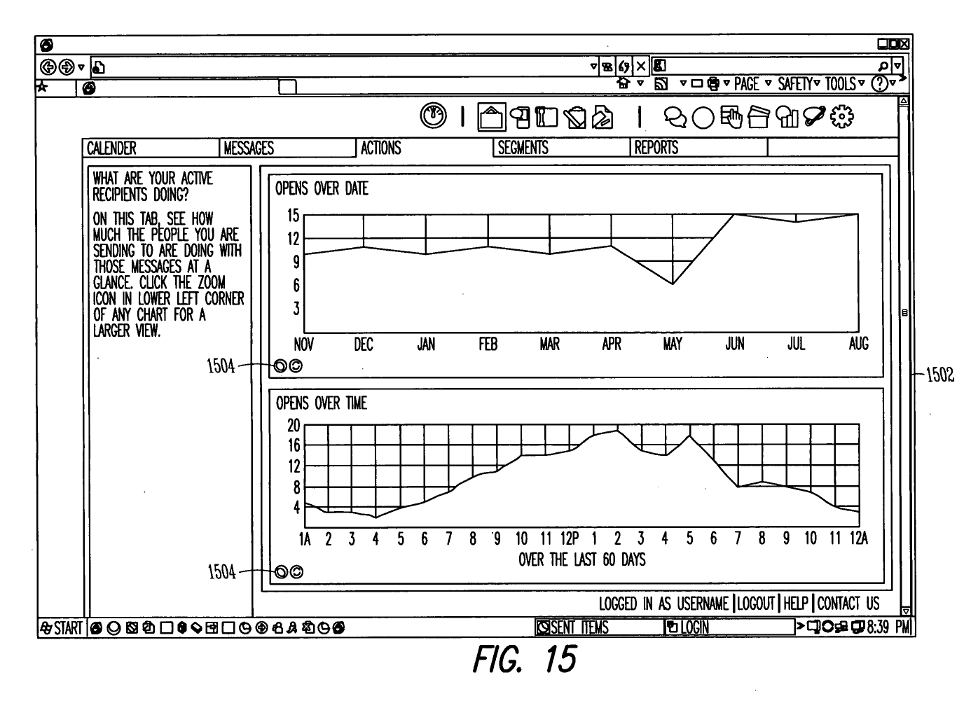

FIG. 15 illustrates a display screen 1502 illustrating actions taken by the message recipients 112 relative to messages sent by the client devices 108. The graph charts show the number of message recipients 112 opening the message over a particular date or opening the message over a time period. A zoom button 1504 is operated to provide a larger view on the screen of the particular chart.

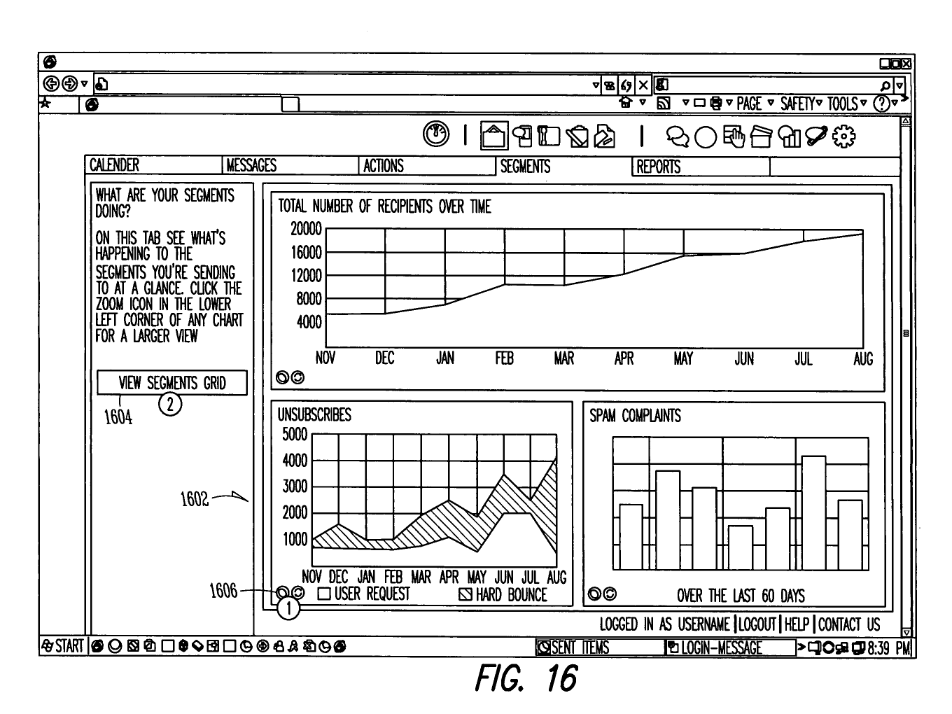

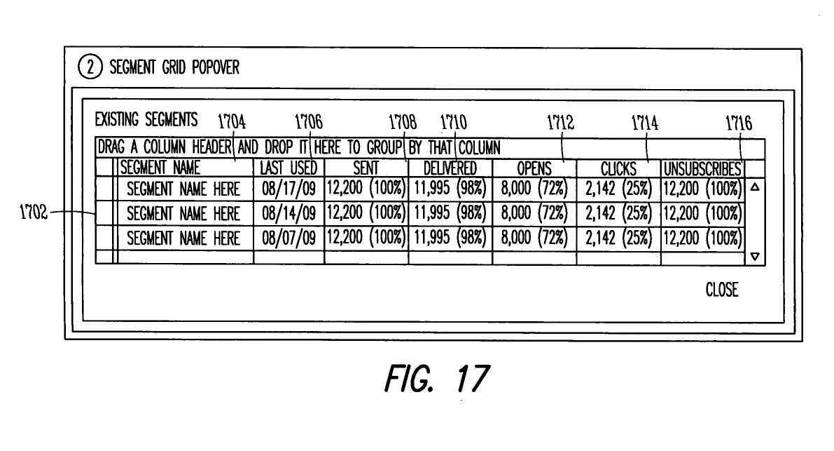

FIG. 16 illustrates a screen 1602 accessed by the “Segments” one of the tabs 1112 and the panel with a graph chart of performance of message segments. (The term “segment” refers to a grouping of recipients 112 included within the recipients database 308 of the client 108, as discussed below). A segment grid button 1604 is activated to display a segment grid popover 1702 illustrated in FIG. 17. The segment grid 1702 includes the segment name 1704, the date the segment was last used 1706, the number and percent of segment messages sent 1708, the number and percent of segment messages delivered 1710, the number and percent of segment messages opened 1712, the number and percent of messages clicked 1714, and the number and percent of unsubscribes 1716 resulting from the transmission of the message to the segment. As is conventional with graph charts, the different information is displayed in distinguishing colors or other distinguishing symbols.

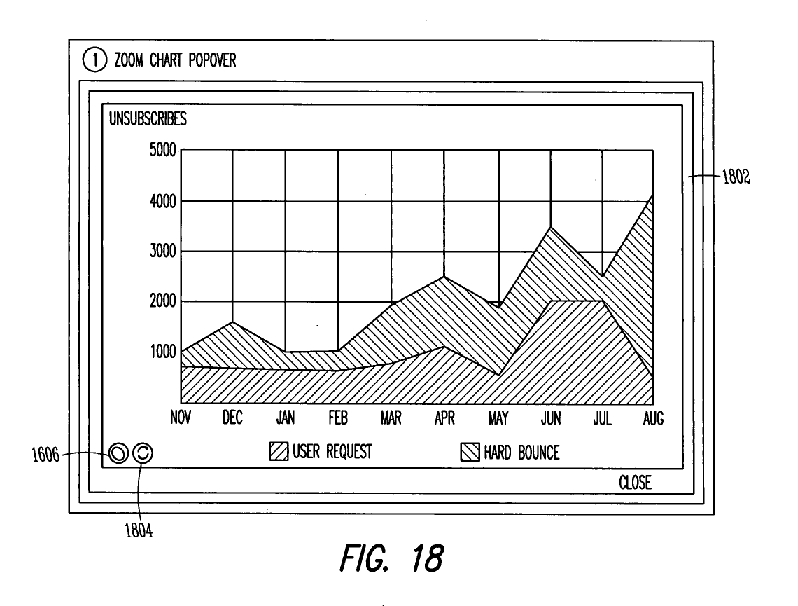

With continuing reference to FIG. 16, the segment performance display screen 1602 includes graph charts of the segment information, including the total number of recipients over time, the number of unsubscribes, the number of spam complaints. A zoom chart button 1606 displays as a popover an enlarged view of the selected chart, for example a chart 1802 as shown in FIG. 18. A return button 1804 returns the display to the segment performance screen 1602 shown in FIG. 16.

In addition to segment performance screen 1602, a reports selection screen will allow the client 108 to generate custom reports. The custom reports will allow the client 108 to select charts and data to be displayed based on the clients' preferences for staying informed as to the messages, actions and message receivers.

### Management Module

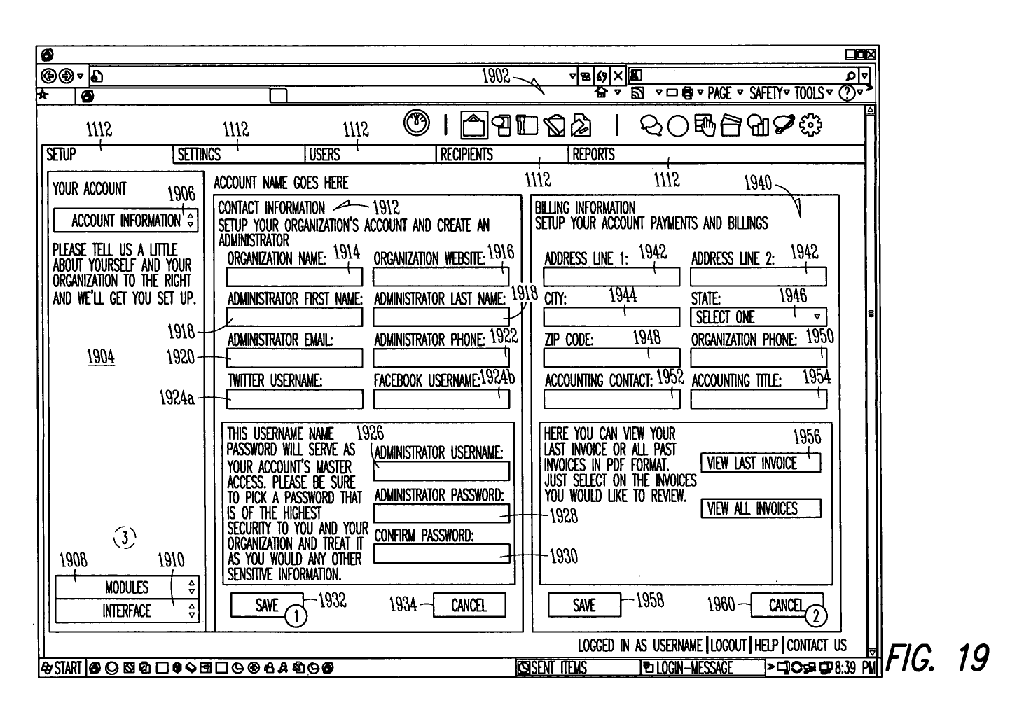

As discussed above in relation to FIG. 2, the host computer 102 includes the management module 224 by which the client 108 establishes account information, system settings, identifies users and recipients and characterizes reports. FIG. 19 illustrates a display screen of the management module 224. The screen includes tabs 1112 entitled “Setup”, “Settings”, “Users”, “Recipients”, and “Reports” for accessing those management functions. FIG. 19 particularly illustrates the account setup screen 1902 in the management module 224 of the host computer 102. The setup tab 1904 includes an account information button 1906, a module selection button 1908, and an interface button 1910. The account information button 1906 brings up the screen 1902 shown in FIG. 19. The account information includes contact information generally 1912, including fields for the organization name 1914, the organization website 1916, the administrator name 1918 and the administrator contact information including e-mail address 1920, phone 1922 and social website user names 1924a, 1924b. An administrator user name field 1926 identifies the user name providing master access for the account of the particular client 108. The administrator password field 1928 receives the password and a confirm field 1930 verifies the correct password was entered. A save button 1932 records the information in the account information data base. A cancel button 1934 clears the data fields for re-entry.

Billing information generally 1940 includes account billing address 1942, city field 1944, state field 1946 and zip code field 1948. Fields are provided for the organization phone 1950, the contact name 1952, and the title of the contact 1954. Billing status including prior invoices can be selectively displayed with select buttons 1956. A save button 1958 saves the billing information to the account data base. A cancel button 1960 clears the fields for re-entry of the billing information.

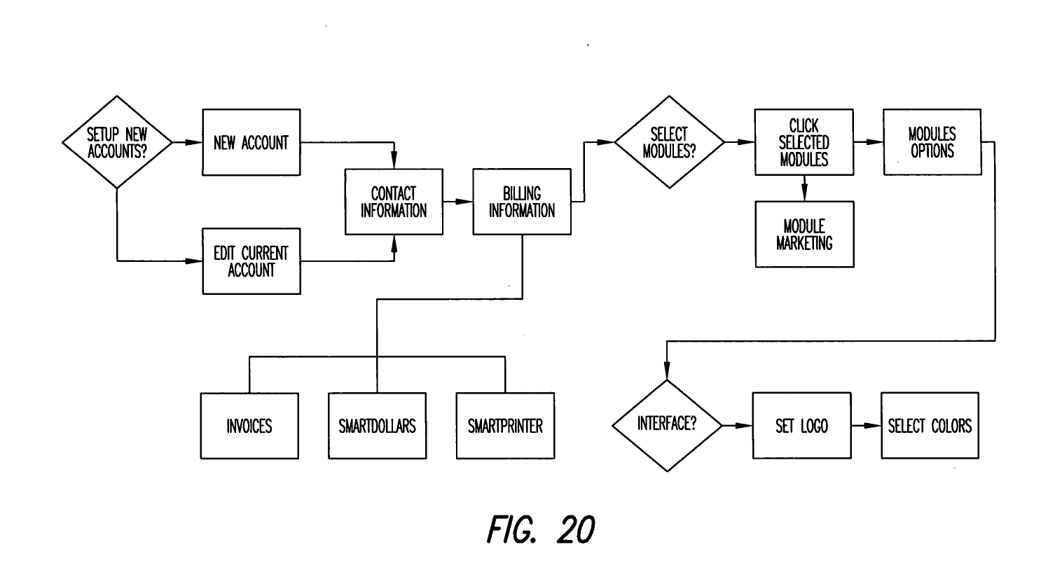

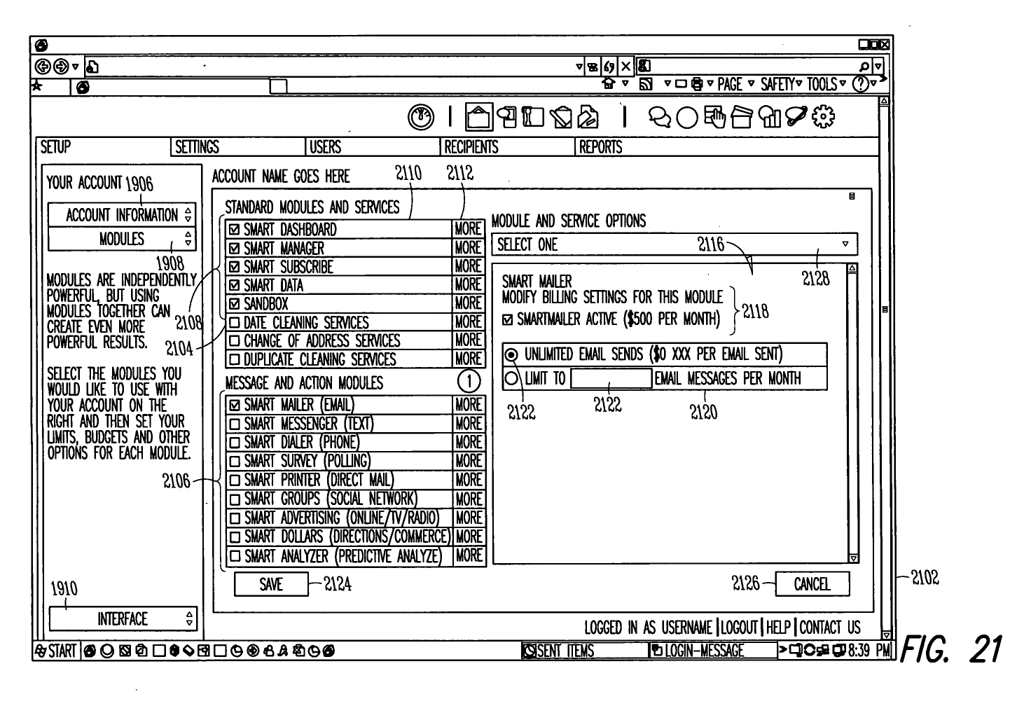

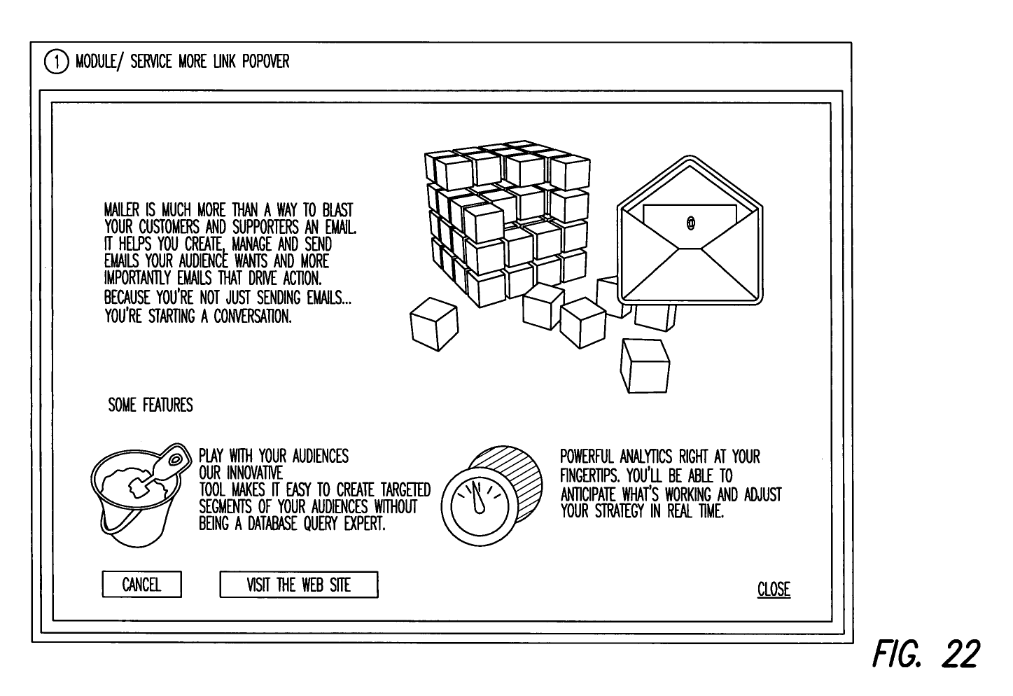

Referring to FIG. 20, a flowchart is depicted which illustrates navigation of the new account setup routine of the management module 224. The portions of the operation of the new account setup routine that are depicted in FIG. 19 are darkened in FIG. 20, below. Referring to FIG. 21, portions of the flowchart of FIG. 20 that are depicted in FIGS. 21 and 22 are darkened in the flowchart of FIG. 20 therebelow. FIG. 21 illustrates the module selection screen 2102 in the account management module for the messaging system. The module selection screen 2102 includes a list of standard modules and services generally 2104 and message and action modules 2106. Both selections include a check box 2108, the name of the module 2110, and a button 2112 by which additional information relative to the selected module can be displayed. The button 2112 activates a popover image shown in FIG. 22 that displays the additional information (see circled reference number 1). The user thereby learns about features and advantages of the particular module and may thus desire to subscribe to that module as part of the services contracted with the administrators of the host computer 102.

The screen 2102 illustrates the module and service options for the mailing module 2116. This includes selection to modify billing settings 2118 and the number of e-mails that can be sent per month 2120. The “emails per month” option is made with a selectable radio button 2122 for unlimited e-mails and for a limited number of emails per month with a field in which the number of e-mail messages per month can be entered. (A radio button allows the user to select between mutually exclusive options.) A save button 2124 enters the information to the accounting data base. A cancel button 2126 clears the selected modules for re-selecting. The options for other of the modules are displayed upon selection using the drop down menu 2128.

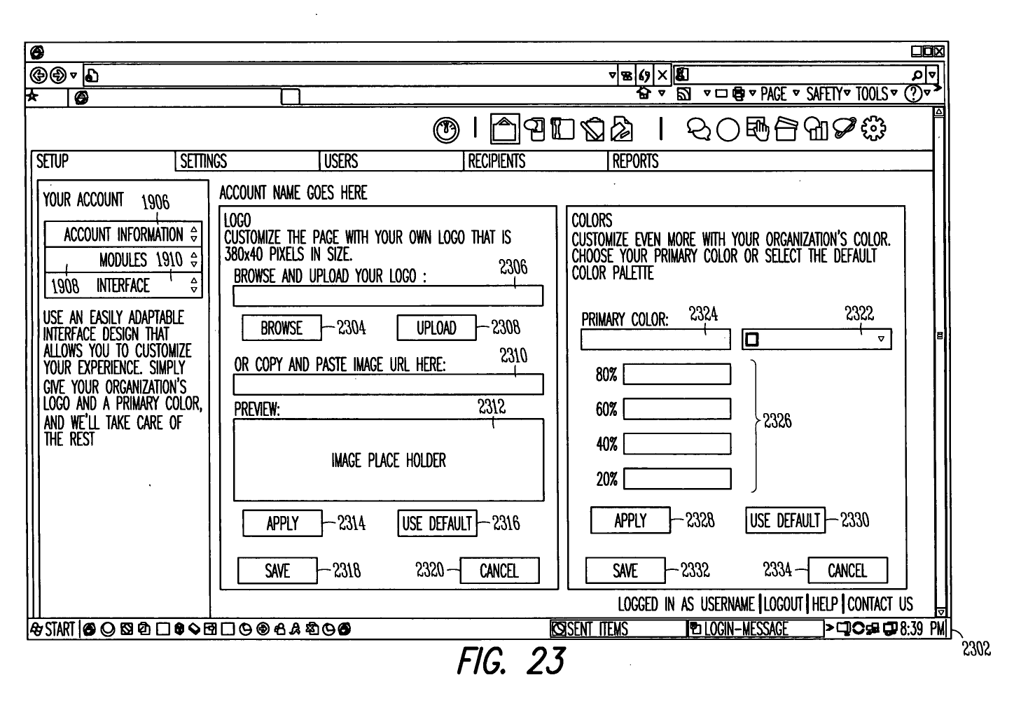

FIG. 23 illustrates a report customization selection screen 2302. Customization includes providing a client logo to the host computer 102 for display in reports and graph charts and other uses. A browse button 2304 enables selecting a data file, such as from the local user's computer, which is displayed in a logo data file field 2306. An upload button 2308 uploads the data file to the client information maintained by the host computer 102. Alternatively, an image URL can be entered in the URL field 2310. A preview window 2312 displays the uploaded image. An apply button 2314 and use default button 2316 direct the system to use the logo in reports and charts. A save button 2318 saves the uploaded image to the client information. A cancel button 2320 clears the selected logo data file name or URL.

The graph reports can be customized with particular colors selected using a dropdown menu 2322. Upon selecting the primary color, the primary color field 2324 displays the selected color. Subsequent gradients 2326 are displayed for use in displaying of secondary information in the graphs. An apply button 2328 instructs the system to apply the selected color. A use default button 2330 instructs the system to use system default colors. A save button 2332 saves the selected color to the system. A cancel button 2334 clears the selected color.

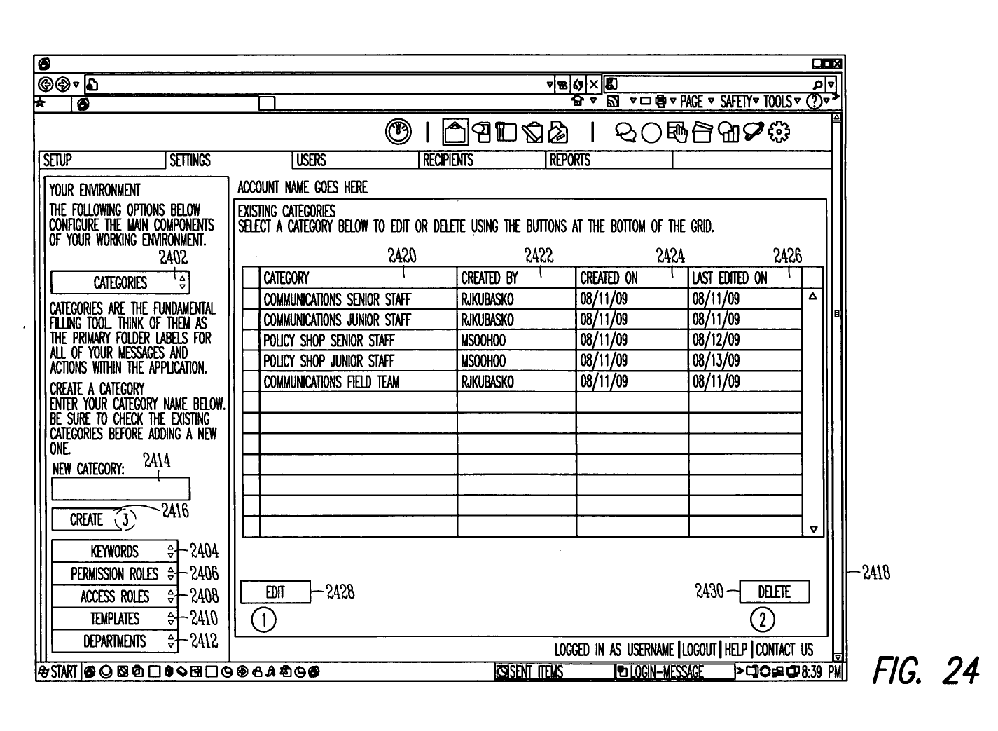

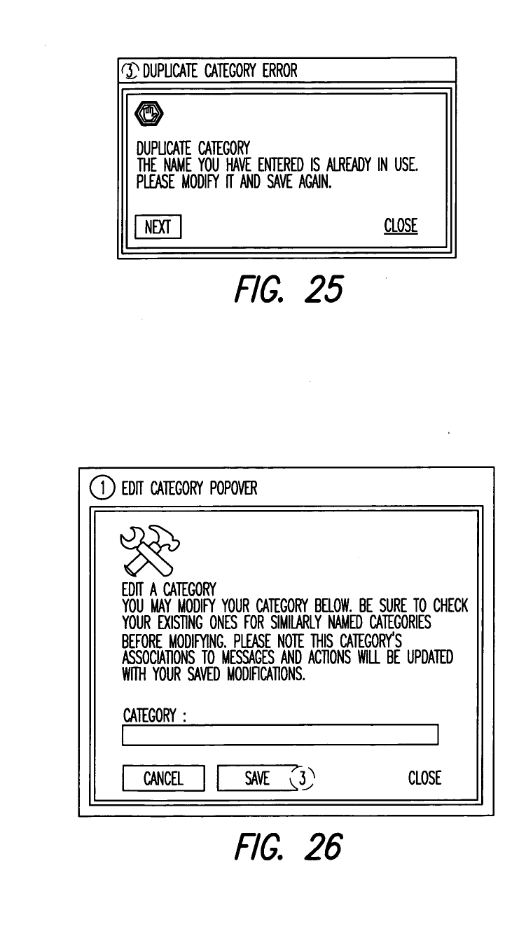

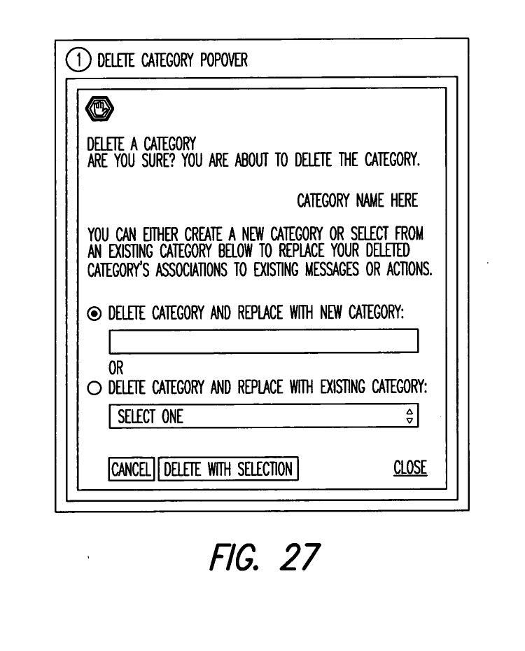

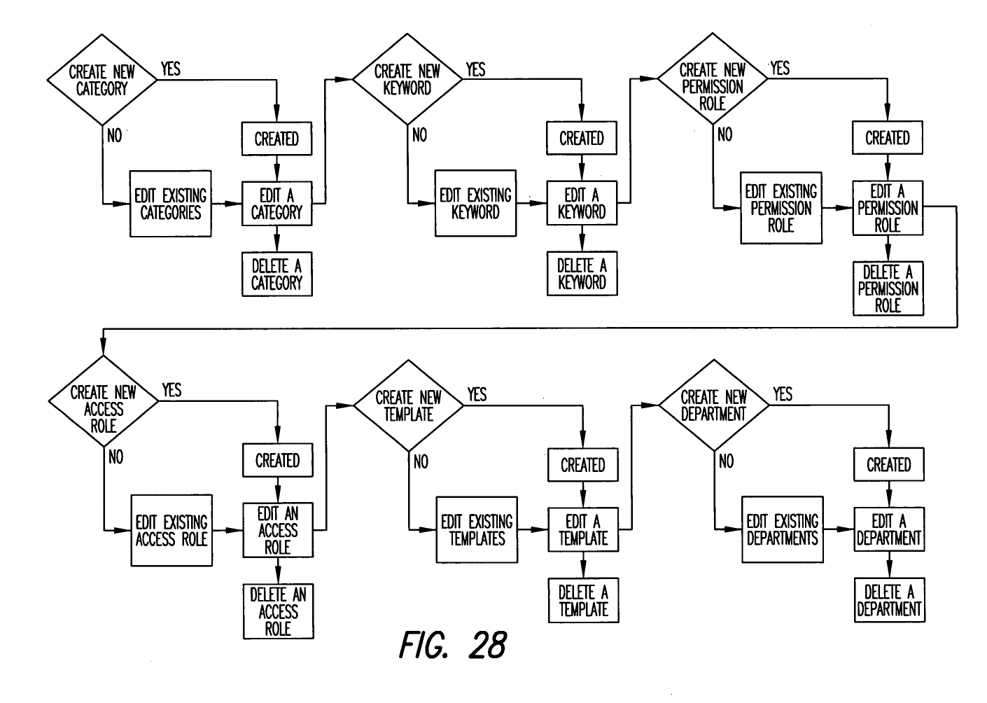

FIG. 24 displays the “Settings” tab in the account management module for the communications system 104. The settings include the category button 2402, keywords 2404, permission roles button 2406, access roles button 2408, message templates button 2410, and a departments button 2412. “Categories” are a filing tool within the host computer 102. Conceptually, “categories” are a folder labeled for messages and actions taken within the application. A new category field 2414 receives the name of the new category. A create button 2416 is used to create the new category. If the system detects a duplicate category an error message is displayed (see FIG. 25 as linked by circled reference number 3). The display screen 2418 also includes a panel with information about existing categories including the category name 2420, identification of the user who created 2422 the category, the date of creation 2424, and the last edit date 2426. An edit button 2428 is used to edit a selected one of the categories. Circled reference number 3 links to a popover display shown in FIG. 26 for creating or editing a category. A category is selected by positioning and highlighting the selected category name (using the mouse control device) and executing the edit button 2428. A delete button 2430 is used to delete a category. When activated, the delete button 2430 brings up a confirmation screen shown in FIG. 27 (see circled reference 2) which provides options to delete the category or delete the category and replace with an existing category. Referring to FIG. 28, a flowchart is depicted which illustrates navigation of the “settings” and “categories” routine of the host computer 102. The portions of the operation of the routine that are depicted in FIGS. 24 to 27 are darkened in FIG. 28.

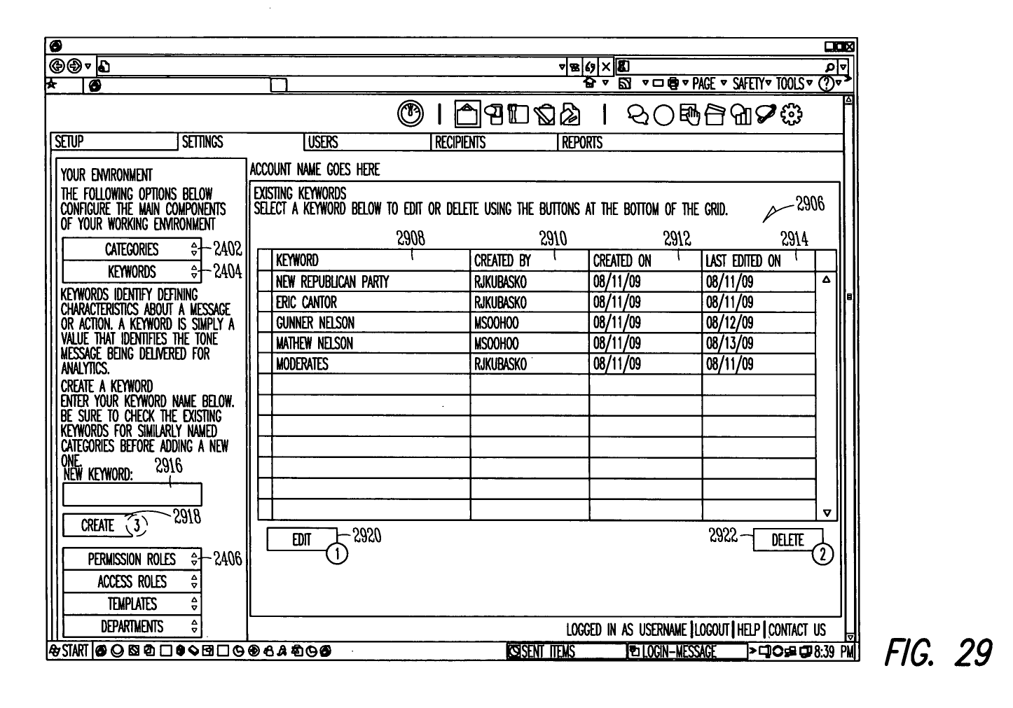

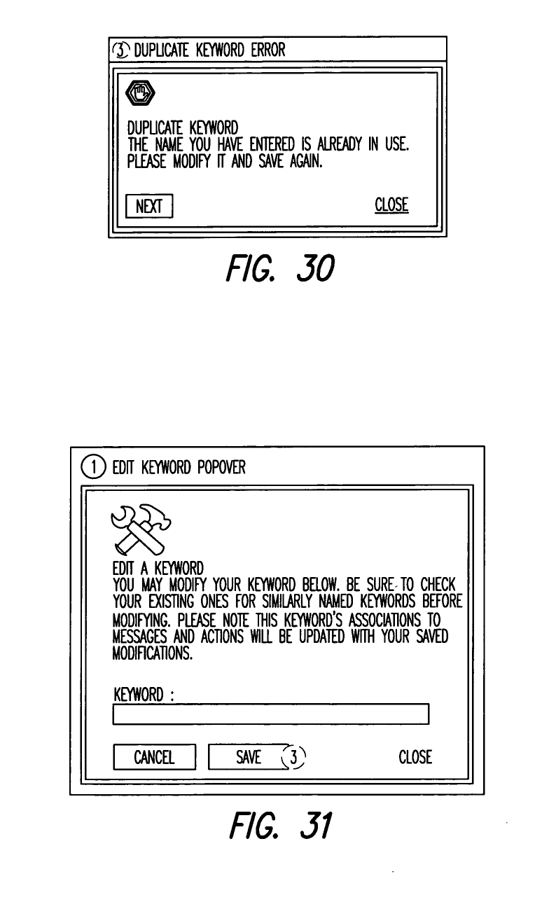

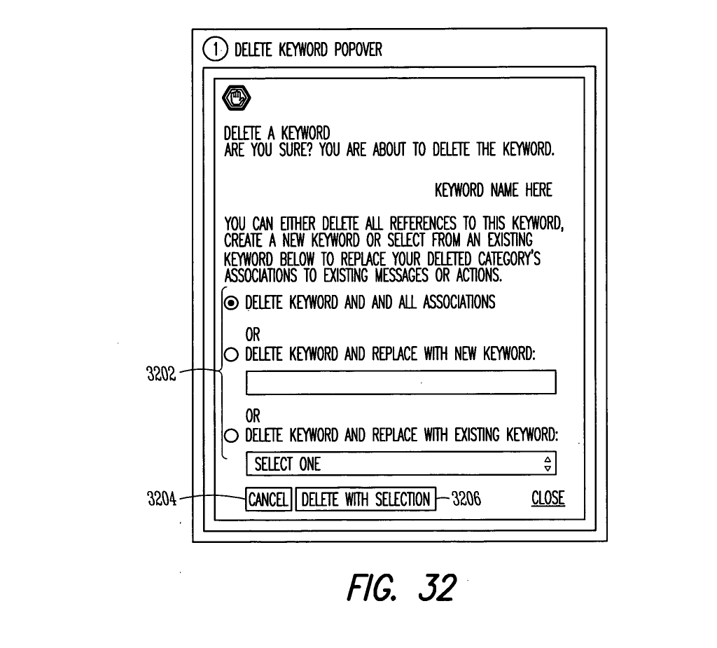

FIG. 29 illustrates a keyword screen 2902 displayed when the keyword button 2404 is activated. Keywords identify defining characteristics about a message or action and may be considered as identifying the tone or message being delivered for analytics purposes. The screen 2902 displays information about the keywords generally 2906 including the keyword 2908, the user name who created the keyword 2910, the date of creation 2912, and the last edit date 2914. A new keyword is created by entering in the keyword field 2916 and activating the create button 2918. A duplicate keyword error is shown by a display screen illustrated in FIG. 30. Keywords can be edited through an edit button 2920 or deleted through a delete button 2922. The edit button 2920 enables editing of a selected one of the keywords. Circled reference number 3 links to a popover display shown in FIG. 31 for creating or editing a keyword. A keyword is selected (using the mouse control device) by positioning on and highlighting the selected keyword and executing the edit button 2920. The delete button 2922 deletes a keyword. When activated, the delete button 2922 brings up a confirmation screen shown in FIG. 32 (see circled reference 2) which provides radio button 3202 for options to delete the keyword, delete the keyword and replace with a new keyword, or delete the keyword and replace with an existing keyword. The keyword is selectively deleted with delete button 3204 or deleted with the selection 3206 made by the radio button options.

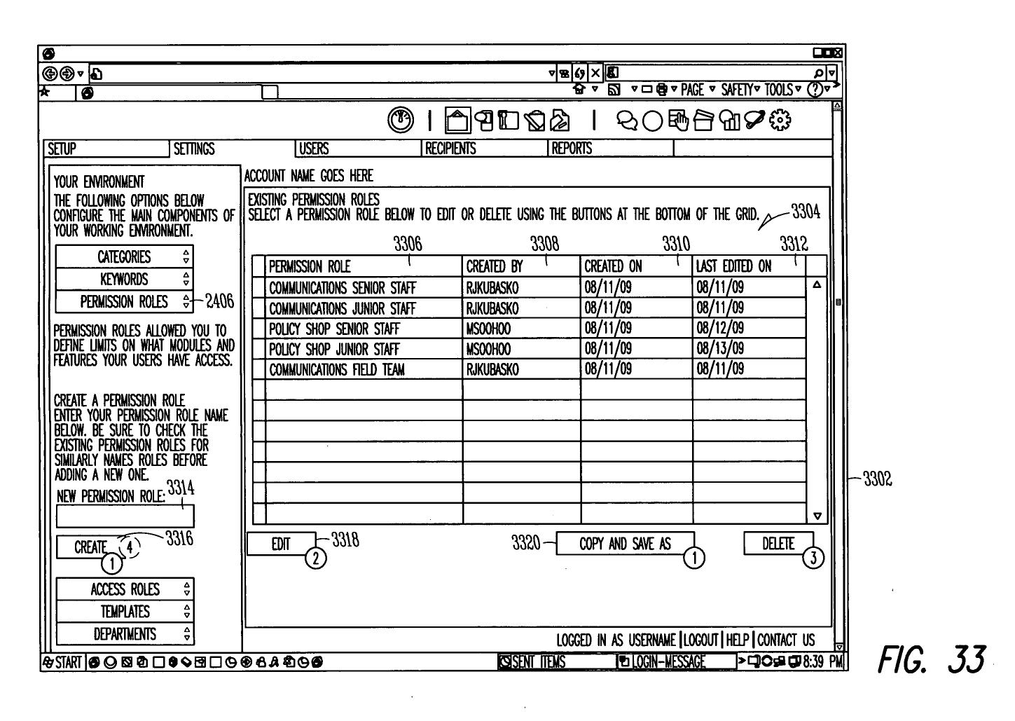

FIG. 33 illustrates a permission roles screen 3302 accessed by the permission roles button 2406. Permission roles allow the client 108 to define limits on what modules and features the users can access. The screen 3302 displays existing permission roles generally 3304 including the name of the permission role 3306, the user who created the permission role 3308 as well as the date of creation 3310 and last edit date 3312. A new permission role is created upon entering the name in the field 3314 and operating the create button 3316.

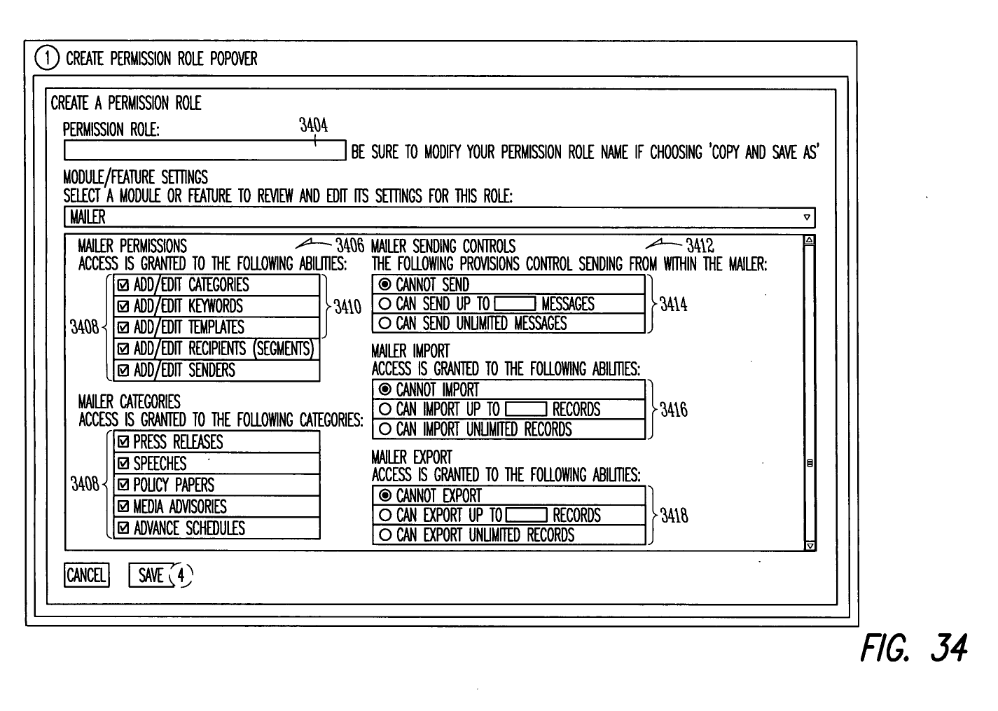

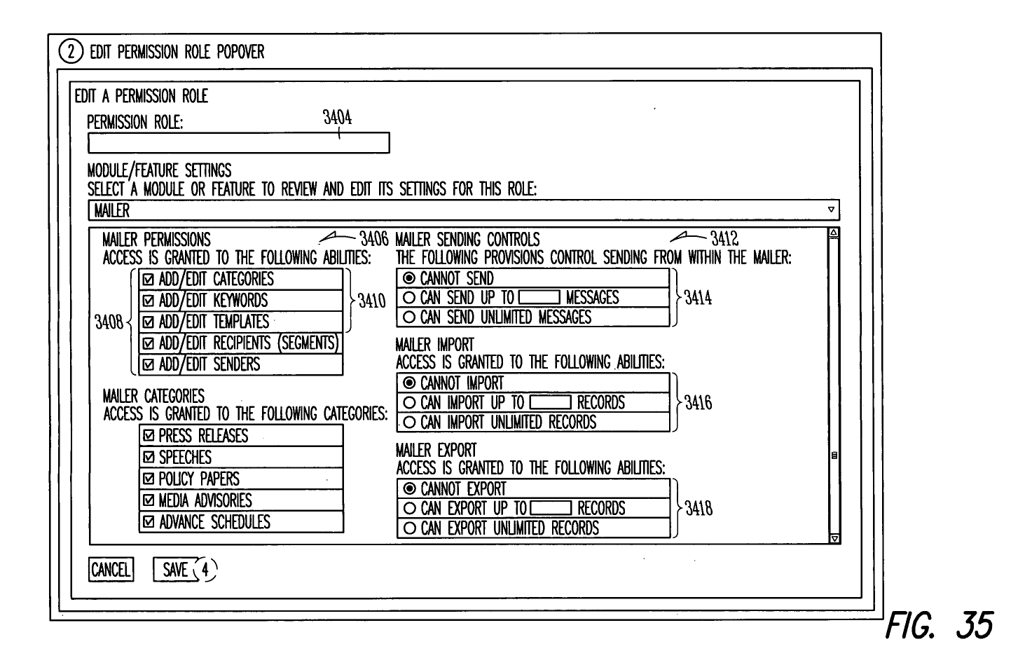

The create button 3316 displays a popover screen 3402 shown in FIG. 34 in which the permission role attributes are created. The permission role name is displayed in a display field 3404. The screen 3402 also displays modules with module access and features 3406. Check boxes or radio buttons 3408 are used to select permitted access. Permissions 3410 as to the mailer module includes add or edit categories, keywords, templates, recipients, and senders. The mail module provides access to press releases, speeches, policy papers, media advisories, and advance schedules. The mail sending control 3412 allows the client 108 to designate through selectable radio buttons whether the permission role can send messages, send a limited number of messages, or send unlimited messages (see 3414). Similarly, permissions are set as to importing data records 3416 or exporting data records 3418. A similar popover screen illustrated in FIG. 35 (see circled reference 2) is provided upon executing the edit command button 3318 displayed on FIG. 33. The selection features operate as discussed above with respect to creating a permission role.

A copy and save button 3320 permits the user to select one of the permission roles by highlighting or selecting by moving the mouse device to position the curser into a selected one of the permission role boxes and then activating the copy and save button. This creates a new permission role (see FIG. 34). The permission name needs to be modified when executing the command so that the changed permission role is not saved over the copied version.

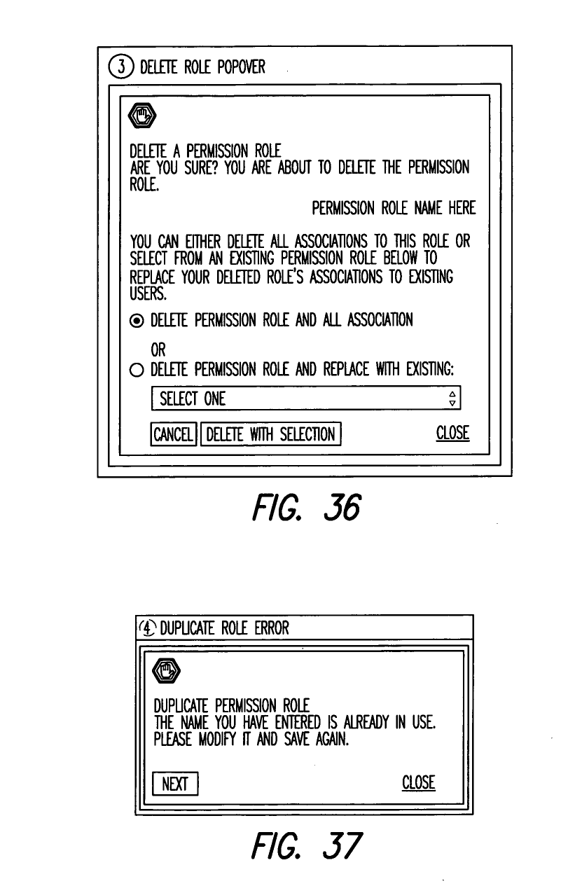

FIG. 36 illustrates a popover screen displayed for use to verify deletion of a permissions role. And FIG. 37 illustrates a popover screen displayed if the user attempts to duplicate a permissions role name.

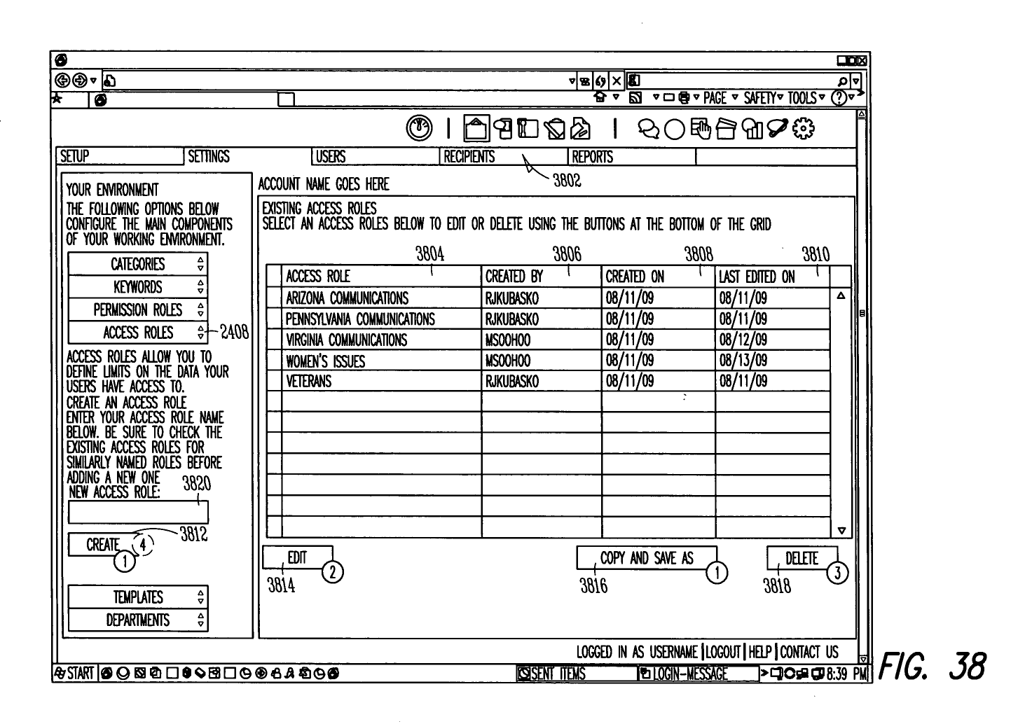

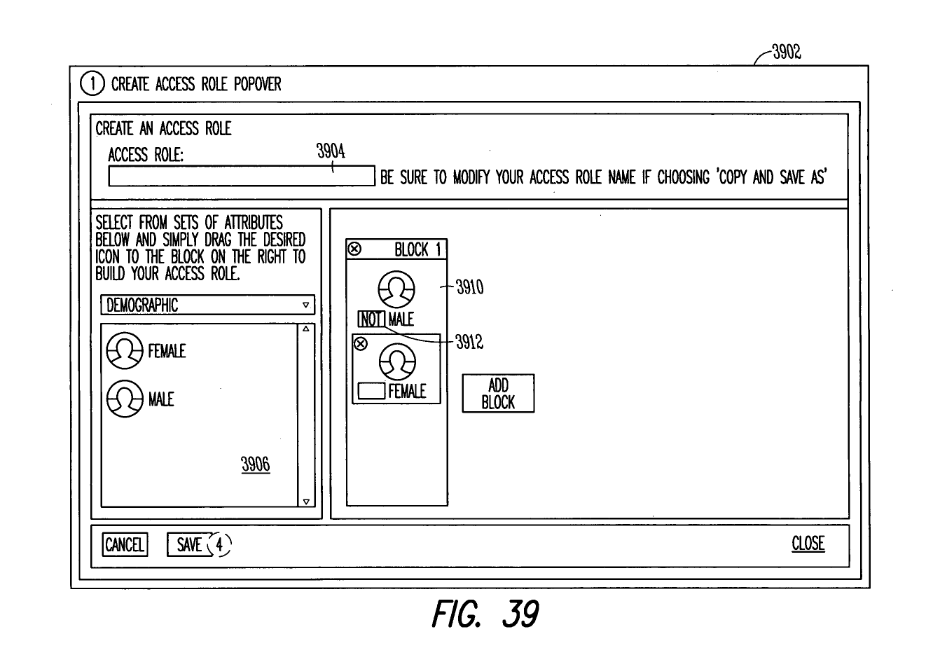

FIG. 38 illustrates the screen 3802 for assigning access roles accessed by the access roles button 2408. The screen 3802 displays existing access roles and allows creating new access roles or editing the existing access roles. “Access roles” define limits on the data to which users have access within the communication system 104. The screen 3802 displays existing access roles including the access role name 3804, the creator 3806 of the access role, the date creation 3808, and last edit date 3810. The screen 3802 also includes a create access role button 3812, an edit button 3814, a copy and save as button 3816, and a delete button 3818. The create button 3812 is selected after entry of a new access role name 3820. The create button 3812 brings up a popover screen 3902 shown in FIG. 39. The access role name is shown in the field 3904. Various attributes can be selected from a selection table 3906 accessed by a menu 3908. The selected attributes are displayed 3910 and a Boolean logic button 3912 can be selected.

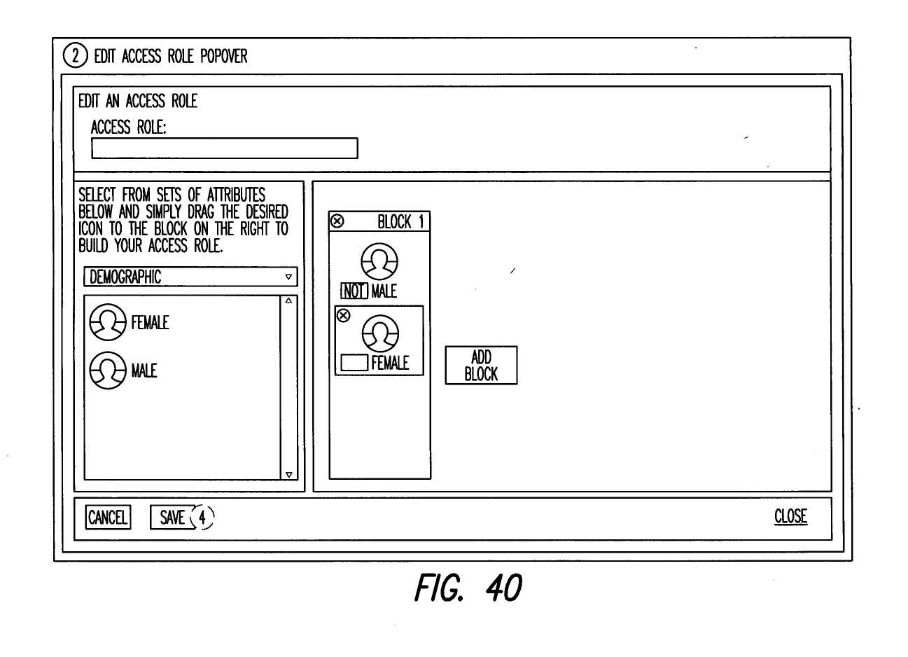

The copy and save button 3816 links to the create access role screen 3902. The edit button 3814 links to an edit screen illustrated in FIG. 40 (see circled reference 2) that functions as discussed above for the create access role screen 3902.

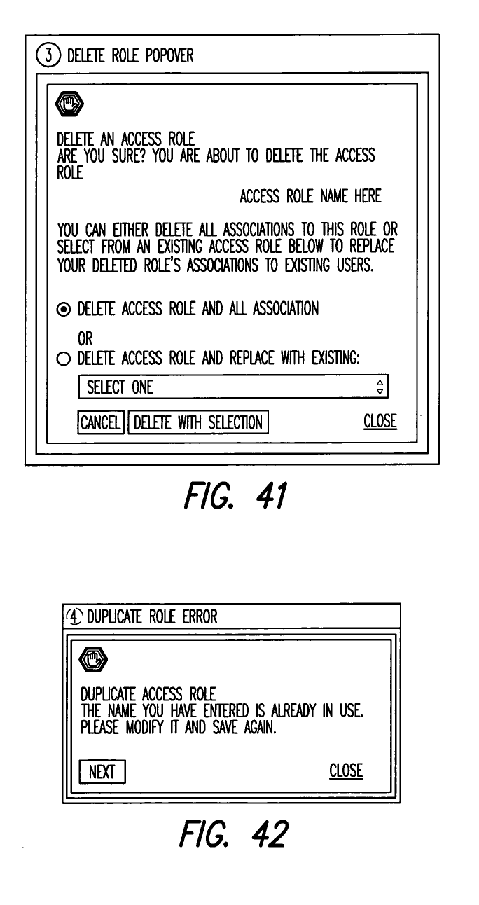

FIG. 41 illustrates a popover screen displayed for a use to verify deletion of an access role. The role can be deleted or through radio buttons deleted with a selected option of deleting the access role and associations with the access role or deleting the existing access role and replacing with an existing access role (selected by a menu). And FIG. 42 illustrates a popover screen displayed if the user attempts to duplicate an access role name.

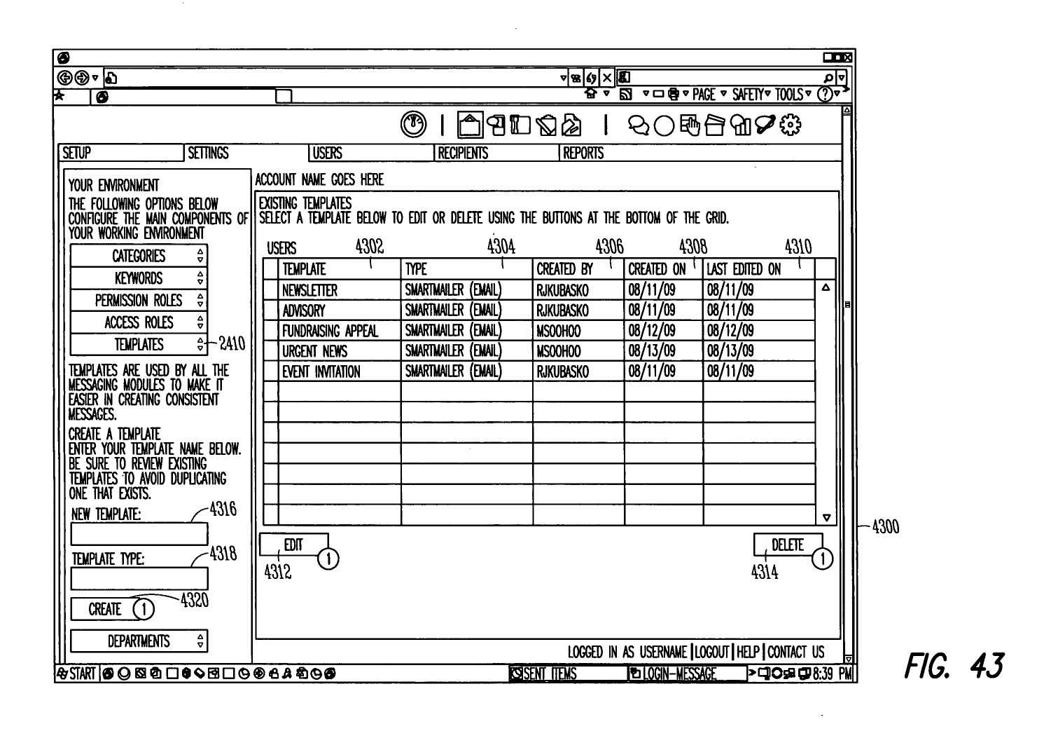

FIG. 43 illustrates the screen 4300 for developing message templates accessed by the template button 2410. Templates are used in the messaging module to facilitate creating consistent messages. Existing templates are displayed in a panel including the template name 4302, the type of template 4304, the creator 4306, the creation date 4308 and the last edit date 4310. Edit button 4312 permits editing a template. The delete button 4314 deletes a selected template. A new template is created upon entering the template name in the field 4316. The template type is selected from the menu 4318. The create button 4320 creates the new template. Although not illustrated, popover screens are provided for confirmation of editing of a template name; for deleting a template; and for advising that the attempt to create a new template name uses an already existing name.

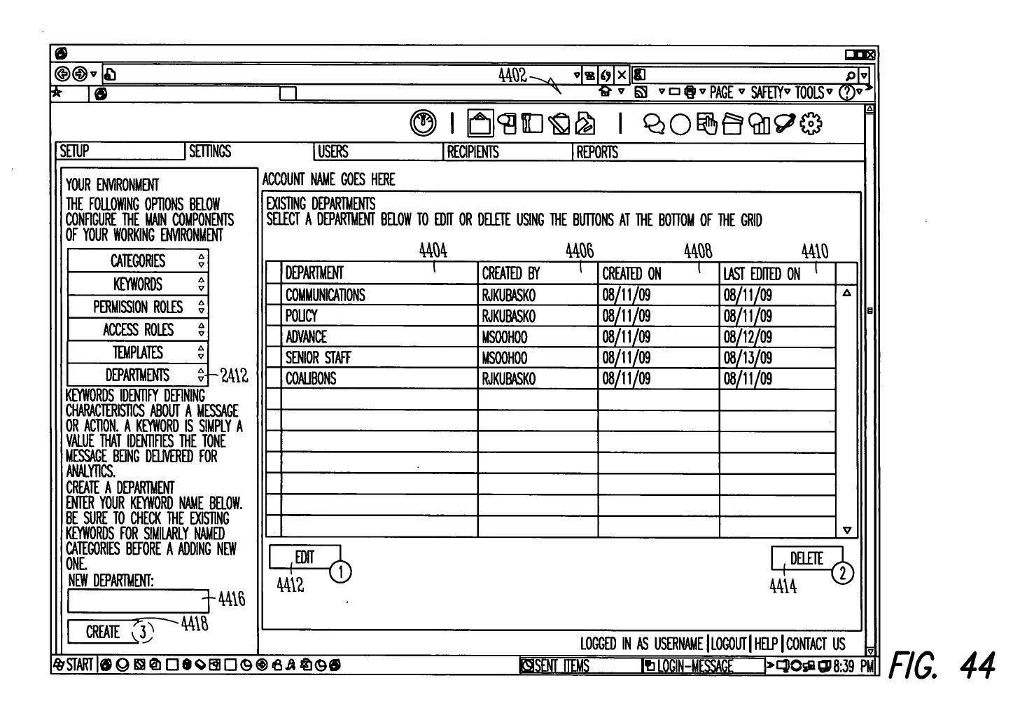

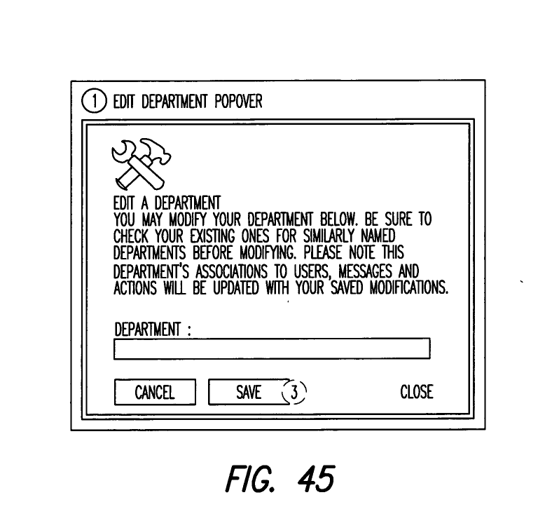

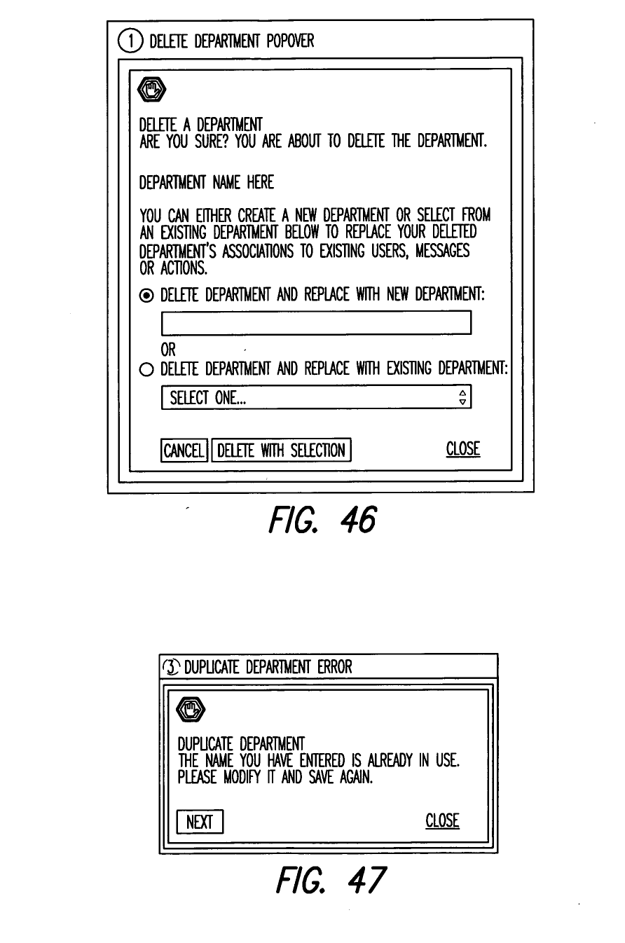

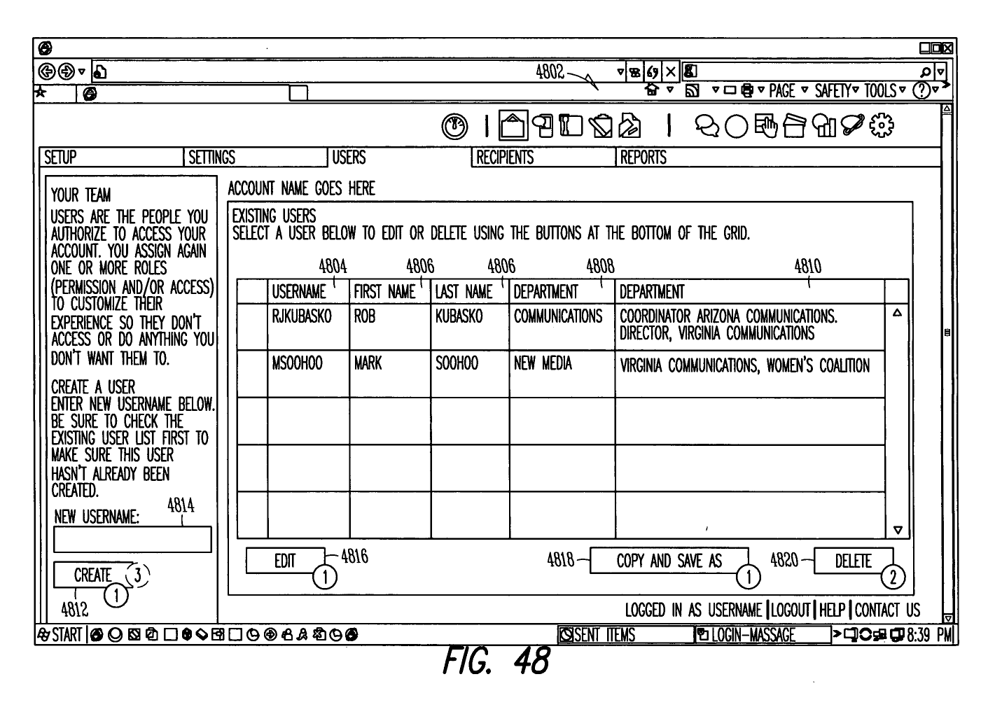

FIG. 44 illustrates the screen 4402 for assigning departments and is accessed by the departments button 2412. Departments reflect the organizational structure of the client 108. Existing departments are displayed in a panel including the department name 4404, the creator 4406, the creation date 4408 and the last edit date 4410. An edit button 4412 permits editing a department through the screen illustrated in FIG. 45. The delete button 4414 deletes a selected department through the screen illustrated in FIG. 46. A new department is created upon entering the department name in the field 4416. A popover warning message alerts to duplicate department names (see circled reference 3 in FIG. 47). The create button 4418 creates the new department.

FIG. 48 illustrates the screen 4802 for defining persons authorized to access the host computer 102 for a client 108. The screen 4802 displays existing users including the user login name 4804, the first and last name of the user 4806, the department associated with the user 4808 and the roles of the user 4810. The screen 4802 includes a create-a-user button 4812 with a name field 4814. An edit button 4816 allows selecting a user for editing purposes. A copy and save button 4818 enables selecting an existing user and copying that profile for creating a new user. A delete button 4820 deletes a selected user.

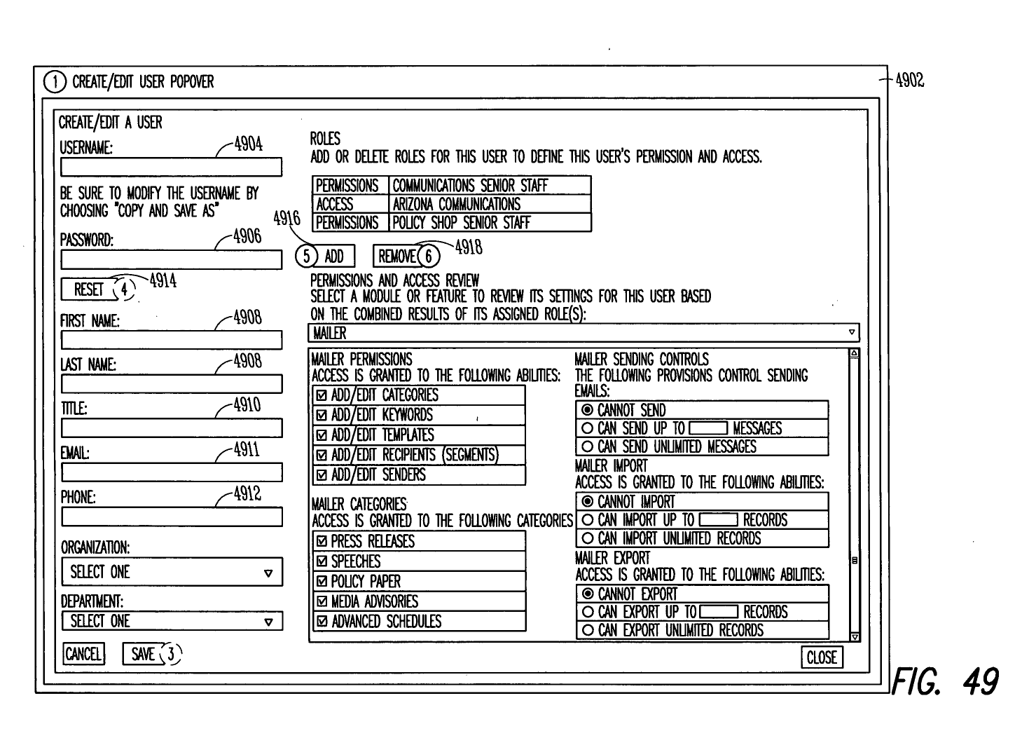

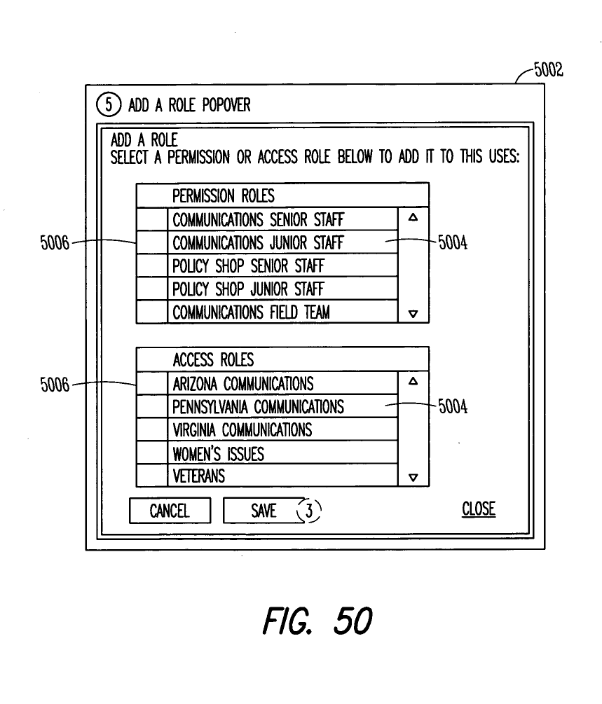

Upon selection of the create or edit buttons 4812, 4816, a popover screen 4902 (see FIG. 49) is displayed for creating or editing user information. The create/edit user screen 4902 includes the user login name 4904, the user's password 4906, as well as the user's first and last name 4908, title 4910 and contact information including e-mail address 4911 and telephone number 4912. A reset button 4914 brings up a screen to reset the password for the user. Roles can be added or deleted using role change buttons 4916 and 4918. Activation of the add role button 4916 brings up a popover window 5002 (see FIG. 50) in which the role permissions are displayed and selected for adding to the profile of the user. The popover window 5002 includes a list of the permission roles and access roles 5004 and check boxes 5006 for selecting permission or access as identified. A cancel button exits from the popover window. Add button adds the selected permissions and access roles to the profile of the user.

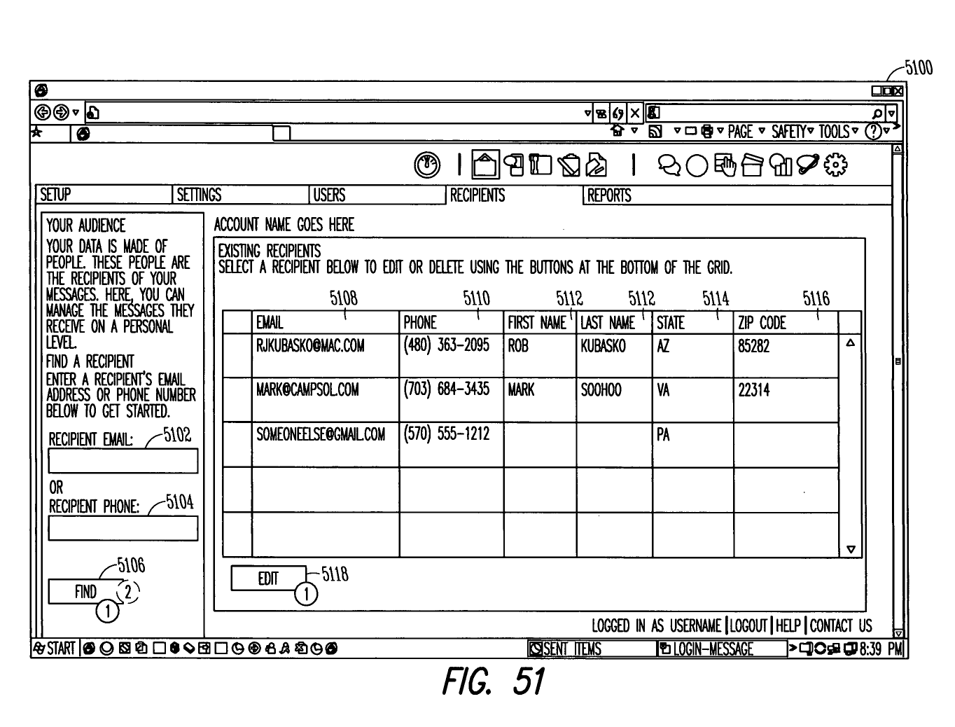

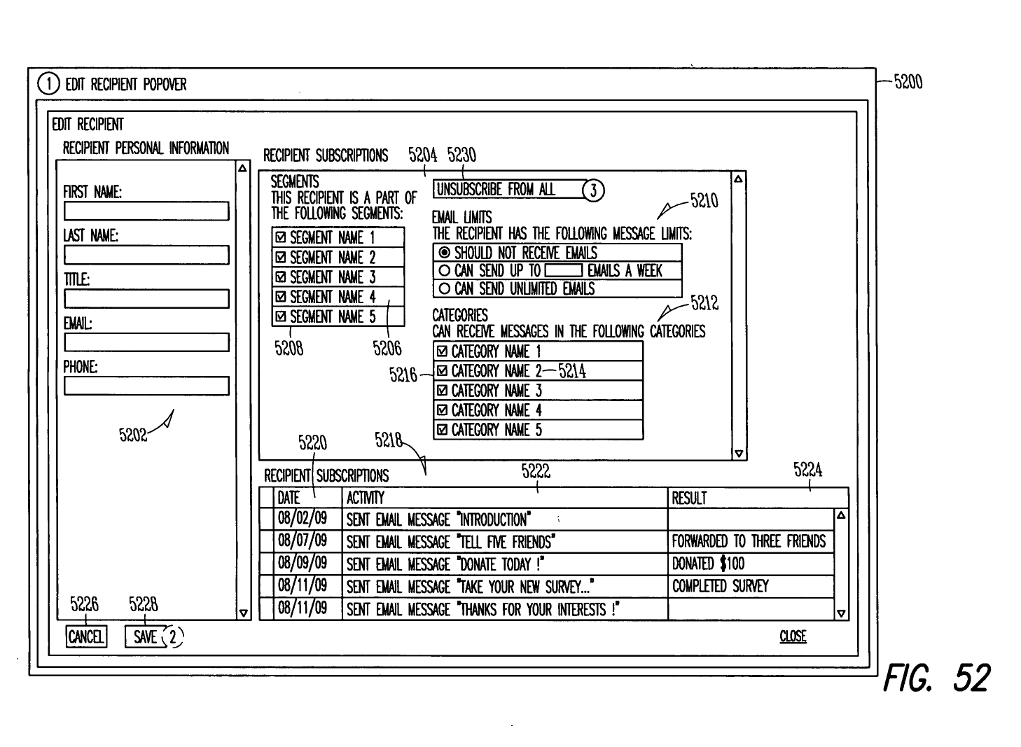

FIG. 51 illustrates a screen 5100 for identifying and managing the database 308 of recipients of messages. The screen 5100 includes a search feature to find a recipient by entering information in a recipient e-mail field 5102 or recipient phone number field 5104. A find button 5106 activates a search against the recipients database 308 of the client 108. The screen 5100 also displays information as to existing recipients in the data base. The information in the illustrated embodiment includes e-mail address 5108, phone number 5110, name information 5112, location 5114 and zip code 5116. Other demographic information can be included in the data base including age, street address, geographic location, affiliations, or other relevant information to which messages would be directed. The geographic location (latitude, longitude) enables use of the communications system with commercial mapping systems for displays and selecting of recipients 112 for receiving a message. Recipient source information is collected from a number of sources including list providers 120 (FIG. 1) as well as recipient contact information developed internally by the client or by accessing public information. An edit button 5118 leads to a popover screen 5200 to edit recipient information shown in FIG. 52.

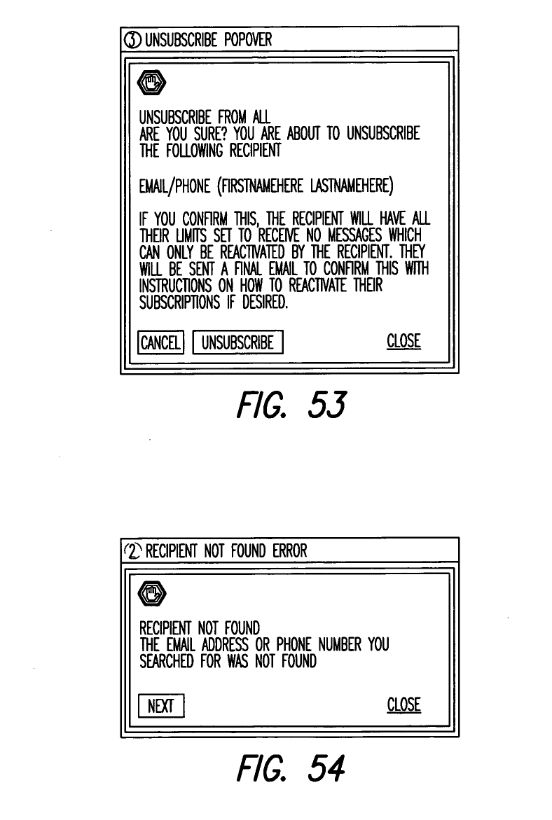

The edit recipient popover screen 5200 includes recipient personal information generally 5202, including name, title, e-mail address, and phone number. The recipient subscription field 5204 enables the client to select the recipient to receive particular segment messages. The segment field 5204 includes the segment name 5206 and a check box 5208 for selecting the segments. An e-mail limit option 5210 enables restricting e-mails or limiting e-mails to a certain number per week or unlimited e-mails. A categories selection table 5212 includes category names 5214 and a check box 5216 by which particular categories can be selected for communicating to the recipient. A recipient activity log 5218 includes the date of message activity 5220, the activity description 5222, and the result 5224 of the messaging activity. A cancel button 5226 cancels from the edit recipient popover and returns control to the recipients screen 5100. A save button 5228 saves the edited recipient information to the data base and returns control to the screen 5100. A unsubscribe all button 5230 clears all of the subscriptions to the segments and categories. A screen is displayed to require verification of the unsubscription, as shown in FIG. 53. If a recipient 112 is not found, a display screen is shown as illustrated in FIG. 54. In an alternate embodiment, recipients 112 can manage subscriptions.

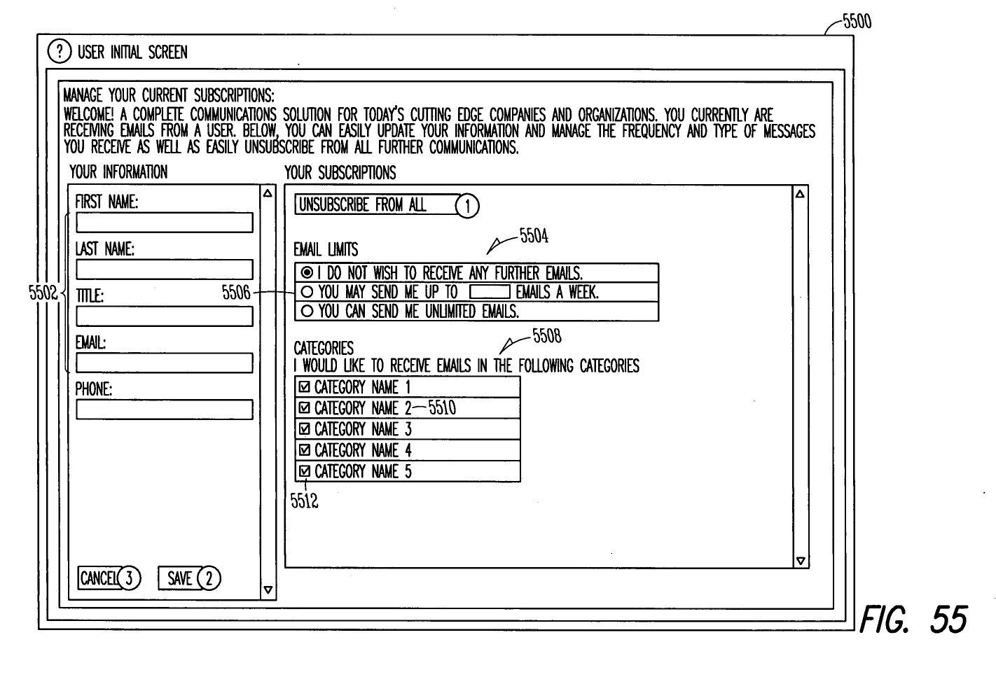

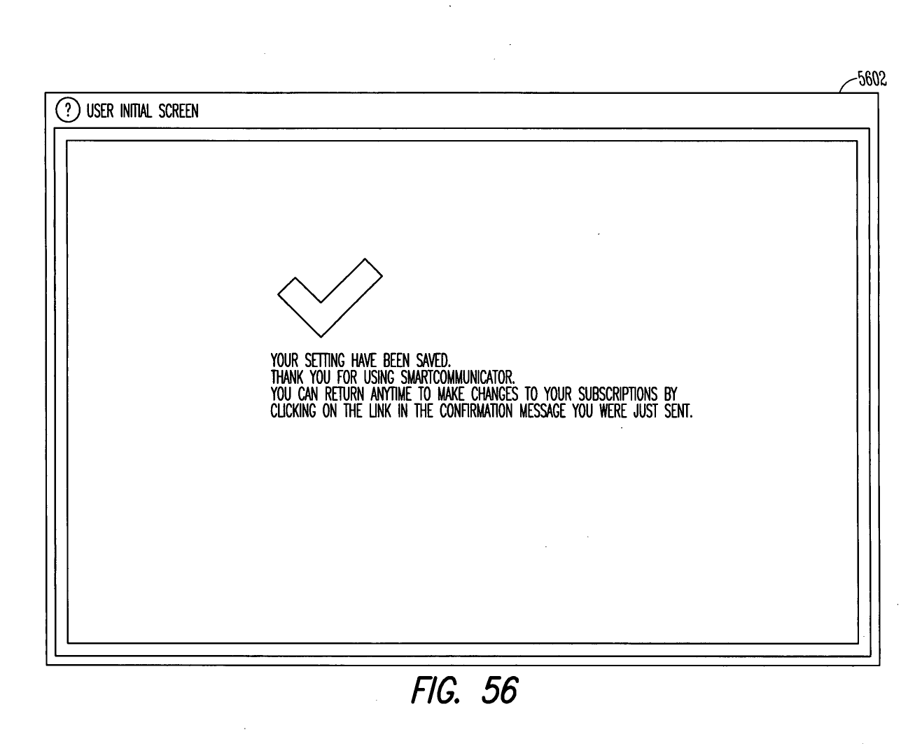

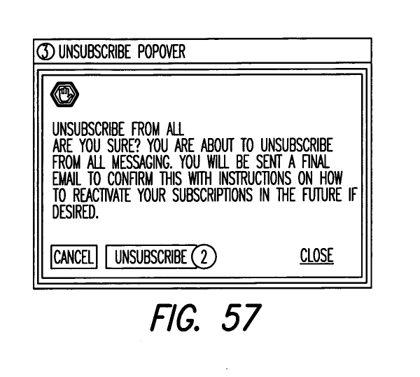

FIG. 55 illustrates a screen 5500 by which a recipient 112 can update contact information and manage the frequency and type of messages sent to the recipient as well as unsubscribe from future communications. The screen 5500 includes recipient information generally 5502, including name, title, e-mail and phone. The recipient can set e-mail limits generally 5504 to stop further e-mails, limit the e-mails to a certain number per week or send unlimited e-mails using a radio button 5506. Categories can be selected from the category table 5508 which includes the category name 5510 and a check box 5512 for selecting categories for future messages. FIG. 56 illustrates a popover screen 5602 advising the recipient that the selections have been entered to the communications system 104. FIG. 57 illustrates a verification popover requiring a confirmation by the recipient to execute an unsubscribe instruction to the communications system.

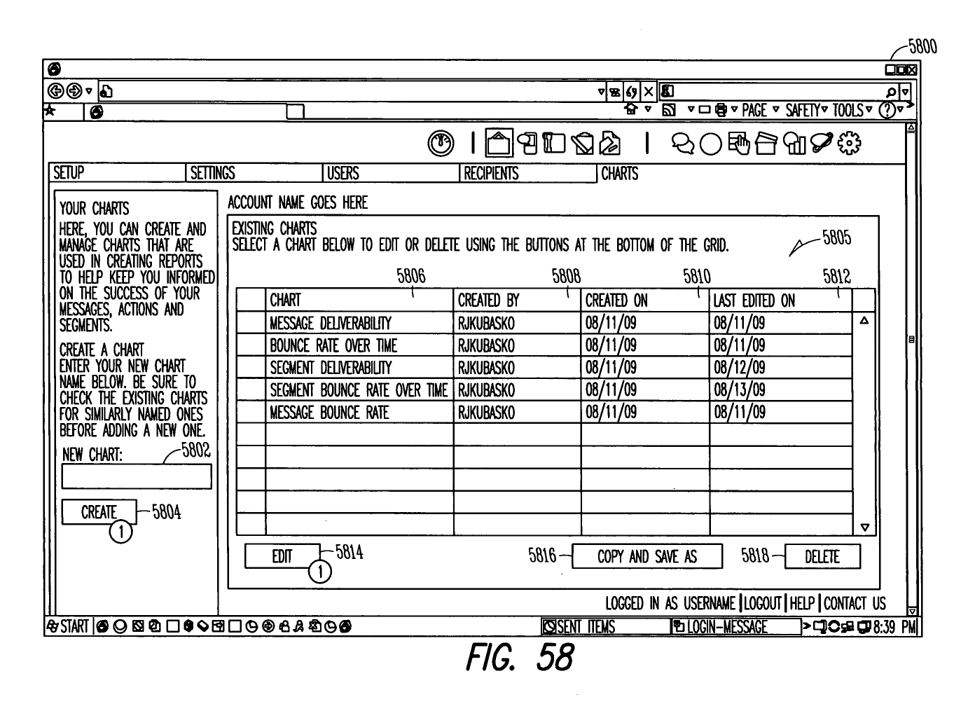

FIG. 58 illustrates a screen 5800 for the authorized user of the client 108 to create and manage charts and to create reports to keep the client 108 informed of the messaging activity, actions and segments. The screen 5800 includes a create chart field 5802 receiving the chart name and a create chart button 5804. The screen 5800 also displays information about existing charts generally 5805 including the chart name 5806, the author who created the chart 5808, the creation date 5810 and the edit date 5812.

Existing charts can be edited using the edit button 5814. This is accomplished by first positioning the curser on the chart to be edited to highlight the chart, and then selecting the edit button 5814. A new chart can be created by highlighting an existing chart and operating the copy and save button 5816. A delete 5818 deletes the selected chart.

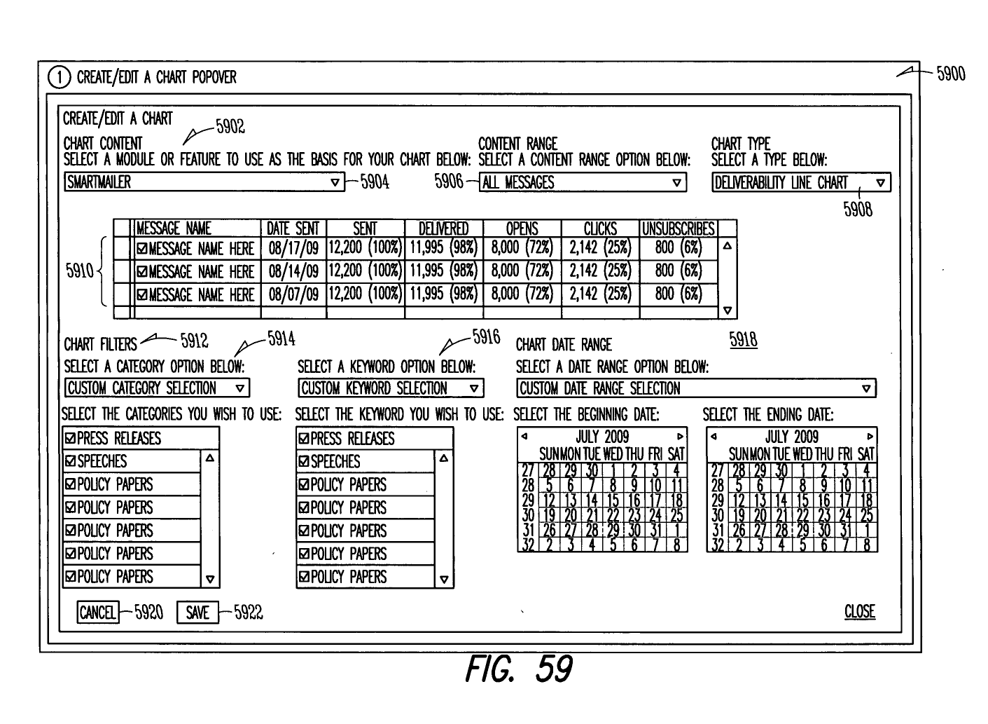

The create button 5804, the edit button 5814, and the copy and save button 5816 transfer control to a popover screen 5900 illustrated in FIG. 59 to create or edit a chart. The chart content 5902 is selected from a menu of modules 5904 as well as content range 5906 and the type of chart to be prepared 5908. Particular messages can be selected for including in the chart generally 5910 which displays the message name, date sent information, number of messages sent, delivered, opened, and clicked and resulting unsubscribe activity. A chart filters section 5912 provides options for selecting a category 5914 and keywords 5916. Both the category and keyword filters include tables with the category and keyword names as well as check boxes for selecting particular ones. A date range table 5918 provides for selecting a beginning date and ending date. The dates are selected by placing the curser on the particular date and pressing enter. A cancel button 5920 cancels the creation or editing of a chart and returns control to the screen 5800 (FIG. 58). A save button 5922 saves the created chart or the edited chart information.

### Message Mailing Module

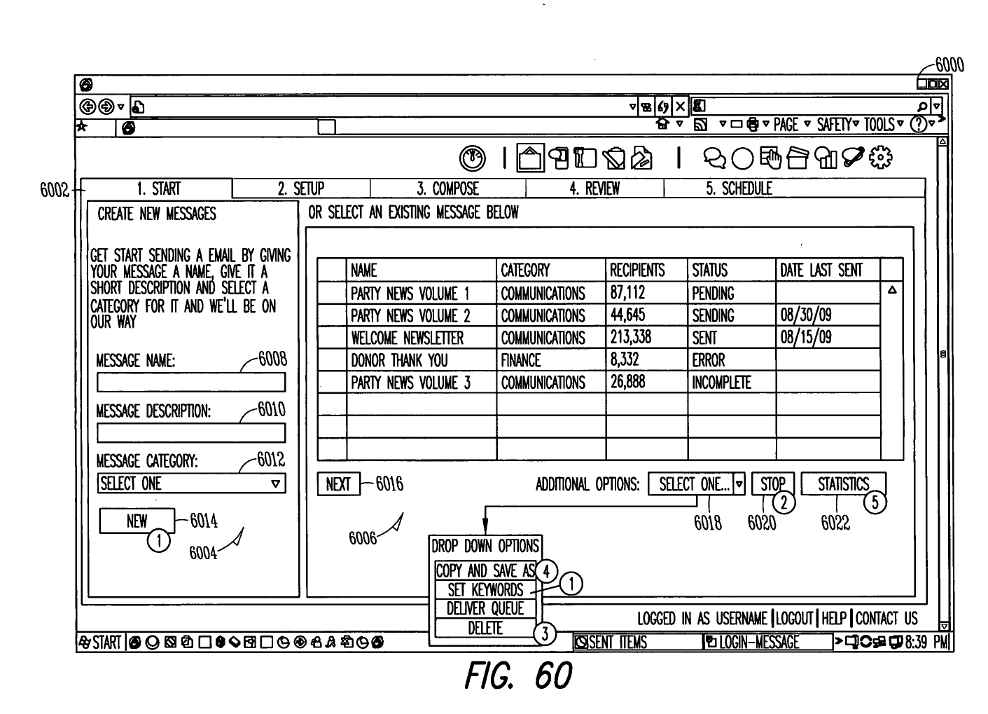

FIG. 60 illustrates a message mailing module screen 6000. The screen 6000 includes five tabs for creating, editing, and scheduling messages generally 6002. The tabs are “Start”, “Setup”, “Compose”, “Review” and “Subscribe”. The Start tab includes a new panel 6004 to create new messages and an existing panel 6006 to select an existing message for editing or scheduling. The new message panel 6004 includes a message name field 6008, a description 6010 of the message and a message category selected from a dropdown menu 6012. A new button 6014 transfers control to creating a new message, as discussed below.

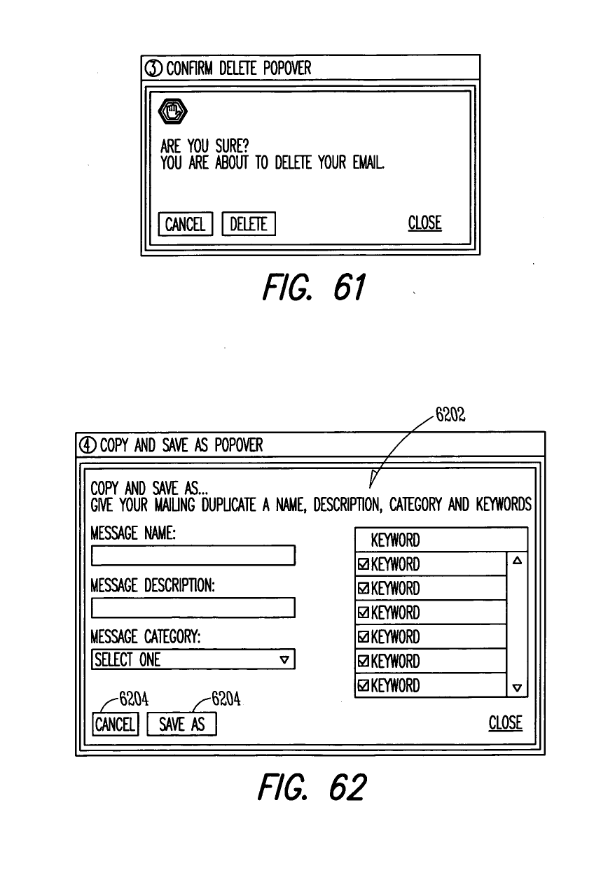

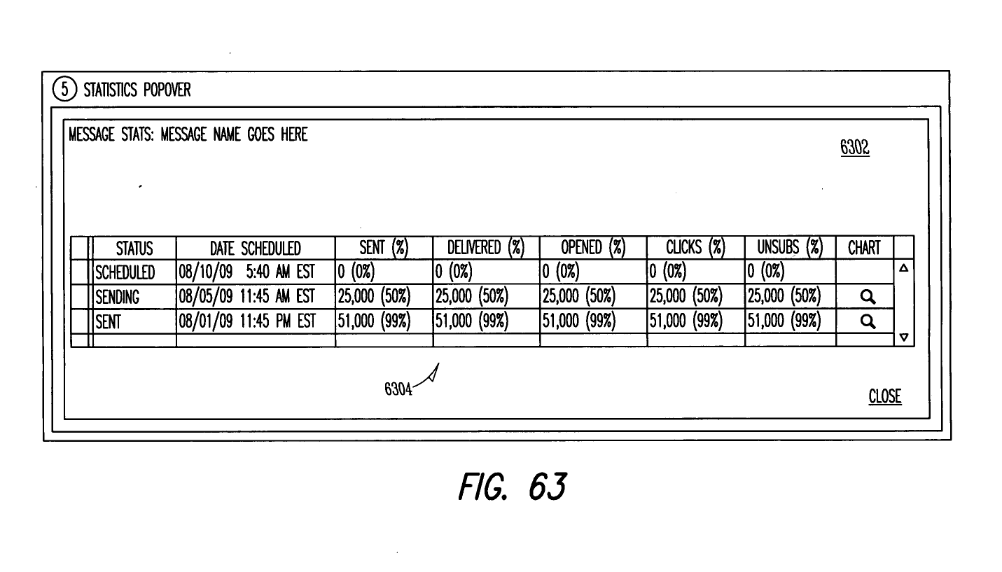

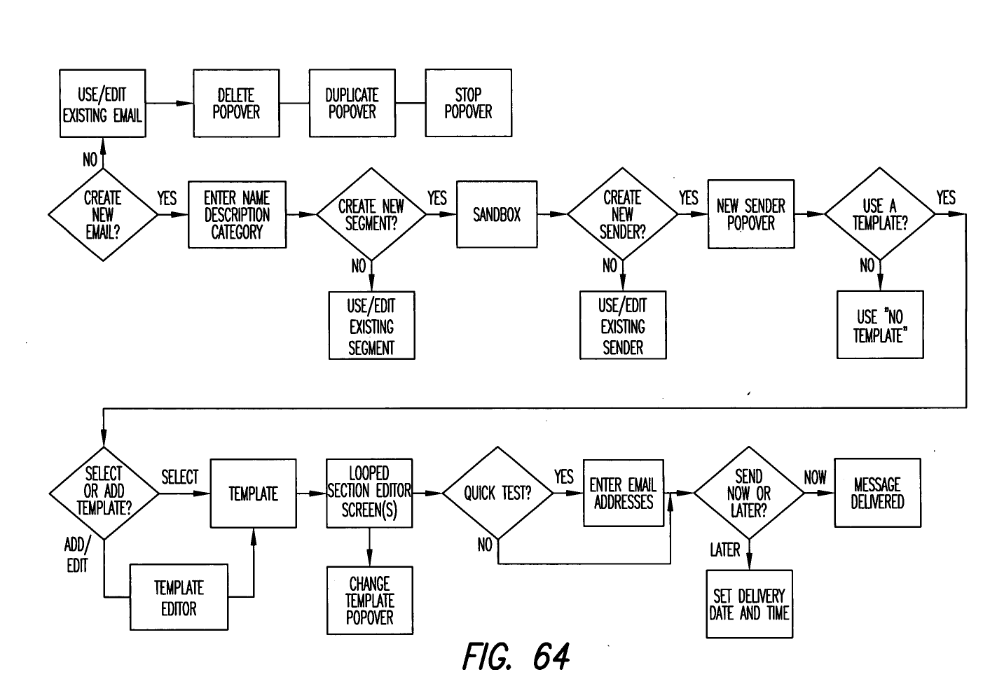

An existing message can be selected from the existing message panel 6006 for editing 6016 or additional options in a dropdown menu 6018 including copy and save, set keywords to associate with the existing message, delivery queue, or delete. A message scheduled for communicating to recipients can be stopped with the stop button 6020. Message statistics can be selected with the statistics button 6022 for display of graph charts discussed above. Activation of the stop button 6020 will require confirmation to either permanently stop the mailing or pause the mailing and resume later. Deletion of a message requires affirmative confirmation through a popover screen illustrated in FIG. 61. The copy and save option displays a popover 6202 illustrated in FIG. 62 provided with fields through which the message name is given a new message name, a message description, a message category (selected from a dropdown menu of categories associated with the client 108), and keywords. The new copied message can be cancelled or saved 6204. The statistics button 6022 displays popover 6302 illustrated in FIG. 63 which provides message statistics generally 6304 including the status of the message, date scheduled, percent sent, delivered, opened, clicked, unsubscribed percentage, and whether the message is subject of a chart. Referring to FIG. 64, a flowchart is depicted which illustrates navigation of the message mailing module of the host computer 102. The portions of the operation of the routine that are depicted in FIGS. 60 to 63 are darkened in FIG. 64.

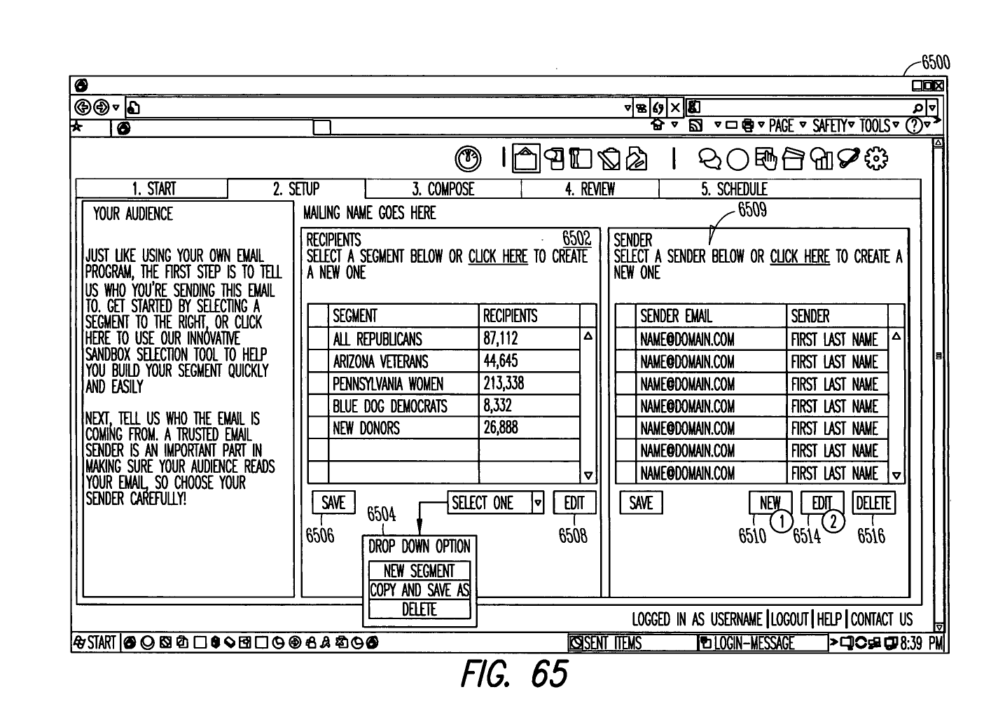

FIG. 65 illustrates a setup screen 6500 for identifying the audience or segment to which a message is to be sent. The screen includes a recipient table 6502 showing the name of the segments of the database 308 of recipients 112 as well as the number of recipients included in the segment. With a drop-down menu 6504, commands are provided for creating a new segment, copy and save a new segment, or delete a selected segment. The selected segments can be saved 6506 or edited 6508.

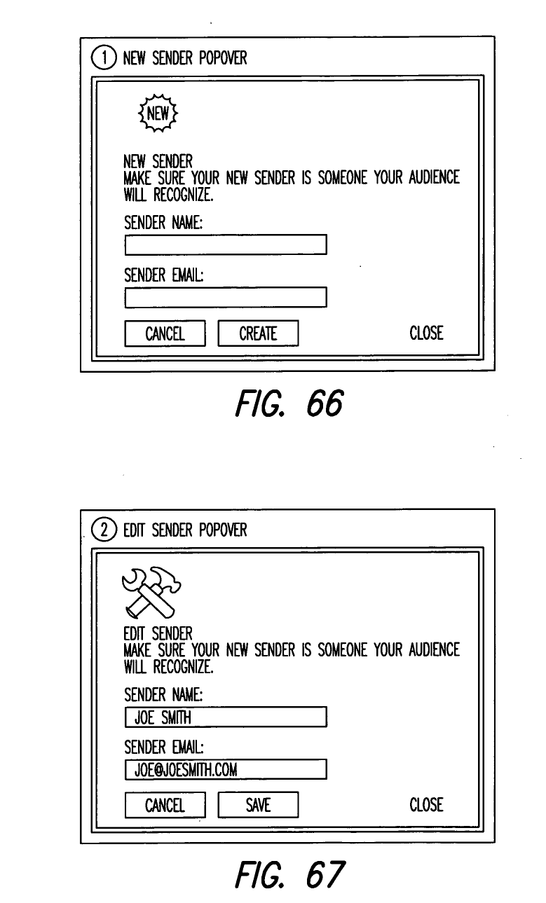

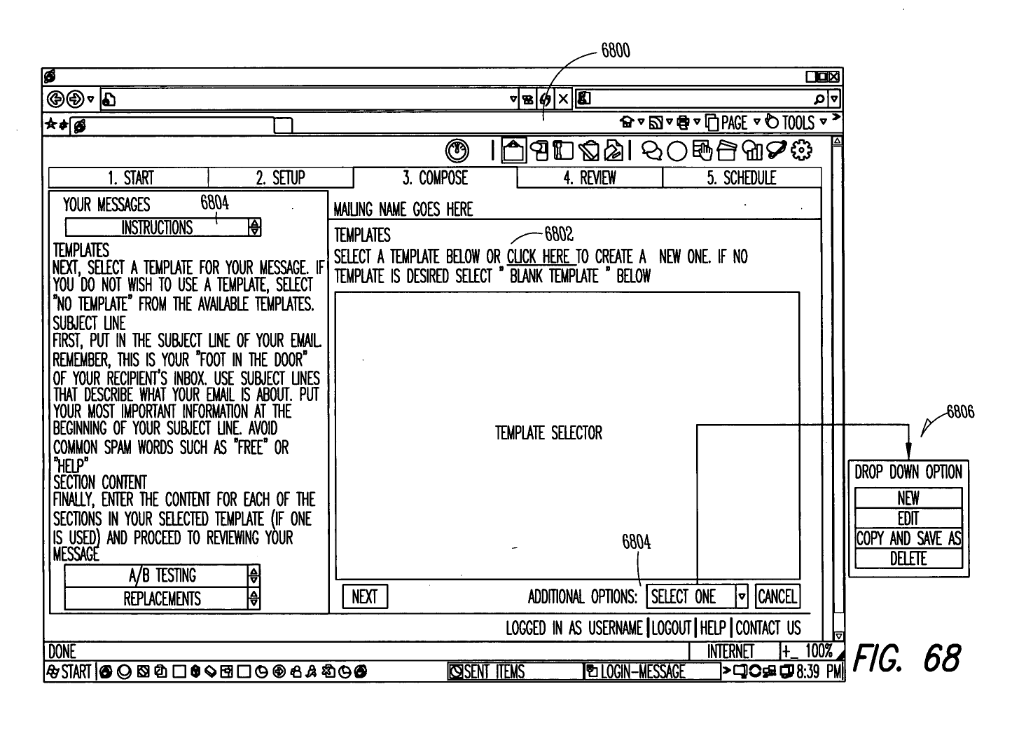

The message can also be associated with a particular sender name selected from a sender table 6509. A new sender name can be created 6510. FIG. 66 illustrates a popover for creating a new sender name with fields for the sender e-mail address and the name of the sender. The selected sender can be saved in association with the message. A new sender can be created 6510 or an existing sender edited 6514 (via popover screen illustrated in FIG. 67) or deleted 6516.

FIG. 68 illustrates a message template screen 6800 for composing a new message to be sent. The message can be based on an existing template displayed on the screen 6800 or creating a new template 6802. A button 6804 provides access to template creation and editing instructions. A dropdown menu 6806 provides for creating a new template, editing an existing template, copying and saving an existing template as a new template or deleting the template.

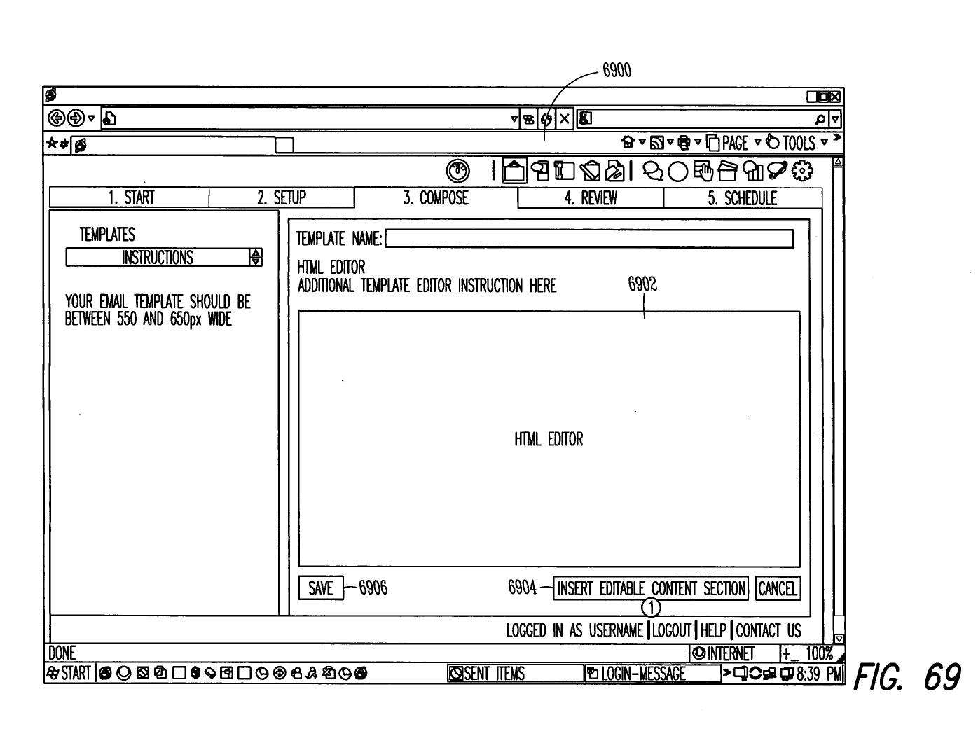

FIG. 69 illustrates a screen 6900 for editing the template in which content can be added to the message using an editor 6902. A button 6904 provides for inserting editable content such as from an existing document file accessible from the client's local computer. A save button 6906 saves the edited content.

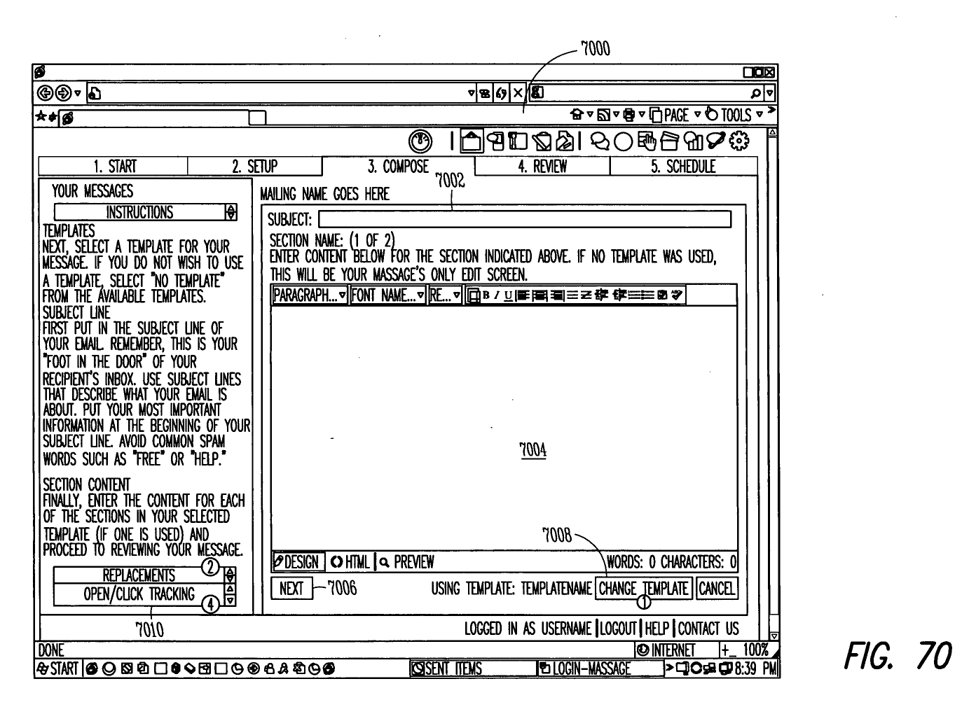

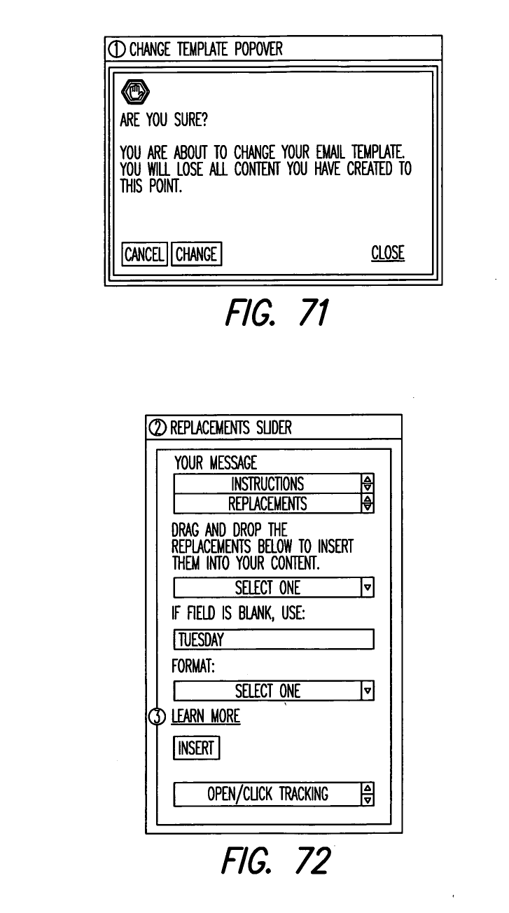

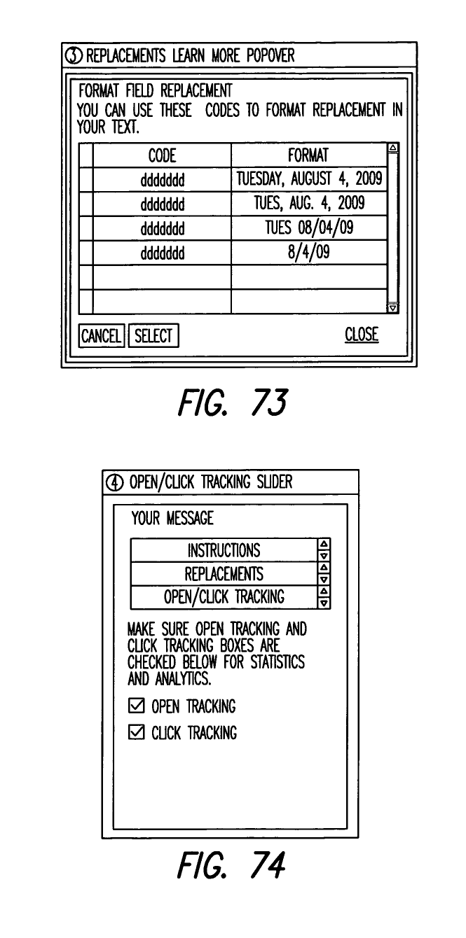

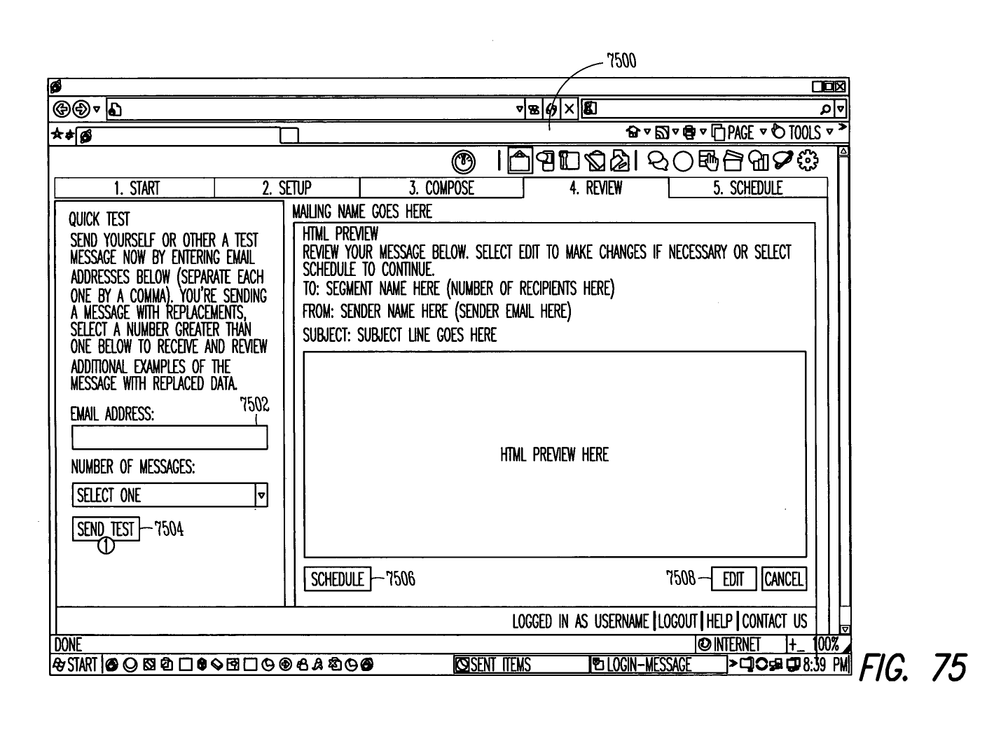

FIG. 70 illustrates a screen 7000 for editing a section of the message. The message includes a subject name field 7002. A section field 7004 permits text entry of content using conventional word processing. The next button 7006 transfers control to a similar screen for entering information in additional sections of the message. The change template button 7008 is operated to save the edited template for the new message. The selection button 7010 provides for activating the open and click tracking feature for the message. FIG. 71 illustrates a popover screen image for the user to verify that the template is to be changed as edited. FIG. 72 illustrates a screen for selecting replacement content for the template, including a selection menu 7202, a field 7204 for entry of replacement information with a format menu 7206 (for example, how a date is to be displayed), and an insert button 7208. FIG. 73 illustrates a “learn more” popover displayed to provide information to the user as to how replacement fields in the template are formatted, including a format code and a display of the associated format. FIG. 74 illustrates a popover screen accessed from the button 7010 for activating open and click tracking features for the message.

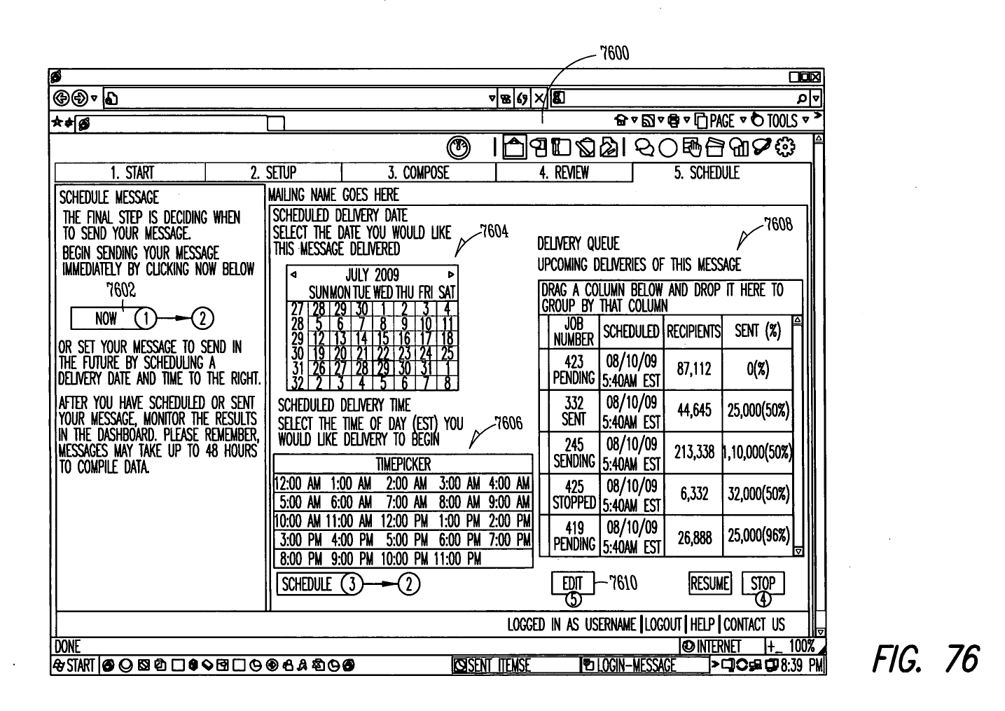

FIG. 75 illustrates a review screen 7500 that provides an HTML preview of the message. In addition, an e-mail address field 7502 can be used for sending a test of the message using the send test button 7504. A number of messages can be selected. This gives the message sender an opportunity to view how a recipient would receive the message. The schedule button 7506 transfers control to the screen 7600 shown in FIG. 76 for scheduling delivery of the message. An edit button 7508 transfers control back to message editing screen 7000 shown in FIG. 70.

FIG. 76 illustrates the scheduling screen 7600 for scheduling communication of a message. The now button 7602 transmits the message immediately. Alternatively, the delivery can be scheduled using the calendar 7604 and the delivery time table 7606. The curser is positioned on the particular date and time for transmission of the message. A deliver queue 7608 displays scheduled deliveries of the message. The queue can be edited 7610 using a popover to edit the message delivery including stopping the particular delivery, future deliveries, and deliveries on a particular date or deliveries after a particular number of deliveries. The delivery can be resent to the same recipients, to recipients who didn't open or to recipients who did not further open or click on aspects of the message. The date and time of the message delivery can also be edited.

### Developing Segments of Recipients for Messages

The present invention provides an apparatus and method for communicating messages to recipients. As discussed above, the broadcast messaging and feedback communications system 100 provides for authorized users to create messages, to select delivery modes and delivery times, and to analyze the communication of the message and its effectiveness. The messages communicate from the client 108 to recipients 112. Information about the recipients is maintained by each client 108 separately in the database 308. A recipient for one client thus may also, but not necessarily be a recipient for another client 108. The communication system 104 provides a mechanism to select groupings (segments) of the database of recipients to receive messages. The communications system 104 provides for graphical interactive creation and managing of segments which are groupings of the recipients selected and organized to specifically target the delivery of each message.

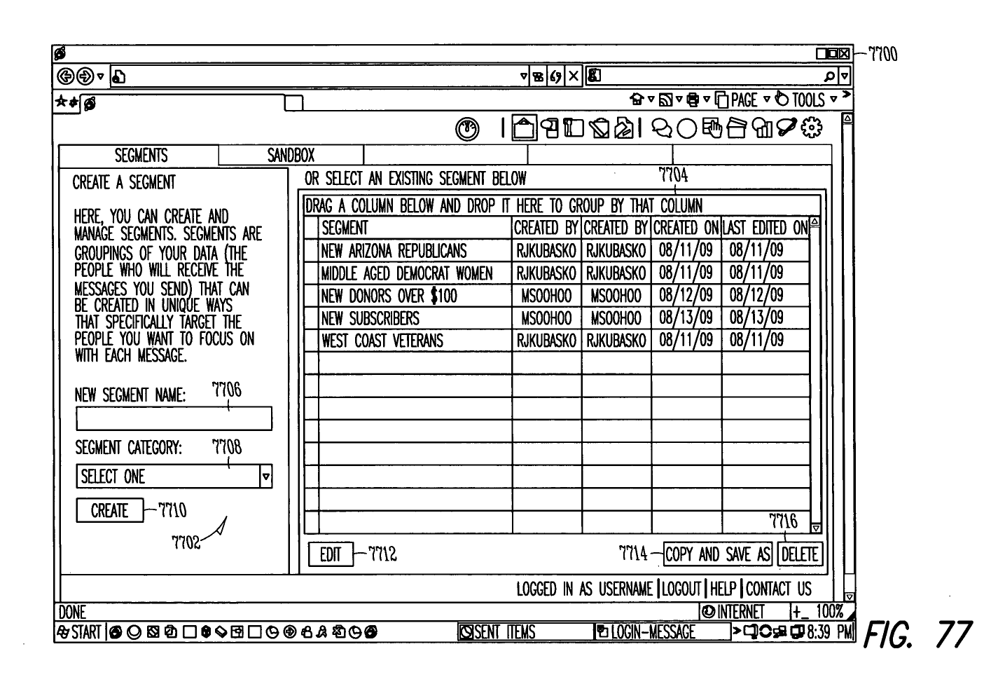

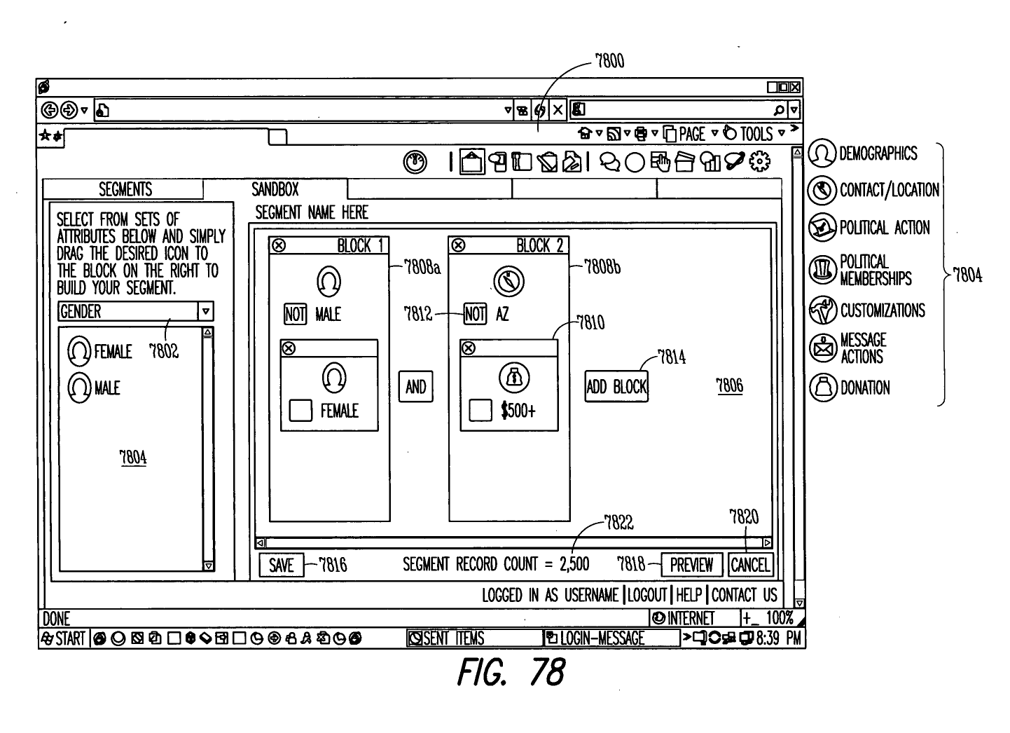

With reference to FIG. 77, segment screen 7700 provides for creating a segment generally 7702 or selecting an existing segment 7704. The create-a-segment 7702 includes a new segment name field 7706 and a segment category selected from a dropdown menu 7708 of categories defined by the client. A create button 7710 transfers to an interactive segment creation screen discussed below with reference to FIG. 78. Existing segments can be displayed and edited 7712. An existing segment can also be copied and saved as a new segment using button 7714. A segment can be deleted 7716. The display 7700 of these segments includes the segment name, the author, its creation date, and last edit date.

FIG. 78 illustrates a segment defining screen 7800 for interactive assembly or characterization of a segment. The grouping screen 7800 features click and drag selection of attributes to be grouped together. The screen 7800 includes an attribute selection dropdown menu 7802 and a display window 7804 containing icons representative of data populations within that attribute. The attribute menu 7802 includes demographics, contact/location, political action membership, political memberships, customizations, message actions, donations, gender, age, academic backgrounds, and other demographic characterizations of the persons for whom the client 108 possesses data. The grouping screen 7800 also includes a field 7806 for positioning selected attributes in order to create a segment targeted for the message. The field 7806 provides a plurality of criteria blocks 7808.

FIG. 78 provides an illustrative embodiment with a segment characterization having two criteria blocks 7808a and 7808b. Each block includes icons 7810 that reflect the selected criteria. Also the criteria can include Boolean logic indicated in a limiter field 7812. In the illustrated example, the criteria in block one are “not male but female”. Block two excludes persons in the state of Arizona and requires income over a threshold level. An add block 7814 tells the communications system 104 to include another criteria. The screen 7800 also displays a count of the number of persons meeting the particular segment criteria established by at least one block of criteria. This provides a running total for observing the number of messages that will be sent based on the selected criteria for the segment. The save button 7816 saves the created segment. A preview button 7818 provides a display of information about persons included within the segment as defined by the criteria blocks 7808. A cancel button 7820 cancels the segment.

The screen 7800 is also used to edit a selected segment upon activation of the add button 7712 or the copy and save button 7714 shown in FIG. 77. In such event, the screen 7800 will be displayed populated with the criteria for that particular existing segment.

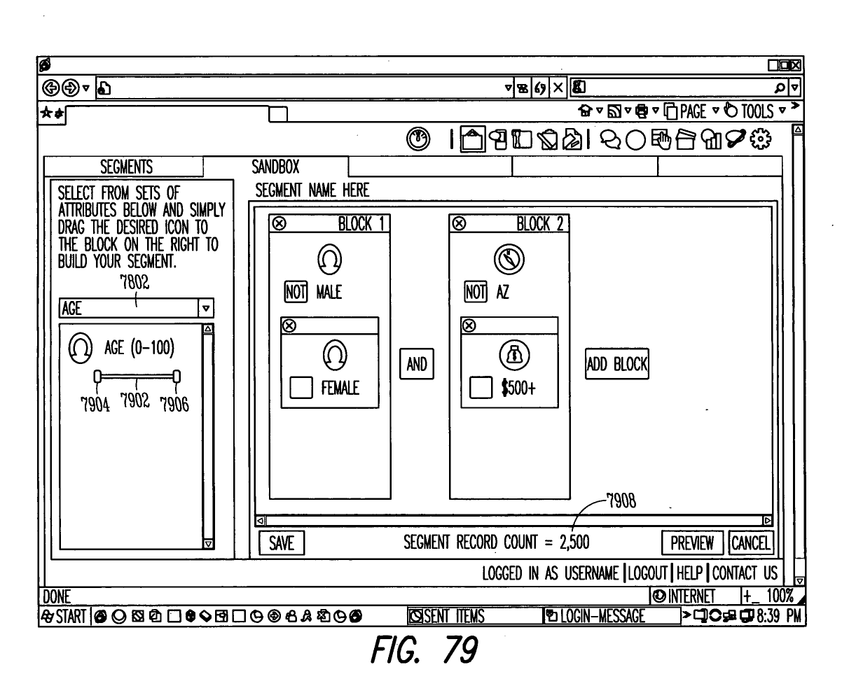

As shown in FIG. 79, some criteria have a range from which selections may be made. For example, the demographic “age” has a range bar 7902 with moveable end points 7904, 7906. The moveable end points 7904, 7906 move laterally toward each other by use of the curser click and drag feature. Moving the end points changes the range of ages to be included in the criteria block for selecting persons to be in a particular segment for messaging. The screen displays 7908 the number of recipients satisfying the criteria.

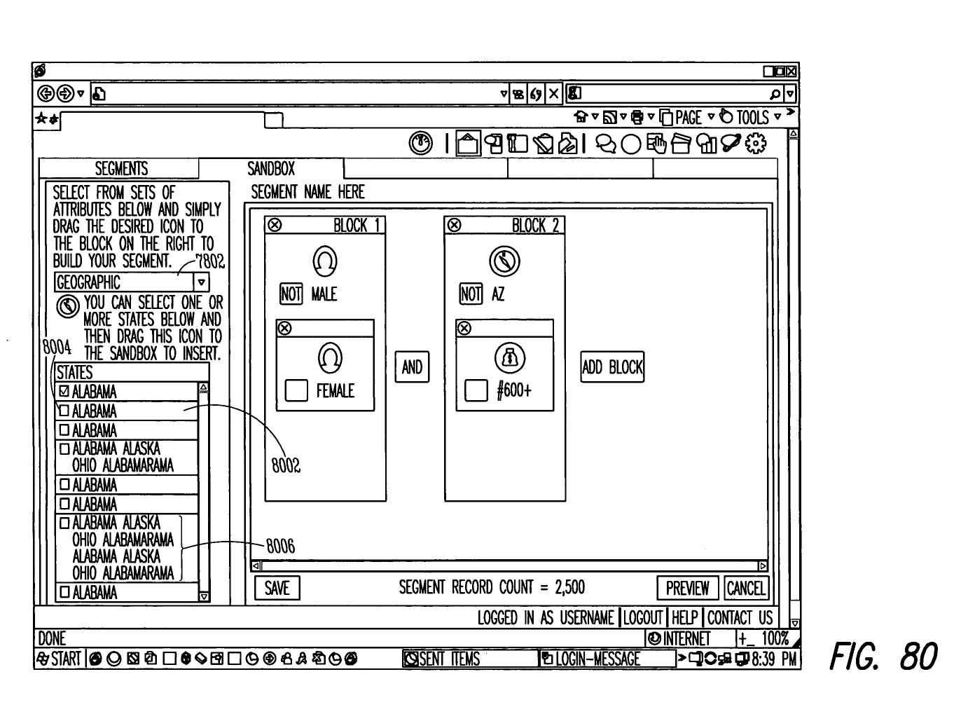

FIG. 80 illustrates a geographic criteria selected in the attribute field 7802. In this example, the states are listed 8002 together with a check box 8004 for selecting states or groups of states. In the illustrated embodiment, collections of states have been grouped together, for example, the collection 8006.

### Operation of the Communications System

With reference to FIG. 1, the present invention provides a messaging communications system 100 providing multiple media communication modes, contact devices 114 generally, for sending messages to recipients 112 and analyzing the recipients 112. The client 108 accesses the communication system 104 through the network 106. The communications system 104 checks the local computer of the client 108 to determine proper software configuration. The illustrated embodiment operates with SILVERLIGHT software.

After loading, the login screen 600 is displayed as shown in FIG. 6. The new client 108 enters the sign-up button 612 to open a new account. This directs the client 108 to the management module 224. With reference to FIG. 19, the client 108 uses the set-up screen 1902 and account information button 1906 to display the panel for entering client contact information 1912 and billing information 1940. After the information is entered in the suitable fields, the save button 1932 or 1958 saves the information to the communication system 104. The client 108 then selects the modules 1908 shown in FIG. 21. The standard modules and services are listed 2104 with check box 2108 for entry by the client. The module and service options are selected. For example, the mailer module provides for unlimited e-mail messages or limited e-mail messages 2120. After selecting the modules, services and action modules, the user saves the information. The client then selects interface features and designs including logo 2306 and colors 2324, 2326, which are applied 2328 or the system default colors 2330 are used. The information is saved 2318, 2332 to the communication system.

With reference to FIG. 24, the client 108 then establishes categories by entering category names in the category field 2414 and creating the category using the create button 2416. As categories are created, they are displayed in the categories panel, including the category and its author and creation date 2422, 2444.

With reference to FIG. 29, the client 108 also creates keywords that define characteristics about a message or action. The new keyword is entered in the keyword field 2916 and created using create button 2918. As keywords are created, the keywords are added to the panel showing existing keywords, including the keyword 2908 and author and creation information 2910, 2912, 2914.

With reference to FIG. 33, the client 108 also establishes permission roles to define limits on modules and features that users can access. The new permission role field is completed 3314 and the create button 3316 operated. As new permission roles are created, they are displayed on the panel that includes the permission role 3306 and the author and creation date information 3308, 3310. The create button 3316 transfers control to a popover screen 3402 in which the permissions and categories are selected using the tables on the screen 3402. Appropriate check boxes and radio buttons are selected in order to select the permissions for the particular permission role 440. The selected permissions are then saved. This returns control to the screen 3302 for adding additional permission roles.

With reference to FIG. 38, the access roles screen 3802 is displayed. New access roles are created to define limits on data that users have access to. The name of the access role is entered in the access role field 3820 and the create button 3812 executed. This brings up a create access role popover screen 3902. Attributes are selected from the attribute list 3906 and dragged to a block 3904 to define an access role to the recipient database 308. In the illustrated embodiment, an access role is created for persons who are females in the database 66.

The communications system 104 is directed towards communicating messages to recipients 112. One form of message is an e-mail message sent to recipients e-mail addresses. While new messages could be created, the system provides for creating and storing templates from which messages can be created. With reference to FIG. 43, the new template name is entered in the field 4316 and the type of template is selected 4318. For example, a template may be an e-mail template, a letter template, or a template for another type of printed documents. The create button 4320 saves the template name. As template names are created, the panel on the screen 4300 displays existing templates including the template name 4302, type of template 4304, and the author and creation date information 4306, 4308. Subsequently, the particular templates can be accessed in the messaging module to build the template defined by the template name.

Departments are created using the screen shown in FIG. 44 through the department create button 4418.

FIG. 48 illustrates the user identification tab of the setup management module for adding user login names for particular individuals in the client 108. The create button 4812 brings up a popover screen 4902 to create or edit a user name 4904. The password 4906 is entered. The name, title, and contact information such as e-mail address 4911 and phone 4912 is entered. The roles 4916 are added for the user to define the user's permissions and access to the communications system 104. The add button 4916 brings up a popover screen 5002 to add roles 5004 for permissions and access by selecting in the check boxes 5006. Selected permissions and access roles are added. This closes the screen 5002 and returns control to screen 4902. Saving the information enters the user information to the communication system and returns control to the user page 4802.

FIG. 51 illustrates the database 308 information about recipients 112. Recipients can be added or information edited using the display panel showing recipient names and contact information. The edit button 5118 operates the popover screen 5200 shown in FIG. 52 for subscribing a recipient to particular segments, messages, and categories.

As shown in FIG. 55, recipients 112 can access and manage subscriptions. Radio buttons allow selecting email limits and categories. The recipients 112 access the communications system 104 through a network connection from the recipient's computer.

The client 108 can selectively arrange charts and reports of messages using the screen 5800 illustrated in FIG. 58. The charts are selectively viewed in the messages analysis screens illustrated in FIGS. 11 to 17. Chart content and features are selected in the popover screen 5900 illustrated in FIG. 59, including modules 5904, content range 5906 and the type of chart to be prepared 5908. Particular messages are selected 5910 using the check box. Filters focus the messages based on category 5914 and keyword 5916 selected by an entry to an associated check box and date range 5918. The dates are selected by placing the curser on the particular date and pressing enter.

Messages to be delivered are created and edited in the messages module with screens illustrated in FIGS. 60 to 68. After the message name is created, keywords are associated with the message in accordance with FIG. 60. The audience to which the message is directed is selected using screen 6500 illustrated in FIG. 65. The recipients are selected based on segment names 6502. The particular sender name is selected 6504. It has been observed that performance of messages (i.e., message opened or not, or additional clicks if the message is opened) differs based on the sender name. With reference to FIGS. 68 to 76, the message content is constructed using a template. The template is selected and a subject line entered. Sections of the message are edited. FIG. 69 illustrates an HTML editor for inserting content into the template of the message under construction. The section edit screen 7000 illustrated in FIG. 70 permits word processing text editing. Additional sections can be created for the message and edited. The constructed message in the template can be viewed using preview screen 7500 illustrated in FIG. 75. The message can be further edited by returning to the edit screen 7000.

Once a message is final, the transmission of the message is scheduled using the schedule screen 7600 illustrated in FIG. 76. Delivery can be selected for a particular date 7604 and time 7606. The schedule of message deliveries is displayed in the queue 7608. Existing delivery schedules can be edited 7610 which links to an edit delivery queue popover.

On the scheduled date and time, the messages are communicated by the communications system 104 to the recipients 112 grouped in the segment(s) selected for the message. The messages are communicated in a selected manner (email is shown in the illustrative embodiment). But other delivery devices are available selectively including telephone, cell phone, print and delivery by mail services or delivery services.

With reference to FIGS. 11-18, message performance can be evaluated in graphic charts or printed reports. The calendar panel 1114b illustrated in FIG. 11 displays message headers 1124 on dates of message delivery or scheduled delivery. The header 1124 includes the message name. Performance of selected messages is reported in graphic charts shown on report screen 1202 of the Messages tab. The chart shows the messages sent, opened, bounced (for example, an invalid email address), and unsubscribed after receipt of the message. Using the zoom button 1206 on each chart, a chart can be selected for enlarged display on the computer screen of the user. Alternatively, a table of messages and performance can be displayed as shown in FIG. 13. Historical opening of the message can be observed on screen 1502 illustrated in FIG. 15.

Segments can be analyzed as shown in FIG. 16, including the number of recipients in the segment over time, the number of unsubscribes, and spam complaints. Zoomed, or enlarged charts, can be selected as shown in FIG. 18, as well as a table chart shown in FIG. 17.

A financial module interacts with the recipients for receiving contributions to the client 108, for example, a charitable civic organization. The financial module is configured for receiving payments such as by check or credit card, including security validation and receipt.

### Telephone Delivery of Messages

The communications system 104 selectively provides a telephone bank for personal or automatic delivery of messages to recipients. The telephone bank provides a central location having a plurality of phones and messaging personnel with computer display screens connected to the host computer 102 operating the communications system 104. The communications system 104 sends recipient information (name, address, and/or demographic information) to message personnel. The message to be delivered is also provided to the message personnel, for example, by display on the computer screen or a printed copy of the message. The automatic dialer of the telephone bank places the call to the recipient. Upon answering, the message personnel deliver the message. Response information is recorded (answers, declines to receive message, prefers message delivered at a different time, message delivered in a different mode, and other messaging information.) Such information assists in developing meaningful segments and messages.

Automatic telephone survey can also be selected. In this aspect, the communications system 104 communicates the message and is configured for receiving a response from the recipient who selectively enters a response by pushing a selected key on the telephone pad.

In one aspect of the present invention, a string series of messages can be scheduled. The string includes a plurality of coordinated messages for a segment. The messages include an event announcement message, a signup message, and at least one reminder message. The event announcement message provides the recipient 112 with information about a planned event including for example, the purpose of the event, the sponsor, the location, and the time. The event announcement message may selectively include a response feature for the recipient to indicate willingness to attend the event. A signup message in the string is subsequently sent to recipients who indicated uncertainty or declined to respond as to attendance. For recipients who respond favorably, the communications system 104 schedules at least one reminder message for delivery the day before the event. In an alternate embodiment, a second reminder is scheduled for the day of the event. The string messaging of the present invention provides coordinated and tracked messaging to recipients in a segment group. The communications system 53 tracks the responses and schedules subsequent messages (signup messaging and reminder messaging). Performance of the messaging and responses can similarly be evaluated using the features of the communication system 104.

### Example of Developing Segments of Recipients for Messages

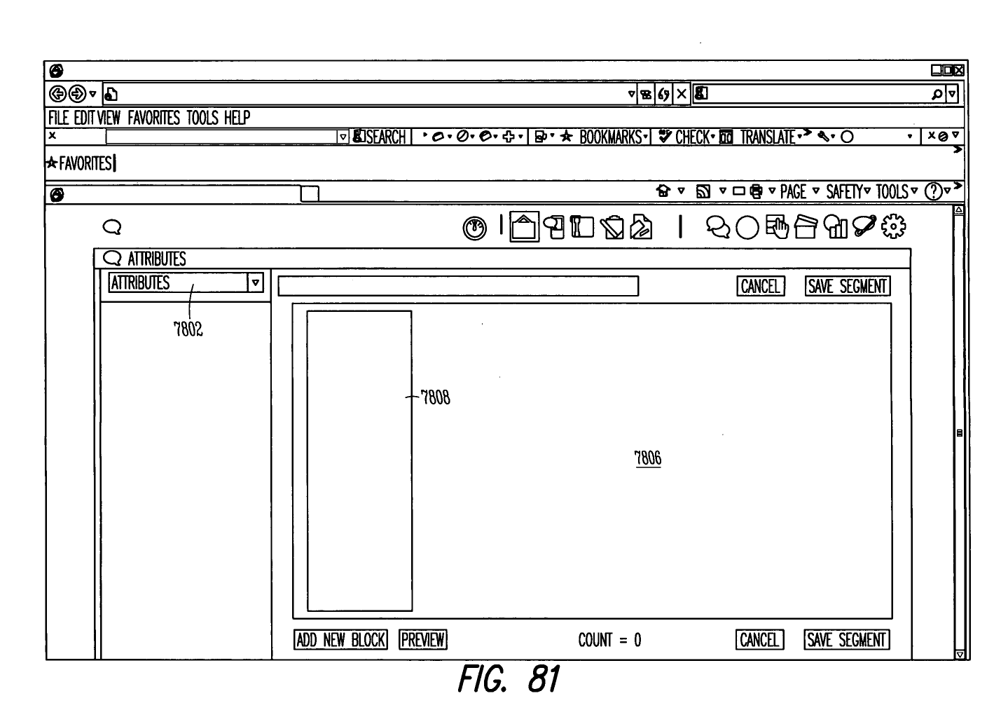

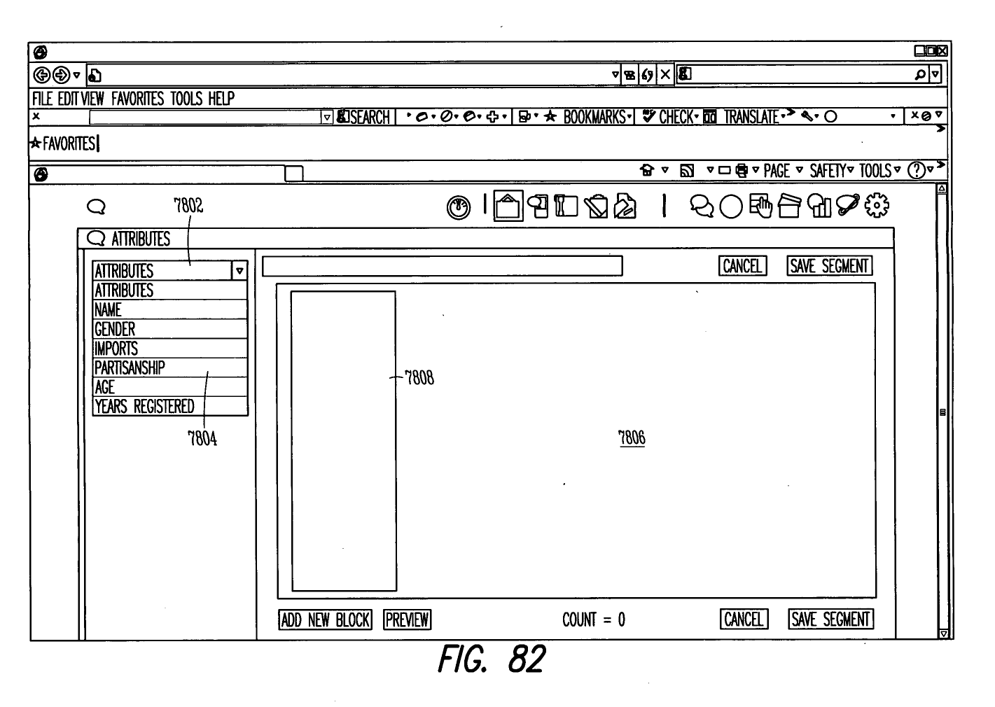

An example of constructing criteria for segments of recipients for messages is discussed herein with reference to FIGS. 77 to 88. Operation of the create button 7710 transfers to the segment defining screen 7800 for interactive assembly or characterization of a segment of recipients in the database 308. As shown in FIG. 81, the user selects an attribute from the attribute selection dropdown menu 7802. The display window 7804 presents icons representative of data populations within that attribute. The attribute menu 7802 includes demographics, contact/location, political action membership, political memberships, customizations, message actions, donations, gender, age, academic backgrounds, and other demographic characterizations of the person for whom the client device 108 possesses data. The grouping screen 7800 also includes a field 7806 for positioning selected attributes in order to create a segment targeted for the message. The field 7806 provides a plurality of criteria blocks 7808.

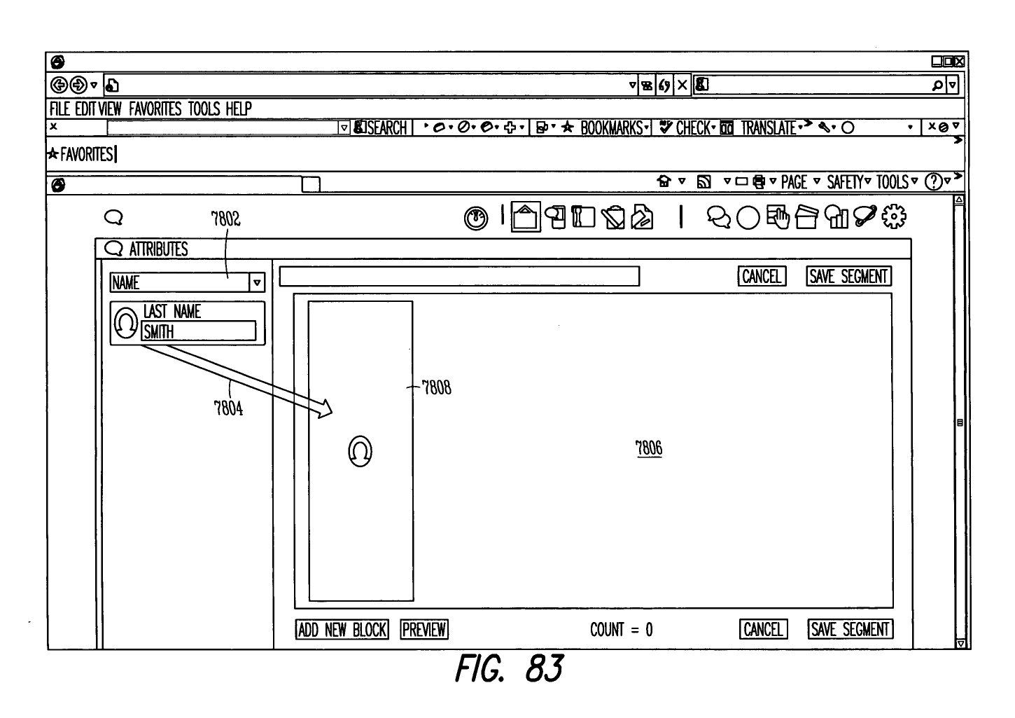

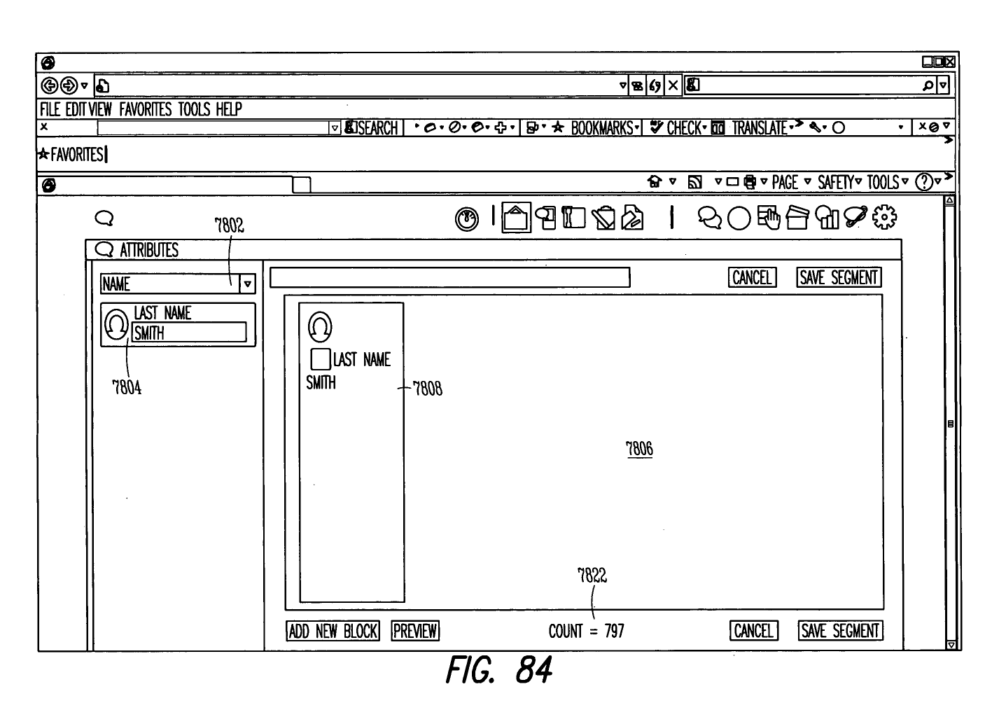

FIG. 82 illustrates an exemplary embodiment of the attribute selection dropdown menu 7802 for selecting an attribute for segment criteria. With reference to FIG. 83, the user has selected the attribute “Last Name” and the name “Smith”. The attribute is dragged and dropped as illustrated by the arrow on the criteria box 7808 in the criteria field 7806. FIG. 84 illustrates the selected attribute “Smith” dropped on the criteria box 7808 with the population count 7822 displayed for the selected criteria under construction.

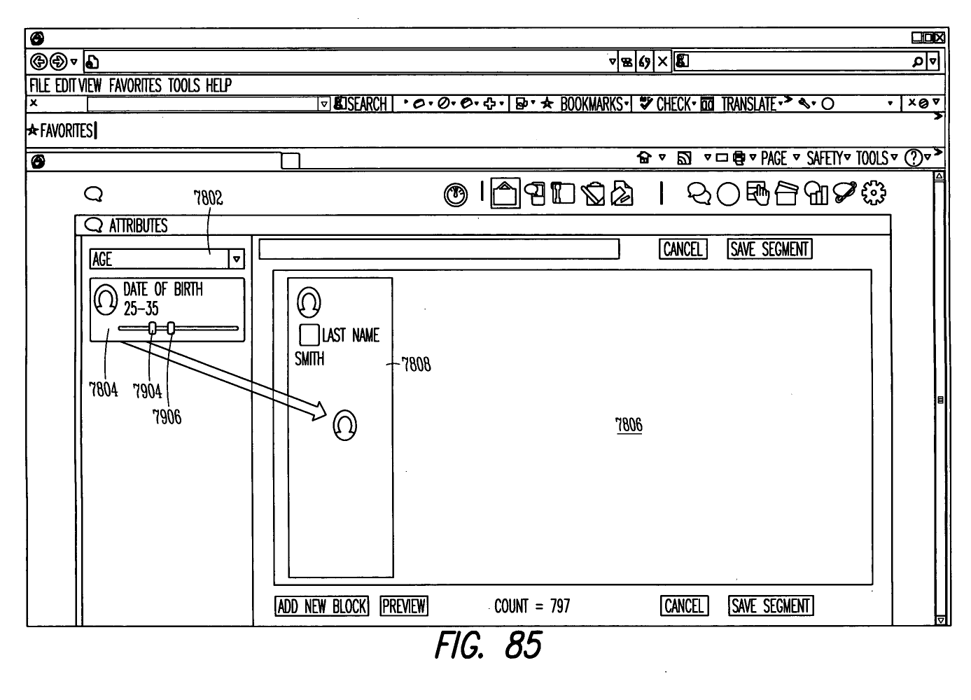

With reference to FIG. 85, the user has selected a second attribute “Age”. The range bar 7902 is operated to narrow the range of potential recipients 112 to be included. In the example, the range limits 7904 and 7906 are moved by mouse/cursor action to narrow the range to “25-35”. The attribute as narrowed is then dragged and dropped as illustrated by the arrow on the criteria box 7808 in the criteria field 7806.

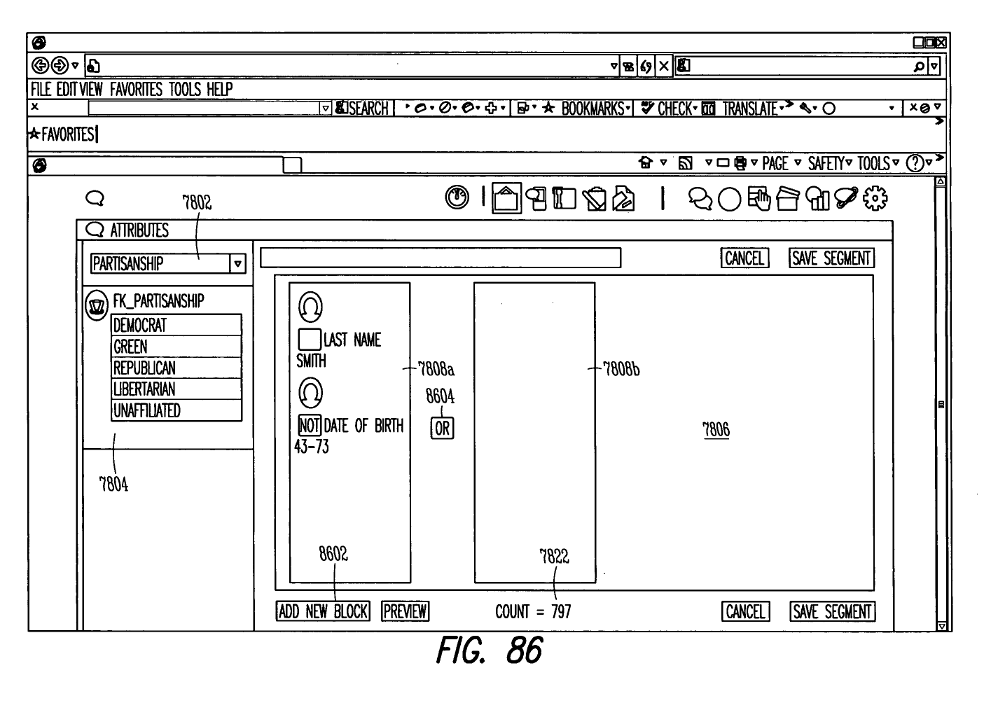

The user may then selectively add a second criterion for the population of the segment. With reference to FIG. 86, the add new block button 8602 is operated to display a second criteria block 7808b on the criteria field 7806. Although not illustrated, a popover window provides a Boolean connector 8604 for the two criteria blocks 7808a and 7808b. The first criteria block 7808a shows the icons for the first criteria and the total population is displayed 7908.

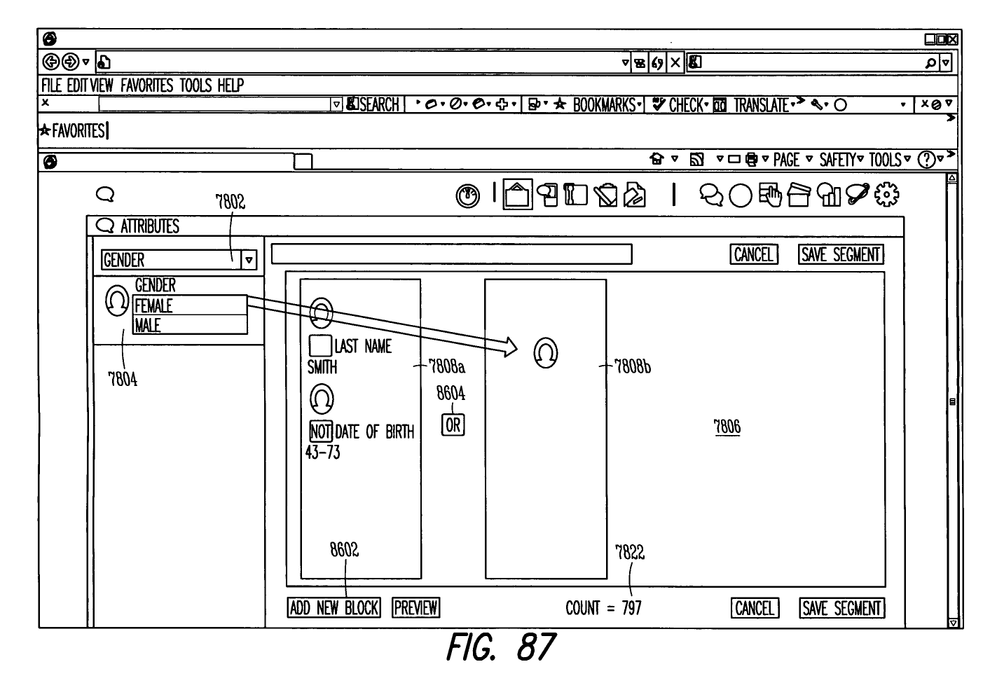

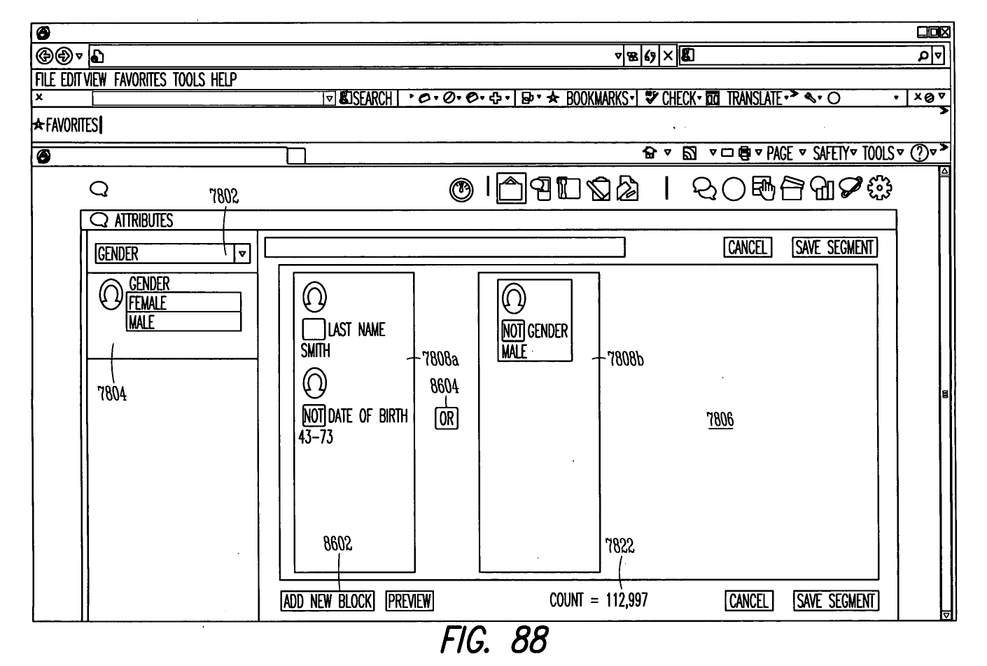

With reference to FIG. 87, the user selects an attribute for the second criteria block 7808b. In the example, the attribute of “gender” is selected and “female” gender is dragged and dropped as illustrated by the arrow onto the second criteria block 7808b. FIG. 88 illustrates the two criteria for the segment with a total count 7908 of the recipients 112 included by the criteria.

Thus, it can be seen that the present invention as disclosed in the above embodiment provides a method and apparatus for integrating many different recipient contact modes, data collection techniques, and data analysis procedures which overcomes the drawbacks of the prior art. It is contemplated that one of ordinary skill in the art will readily understand the present invention and the disclosed features described and illustrated in the foregoing specification and that many changes and modifications can be made within the meaning and purpose thereof, without departing from the disclosed invention. The modular features of the present communications system allow clients to perform a variety of messages and actions including email, text messaging, and surveys. Analysis tools facilitate interpretation of data collected from recipient's responses and actions to leverage the delivery and communication of messages. The detailed description is in exemplary reference to illustrative embodiments and is not limited to such examples.

What is claimed is:

1. A method in a communication system for contacting a plurality of recipients and collecting feedback data from the plurality of recipients, the method comprising the steps of:
a client customizing contact of the plurality of recipients from a host computer;
the client customizing collection of the feedback data from the recipients at the host computer; and
the client receiving the feedback data via a network portal coupled to the host computer, wherein the feedback data is received in the form of a report including at least a portion of the feedback data, and wherein the feedback data is analyzed in accordance with client analysis criteria customized by the client.

2. The method in accordance with claim 1 wherein the step of the client customizing collection of the feedback data comprises the client customizing a status screen to be displayed upon startup of a client device to display feedback status data indicating status of the feedback received by the client device.

3. The method in accordance with claim 1 wherein the step of the client customizing contact of the plurality of recipients comprises the step of the client assigning one of a plurality of predetermined contact modes for contacting each of the plurality of recipients.

4. The method in accordance with claim 3 wherein the step of the client assigning one of the plurality of predetermined contact modes comprises the client assigning one of the plurality of predetermined contact modes wherein the plurality of predetermined contact modes are one or more of electronic mail, telephone, cell phone or delivery to a street address.

5. The method in accordance with claim 3 wherein the step of the client assigning one of the plurality of predetermined contact modes comprises the step of the client assigning one of the plurality of predetermined contact modes for contacting each of the plurality of recipients in response to recipient contact information obtained from public information.

6. The method in accordance with claim 3 wherein the step of the client assigning one of the plurality of predetermined contact modes comprises the step of the client assigning one of the plurality of predetermined contact modes for contacting each of the plurality of recipients in response to recipient contact information obtained from list providers which collect such information.

7. The method in accordance with claim 1 wherein the step of the client customizing collection of the feedback data comprises the step of the client customizing collection of the feedback data from the recipients at the host computer in accordance with one of a plurality of modules operating on the host computer.

8. A communication system for delivering first data to a plurality of recipients and obtaining and manipulating feedback information received from the plurality of recipients, the communication system comprising:
a host computer including a set of instructions for operating one or more modules;
a network coupled to the host computer
one or more client devices coupleable to the network for coupling to the host computer via the network to access some or all of the one or more modules; and
a plurality of recipients, wherein the host computer can couple to each of the plurality of recipients in one of a plurality of predetermined delivery modes,
wherein the client is able to customize contact of the plurality of recipients from the host computer and collection of feedback data from the recipients at the host computer.

9. The communication system in accordance with claim 8 wherein the feedback data is received in the form of a report including at least a portion of the feedback data.

10. The communication system in accordance with claim 8 wherein the feedback data is analyzed in accordance with client analysis criteria customized by the client.

11. The communication system in accordance with claim 9 wherein the client customizes a status screen to be displayed upon startup of a client device to display feedback status data indicating status of the feedback received by the client device.

12. The communication system in accordance with claim 8 wherein the client assigns one of a plurality of predetermined contact modes for contacting each of the plurality of recipients.

13. The communication system in accordance with claim 12 wherein the plurality of predetermined contact modes are one or more of electronic mail, telephone, cell phone or delivery to a street address.

14. The communication system in accordance with claim 12 wherein the client assigns one of the plurality of predetermined contact modes for contacting each of the plurality of recipients in response to recipient contact information obtained from public information.

15. The communication system in accordance with claim 12 wherein the client assigns one of the plurality of predetermined contact modes for contacting each of the plurality of recipients in response to recipient contact information obtained from list providers which collect such information.

16. The communication system in accordance with claim 8 wherein the client customizes collection of the feedback data from the recipients at the host computer in accordance with one of a plurality of modules operating on the host computer.

17. A host computer for operating under customized control of a client device for communicating with a plurality of recipients and obtaining feedback data therefrom, the host computer comprising:
a survey module for creation of surveys by the client device to enable the client device to obtain information concerning interests of at least a portion of the plurality of recipients;
a group module for allowing the client device to interact with social networking websites;
an analyzer module for generating and providing analytics to the client device on a plurality of predetermined contact modes for contacting each of the plurality of recipients; and
a manager module for communicating advertising messages to at least a portion of the plurality of recipients in response to demographic information on each of the at least a portion of the plurality of recipients.

18. The host computer in accordance with claim 17 further comprising one or more contact modules comprising one or more of a mailer module for electronic distribution of messages, a messenger system for managing and sending text messages, a dialer module for connecting the client device to a telephone or a cell phone, and a printer module for generating printed material for distribution by mail, courier or other delivery service.

19. The host computer in accordance with claim 17 further comprising an online donation module to facilitate collection of donations.

20. The host computer in accordance with claim 17 further comprising a sequencer module for creation of communication plans integrating functions of one or more of the survey module, the group module, the analyzer module, and the manager module.
